(19) United States
(12) Patent Application Publication
(10) Pub. No.: US 2008/0139307 A1
(43) Pub. Date: Jun. 12, 2008

(54) Simulated Experience Apparatus, Energy Consumption Calculation Method, Squatting Motion Detection Apparatus, Exercise Assist Apparatus, Animation Method, Exercise Amount Management Apparatus, Athletic Ability Measurement Apparatus, Reflexes Ability Measurement Apparatus, And Audio-Visual System

(76) Inventors: Hiromu Ueshima, Shiga (JP); Akimasa Konishi, Shiga (JP); Yoshiyuki Okabe, Shiga (JP)

Correspondence Address: JEROME D. JACKSON (JACKSON PATENT LAW OFFICE), 211 N. UNION STREET, SUITE 100, ALEXANDRIA, VA, 22314, US

(21) Appl. No.: 11/722,718

(22) PCT Filed: Dec. 26, 2005
(86) PCT No.: PCT/JP2005/024216

§ 371 Date: Jun. 25, 2007

Related U.S. Application Data
(60) Provisional application No. 60/639,670, filed on Dec. 28, 2004.

(30) Foreign Application Priority Data
Apr. 15, 2005 (JP) 2005-118149
Apr. 19, 2005 (JP) 2005-121238

(51) Int. Cl. A63F 13/00; A63F 9/24; A63B 71/00

(52) U.S. Cl. 463/31; 463/36; 482/8

(57) ABSTRACT

A manipulation object 400 displayed on a television monitor 5 performs the same various motions as various motions which a player performs on a mat 2 (a motionless state, a walking motion, a running motion, a side stepping motion, a jumping motion and a squatting motion). Accordingly, the player can have an experience as if he were actually moving in a virtual space through the manipulation object 400 by performing these motions on the mat 2.

### TECHNICAL FIELD

The present invention relates to a simulated experience apparatus by which a player can experience a virtual space by simulation, an energy consumption calculation method for calculating the energy consumption of a player, a squatting motion detection apparatus for detecting the squatting motion of a player, an exercise assist apparatus for assisting a player to do exercise by guiding motions, an animation method for animating a character, an exercise amount management apparatus for managing the change in the amount of exercise, an athletic ability measurement apparatus for measuring athletic ability, a reflexes ability measurement apparatus for measuring reflexes ability, an audio-visual system for receiving the detection result of stepping motions and generating a video signal and an audio signal, and the related arts.

### BACKGROUND ART

A dance game system is described in Japanese Patent Published Application No. Tokkai 2000-37490. This dance game system serves to guide a player how to take steps by displaying images on a monitor. The player can enjoy the dance game by stepping on step members in accordance with the guides. This is a kind of a passive game for the player because the game is played in accordance with the guides.

### SUMMARY OF THE INVENTION

It is an object of the present invention to provide a simulated experience apparatus and the related arts, by which a player can experience a virtual space by simulation in an active manner.

It is another object of the present invention to provide an energy consumption calculation method and the related arts, by which the energy consumption of a player can be calculated to reflect the motion pattern of the player without evaluating the motion pattern.

It is a further object of the present invention to provide a squatting motion detection apparatus and the related arts, by which not only the stepping motions of a player but also the squatting motion can be detected with ease.

It is a still further object of the present invention to provide an exercise assist apparatus and the related arts, by which a player can more easily recognize the motion as instructed, thereby the exercise environment can be improved, and in addition to this the player is assisted to do not only exercises using stepping motions but also exercises using the whole body.

It is a still further object of the present invention to provide an animation method and the related arts, by which the storage capacity can be reduced as compared with the case where animated images are provided separately for the respective musics.

It is a still further object of the present invention to provide an animation method and the related arts, by which the last animation can be started just after the playback start time thereof arrives without need for an additional parameter.

It is a still further object of the present invention to provide an animation method and the related arts, by which the next unit animation can be played back from the playback end time of the current unit animation as the playback start time.

It is a still further object of the present invention to provide an exercise amount management apparatus and the related arts, by which a user can easily know not only the changes in the amount of exercise of respective exercise programs, but also the change in the total amount of the exercises, and in addition to this, the user can easily know the proportions of the amount of exercise of the respective exercise programs to the total amount of the exercises.

It is a still further object of the present invention to provide an athletic ability measurement apparatus and the related arts, by which athletic ability can easily be measured.

It is a still further object of the present invention to provide a reflexes ability measurement apparatus and the related arts, by which reflexes ability can easily be measured.

It is a still further object of the present invention to provide an audio-visual system and the related arts, by which the limitation on the installation location of the unit serving to detect stepping motions can be lessened.

In accordance with a first aspect of the present invention, a simulated experience apparatus comprising: a plurality of step members each of which includes a detector unit operable to detect a stepping motion of a player as an input; a motion determination unit operable to determine which of a plurality of predetermined motion patterns the motion of the player belongs on the basis of the detection result by said detector unit; and a motion control unit operable to control motion of a manipulation object displayed on a display device in accordance with the motion pattern as determined by said motion determination unit.

In accordance with this configuration, since the manipulation object displayed on the display device performs a motion corresponding to a stepping motion performed by the player, the player can manipulate the manipulation object through the stepping motion (that is to say, it is an active play). Accordingly, the player can have an experience as if he were actually moving in the virtual space through the manipulation object by performing stepping motions. In other words, it is possible to have a simulated experience in the virtual space.

In the case of the above simulated experience apparatus, the plurality of predetermined motion patterns include part or all of a motionless state, a walking motion, a running motion, a side stepping motion, a jumping motion and a squatting motion.

In accordance with this configuration, by actually performing a stepping motion or a squatting motion which are included in these motion patterns, the player can control the manipulation object to perform the motions corresponding to these motion patterns.

In the simulated experience apparatus as described above, said motion determination unit determines that the motion of the player is the squatting motion when said detector units of three or four of said plurality of step members simultaneously detect the inputs of the player.

In accordance with this configuration, not only the stepping motions of the player but also the squatting motion can be detected with ease. This is because, while the state of putting both feet on two step members can be detected by two detector units, a further one or two detector unit is (are) turned on to detect an input(s) if the player pushes either or both hands to a further one or two step member, and in such a case it can be assumed that the player is squatting.

The simulated experience apparatus as described above further comprises an indication object control unit operable to make an indication object appear, which indicates what motion the player is to do, on a course in a virtual space displayed on the display device.

In accordance with this configuration, the simulated experience apparatus can predict how the player moves from the start to the end because the player will move as instructed.

In the simulated experience apparatus as described above, 1 further comprising an energy consumption calculation unit operable to calculate the energy consumption of the player by adding an adjusted value calculated by adjusting an energy consumption value predetermined as an energy consumption corresponding to a predetermined motion in accordance with the number of times that the player performs the stepping motion to a base energy consumption calculated by multiplying a unit step energy consumption which is predetermined as an energy consumption of a unit stepping motion corresponding to the motion of stepping for predetermined times by the number of times of performing the unit stepping motion.

In accordance with this configuration, since the approximative value of the energy which is consumed by the player can be calculated, by displaying it on the display device, it is possible to inform the player of the amount of own exercise from an objective view point.

In accordance with a second aspect of the present invention, an energy consumption calculation method comprising: acquiring a base energy consumption by multiplying a unit step energy consumption which is predetermined as an energy consumption of a unit stepping motion corresponding to the motion of stepping for predetermined times by the number of times of performing the unit stepping motion; acquiring an adjusted value by adjusting an energy consumption value predetermined as an energy consumption corresponding to a predetermined motion in accordance with the number of times that the player performs the stepping motion; and acquiring the energy consumption of the player by adding the adjusted value to the base energy consumption.

In accordance with this configuration, it is possible to calculate the approximative value of the energy which is consumed by the player only by counting the number of times of stepping without evaluating the motion pattern. Furthermore, the energy value predetermined corresponding to a predetermined motion is adjusted in accordance with the number of times that the player performs the stepping motion, and the adjusted energy value is added to the base energy consumption, so that it is possible to improve the accuracy of the energy value as finally calculated.

That is, while the predetermined motions are not normal stepping motions but special motions including part or all of the side stepping motion, the jumping motion and the squatting motion, the energy consumptions corresponding to these special motions are added to the energy consumptions corresponding to the normal stepping motions on the assumption that the player performs these special motions in addition to the normal stepping motions in order to improve the accuracy of the energy value as calculated.

The adjustment of the predetermined energy value corresponding to the predetermined motion is made because in the case where the predetermined energy value is uniformly added irrespective of the actual step count, the motion of the player cannot be reflected, but rather the accuracy is degraded.

In accordance with a third aspect of the present invention, a squatting motion detection apparatus comprising: a plurality of step members each of which includes a detector unit operable to detect a stepping motion of a player as an input; and a determination unit operable to determine that the motion of the player is the squatting motion when said detector units of three or four of said plurality of step members detect the inputs of the player.

In accordance with this configuration, not only the stepping motions of the player but also the squatting motion can be detected with ease. This is because, while the state of putting both feet on two step members can be detected by two detector units, a further one or two detector unit is(are) turned on to detect an input(s) if the player pushes either or both hands to a further one or two step member, and in such a case it can be assumed that the player is squatting.

In accordance with a fourth aspect of the present invention, an exercise support apparatus which is used by connecting it to a display device, comprising: a plurality of step members each of which includes a detector unit operable to detect a stepping motion of a player as an input; and a video signal generation unit operable to generate a video signal for displaying a plurality of objects, and output the video signal to the display device, wherein the objects includes a plurality of response objects which are provided corresponding respectively to said plurality of step members and each of which is operable to respond to the detection of a stepping motion by said detector unit corresponding thereto, a moving object which moves on one of motion lanes provided corresponding respectively to the response objects and which is operable to instruct the player on what position and timing the player is to take a step on said plurality of step members, a character operable to instruct the player on what fullbody motion the player is to do, and a plurality of objects which correspond to said plurality of step members and are pointed to by the character in order to instruct the player on what position and timing the player is to take a step on said plurality of step members.

In accordance with this configuration, the player can recognize the stepping position and the stepping timing not only by the moving objects and the response objects but also by the character and the objects pointed to by the character. Accordingly, the player can more easily recognize the motion as instructed, and thereby the exercise environment can be improved. In addition to this, since the character indicates the motion of the whole body, the player can do not only exercises using stepping motions but also exercises using the whole body.

In the exercise support apparatus as described above, the response objects are designed in similar forms as said stepping members respectively corresponding thereto, and wherein the objects which are pointed to by the character are designed in similar forms as said stepping members respectively corresponding thereto.

Accordingly, it is possible to enhance the realistic sensation that the player can experience during exercise, and make it easier for the player to recognize how to move as indicated.

In accordance with a fifth aspect of the present invention, an animation method of animating a character in accordance with a music by combining a plurality of types of unit animations, comprising: Playing back the music; and Playing back the combination of the unit animations as the animation of the character, wherein the combination of the unit animations for animating the character is predetermined in accordance with the music, and wherein the playback times of the unit animations are predetermined in accordance with the music.

In accordance with this configuration, it is possible to animate the character in synchronization with music only by changing the combination of unit animations and the playback time. Accordingly, the storage capacity can be reduced as compared with the case where animated images are provided separately for the respective musics.

In accordance with a sixth aspect of the present invention, an animation method of animating a character by combining a plurality of types of unit animations, wherein the playback end time of the unit animation is designated on a time axis before playing back this unit animation.

In accordance with this configuration, since the playback end time can be recognized when starting the playback, it is possible to calculate the playback time of each image frame of a unit animation when starting the playback. As a result, it is possible to start the last unit animation of the animation of the character just after the playback start time of the last unit animation arrives.

Incidentally, in the case where a unit animation is played back by designating the playback start time, the playback time or the playback end time have to be designated if the last unit animation is to be played back just after the playback start time arrives. As thus described, in such a case, an additional parameter is needed for playing back the last unit animation.

In accordance with the present invention, it is possible to start the last unit animation just after the playback start time arrives without need for an additional parameter.

In accordance with a seventh aspect of the present invention, an animation method of animating a character by combining a plurality of types of unit animations, comprising: setting sequentially, every time when a unit animation is to be set up, designation information for designating the unit animation and a constant value; starting a count operation from the constant value for each of the unit animations; starting a count operation from a base value as registered, continuing the count operation until an end point value as registered; playing back the unit animation in accordance with the designation information as registered until the result of counting from the base value becomes equal to the end point value; registering the result of counting from the constant value as first set as the new end point value when the result of counting from the base value becomes equal to the end point value; registering anew the designation information as first set when the result of counting from the base value becomes equal to the end point value; and registering anew the base value when the result of counting from the base value becomes equal to the end point value.

In accordance with this configuration, while successively playing back the unit animation indicated by the designation information as registered (during the playback operation) on the basis of the end point value as registered and the base value as registered, the constant value (corresponding to the playback end time of a unit animation) and the designation information are successively set up every time the instruction of the setting is given. Then, when the result of counting from the base value becomes equal to the end point value, i.e., when the playback of the current unit animation ends, the result of counting from the constant value as first set (i.e., the end point value), the designation information as first set and the base value are registered anew, and the playback of the next unit animation is started on the basis of the registration information.

As has been discussed above, by buffering the constant value (which points to the playback end time of each unit animation) and the designation information respectively used for playing back subsequent unit animations, the playback end time of the next unit animation can be recognized at the time when the current unit animation being played back ends, so that it is possible to play back the next unit animation from the playback end time of the current unit animation as the playback start time.

It is assumed here that the character is animated in synchronization with music. As has been discussed above, since animated images are played back by the use of a buffering mechanism, the animation of the character is delayed by the time corresponding to the above constant value. Accordingly, by delaying the playback of music by the time corresponding to the above constant value, it is possible to match the playback timing of music and the playback timing of animation, and synchronize the animation of the character with music. Meanwhile, in the period corresponding to the above constant value before starting the animation of the character, the animation of the character which is not necessarily synchronized with music (the animation of the character in the state of, as it were, waiting the playback of music) is played back.

In accordance with an eighth aspect of the present invention, an exercise amount management apparatus which is used by connecting it to a display device, comprising: an exercise program providing unit operable to provide a user with a plurality of types of exercise programs through an image which is displayed on the display device; an exercise amount calculating unit operable to calculate the amounts of exercise of the user separately for the respective exercise programs; an accumulation unit operable to accumulate the amounts of exercise on a predetermined time period basis for each of the exercise programs; a video signal generation unit operable to generate a video signal including an image which shows the change in the accumulated values by said accumulation unit on the same time axis for at least two predetermined exercise programs of the plurality of types of exercise programs.

In accordance with this configuration, even when the user do different exercise programs, the changes in the amount of exercise are displayed separately for the respective exercise programs on the same time axis. Because of this, the user can easily know not only the changes in the amount of exercise of the respective exercise programs, but also the change in the total amount of exercise. Furthermore, since the proportions of the amounts of exercise of the respective exercise programs to the total amount of exercise can be easily known, it is easy to make the schedule of doing the respective exercise programs.

In this description, “the amount of exercise” is meant a value which quantitatively represents how much the player exercises.

In the exercise amount management apparatus as described above, the image showing the change in the accumulated values is displayed on the predetermined time period basis with the same time axis as a first axis and an axis representing the amount of exercise as a second axis which is perpendicular to the first axis, wherein the accumulated values of the at least two predetermined exercise programs are designated in different appearances respectively, and wherein the accumulated values designated in the different appearances are stacked in the direction of the second axis.

In accordance with this configuration, the user can more easily know the changes in the amount of exercise of respective exercise programs, the change in the total amount of exercise, and the proportions of the amount of exercise of the respective exercise programs to the total amount of exercise.

In the exercise amount management apparatus as described above, the amount of exercise is the energy that the user has consumed.

In accordance with this configuration, since the energy consumption which is commonly known is used as a measure of the amount of exercise, the user can easily know the amount of exercise.

In accordance with a ninth aspect of the present invention, an athletic ability measurement apparatus which is used by connecting it to a display device, comprising: a plurality of step members each of which includes a detector unit operable to detect a stepping motion of a player as an input; a video signal generation unit operable to generate a video signal including an image by which the player is instructed to start a motion, and output the video signal to the display device; and a counter unit operable to count the number of times that the player performs stepping motions within a predetermined period after the image by which the player is instructed to start the motion is displayed, wherein the video signal generation unit generates a video signal including an image indicative of the count result of said counter unit, and outputs the video signal to the display device.

In accordance with this configuration, since the count of steps within the predetermined time is used as the measure of athletic ability, it is possible to easily measure athletic ability. Then, the player can know own athletic ability with reference to the count of steps within the predetermined time.

In accordance with a tenth aspect of the present invention, a reflexes ability measurement apparatus which is used by connecting it to a display device, comprising: a plurality of step members each of which includes a detector unit operable to detect a stepping motion of a player as an input; a video signal generation unit operable to generate a video signal including an image by which the player is instructed to start a motion, and output the video signal to the display device; and a measurement unit operable to measure the time period passing after the image by which the player is instructed to start the motion is displayed until the input from the player to a predetermined detector unit of the detector units comes to cease, wherein the video signal generation unit generates a video signal including an image indicative of the measurement result of said measurement unit, and outputs the video signal to the display device.

In accordance with this configuration, since the measure of reflexes ability is the time period from the time point when the start of action is indicated to the time point when the input from the player comes to cease, it is possible to easily measure reflexes ability. Then, the player can know own reflexes ability with reference to the time counted after the start of action is indicated until the input from the player comes to cease.

In accordance with an eleventh aspect of the present invention, an audio-visual system comprising: a stepping unit provided with a plurality of stepping members which are stepped on by a user; an information processing unit operable to perform processes in accordance with a program, each of the stepping members including: a detector unit operable to detect a stepping motion of the user as an input; said stepping unit further including: a transmitter unit operable to wireless transmit the detection result by said detector unit to said information processing unit, said information processing unit including: a receiver unit operable to receive the detection result which is wireless transmitted from said transmitter unit of said stepping unit; and a processor operable to generate a video signal and an audio signal on the basis of the detection result.

In accordance with this configuration, since the detection result by the stepping unit is transmitted to the processor by wireless communication, the limitation on the installation location of the stepping unit can be lessened.

### BRIEF DESCRIPTION OF DRAWINGS

The aforementioned and other features and objects of the present invention and the manner of attaining them will become more apparent and the invention itself will be best understood by reference to the following description of a preferred embodiment taken in conjunction with the accompanying drawings, wherein.

FIG. 1 is a schematic diagram showings the entire configuration of a mat system in accordance with an embodiment 1 of the present invention.

FIG. 2 is a perspective view showing the adapter 1 and the cartridge 3 of FIG. 1.

FIG. 3 is a perspective view showing the adapter 1 as seen from the back side.

FIG. 4 is a block diagram which shows the internal configuration of the adaptor 1 of FIG. 1.

FIG. 5 is a schematic diagram showing the internal configuration of the cartridge 3 of FIG. 1.

FIG. 6 is a block diagram showing the internal configuration of the mat unit 7 of FIG. 1.

FIG. 7 is a circuit diagram showing the infrared emission unit 200 and the mode setting unit 204 of FIG. 6.

FIG. 8 is a circuit diagram showing the key matrix 206 of FIG. 6.

FIG. 9 is a circuit diagram showing another example of the key matrix 206 of FIG. 6.

FIG. 10 is a flow chart showing the processing of the MCU 202 of FIG. 6.

FIG. 11 is an exploded perspective view of the mat 2 of FIG. 1.

FIG. 12 is a view showing an example of a screen as displayed on the television monitor 5 of FIG. 1 by the simulated experience apparatus of the embodiment 2.

FIG. 13 is a view showing another example of a screen as displayed on the television monitor 5 of FIG. 1.

FIG. 14 is a view showing a further example of a screen as displayed on the television monitor 5 of FIG. 1.

FIG. 15 is a view showing a still further example of a screen as displayed on the television monitor 5.

FIG. 16 is a view showing a still further example of a screen as displayed on the television monitor 5 of FIG. 1.

FIG. 17 is a view showing an example of an outcome screen as displayed on the television monitor 5 of FIG. 1.

FIG. 18 is a schematic diagram showing the on/off patterns of the foot switches SW1 to SW4 of the mat 2 of FIG. 1.

FIG. 19 is an explanatory view for showing the motion of the manipulation object 400.

FIG. 20 is an explanatory view of a table showing the relation among the motion of the manipulation object 400, the motion number, the animation time (the manipulation object), the animation time (the background), the two-footed contact time, and the average step interval.

FIG. 21 is a flow chart showing an example of the overall process flow by the high speed processor 91 of FIG. 5 which is used in the simulated experience apparatus in accordance with the embodiment 2 of the present invention.

FIG. 22 is a flow chart showing an example of the process of acquiring IR codes (interrupt handler) in step S21 of FIG. 21.

FIG. 23 is a flow chart showing an example of the process of measuring the step interval in step S5 of FIG. 21.

FIG. 24 is a flow chart showing an example of the process for counting the two-footed contact time in step S6 of FIG. 21.

FIG. 25 is a flow chart showing an example of the process for determining the current lane in step S7 of FIG. 21.

FIG. 26 is a flow chart showing an example of the side step determination process in step S8 of FIG. 21.

FIG. 27 is a flow chart showing an example of the squatting determination process in step S9 of FIG. 21.

FIG. 28 is a flow chart showing an example of the jumping determination process in step S10 of FIG. 21.

FIG. 29 is a flow chart showing an example of the process of registering a motion number in step S11 of FIG. 21.

FIG. 30 is a flow chart showing an example of the process of controlling animation in step S12 of FIG. 21.

FIG. 31 is a flow chart showing an example of a first pre-processing of calculating the calorie consumption in step S4 of FIG. 21.

FIG. 32 is a flow chart showing an example of a second pre-processing of calculating the calorie consumption in step S18 of FIG. 21.

FIG. 33 is a view showing an example of the tutorial screen (Standby) as displayed on the television monitor 5 of FIG. 1.

FIG. 34 is a view showing an example of the tutorial screen (Walk/Run) as displayed on the television monitor 5 of FIG. 1.

FIG. 35 is a view showing an example of the tutorial screen (Jump) as displayed on the television monitor 5 of FIG. 1.

FIG. 36 is a view showing an example of the tutorial screen (Squat) as displayed on the television monitor 5 of FIG. 1.

FIG. 37 is a view showing an example of the tutorial screen (Side Step) as displayed on the television monitor 5 of FIG. 1.

FIG. 38 is an explanatory view for showing a first exemplary modification of the simulated experience apparatus in accordance with the embodiment 2 of the present invention.

FIG. 39 is an explanatory view for showing a second exemplary modification of the simulated experience apparatus in accordance with the embodiment 2 of the present invention.

FIG. 40 is a view showing an example of a screen as displayed on the television monitor 5 of FIG. 1 by the exercise support apparatus of the embodiment 3.

FIG. 41 is a view showing an example of an outcome screen as displayed on the television monitor 5 of FIG. 1.

FIG. 42 is a table for explaining the musical score data for melody.

FIG. 43A is a table for explaining the musical score data for dance code.

FIG. 43B is a view showing the relationship among the note number, the velocity, the dance code and the motion of the character 406.

FIG. 44A is a table for explaining the musical score data for moving object.

FIG. 44B is a view showing the relationship between the note number of the musical score data for moving object and the motion lane/the moving object.

FIG. 45 is a view showing an example of the musical score data for dance code.

FIG. 46 is a view for explaining the dance management and control performed on the basis of the musical score data for dance code of FIG. 45.

FIG. 47 is a time chart for explaining the dance management and control performed on the basis of the musical score data for dance code of FIG. 45.

FIG. 48 is a flow chart showing an example of the overall process flow by the high speed processor 91 of FIG. 5 which is used in the exercise support apparatus of the embodiment 3 of the present invention.

FIG. 49 is a flow chart showing an example of the dance management process in step S209 of FIG. 48.

FIG. 50 is a flow chart showing an example of the dance control process in step S210 of FIG. 48.

FIG. 51 is a flow chart showing an example of the moving/response object control process in step S211 of FIG. 48.

FIG. 52 is a flow chart showing an example of the sound process in step S217 of FIG. 48.

FIG. 53 is a flow chart showing an example of the process of playing back melody in step S280 of FIG. 52.

FIG. 54 is a flow chart showing an example of the process of registering a dance code in step S281 of FIG. 52.

FIG. 55 is a flow chart showing an example of the process of registering a moving object in step S282 of FIG. 52.

FIG. 56 is a view showing an example of the selection screen which is displayed on the television monitor 5 of FIG. 1.

FIG. 57 is a view showing another example of the selection screen which is displayed on the television monitor 5 of FIG. 1.

FIG. 58 is a view showing an example of the screen which is displayed after the screen of FIG. 57 is displayed.

FIG. 59 is a view showing an example of a screen as displayed on the television monitor 5 of FIG. 1 by the entertainment apparatus of the embodiment 4.

FIG. 60 is a view showing another example of a screen as displayed on the television monitor 5 of FIG. 1.

FIG. 61 is a flow chart showing an example of the overall process flow by the high speed processor 91 of FIG. 5 which is used in the entertainment apparatus in accordance with the embodiment 4 of the present invention.

FIG. 62 is a view showing an example of a ready screen as displayed on the television monitor 5 of FIG. 1 in accordance with the athletic ability measurement apparatus of the embodiment 5 of the present invention.

FIG. 63 is a view showing an example of a screen which is displayed during playing on the television monitor 5 of FIG. 1.

FIG. 64 is a view showing an example of a “Finish” screen which is displayed on the television monitor 5 of FIG. 1.

FIG. 65 is a view showing an example of a screen which is displayed during playing on the television monitor 5 of FIG. 1 in accordance with the reflexes ability measurement apparatus of the embodiment 6 of the present invention.

FIG. 66 is a view showing an example of a “Finish” screen which is displayed on the television monitor 5 of FIG. 1.

FIG. 67 is a view showing an example of a user name entry screen as displayed on the television monitor 5 of FIG. 1 in accordance with the mat system of the embodiment 7 of the present invention.

FIG. 68 is a view showing an example of a user information entry screen as displayed on the television monitor 5 of FIG. 1.

FIG. 69 is a view showing an example of a play mode selection screen as displayed on the television monitor 5 of FIG. 1.

FIG. 70 is a view showing an example of the graphic screen displayed on the television monitor 5 of FIG. 1.

FIG. 71 is a view showing another example of the graphic screen displayed on the television monitor 5 of FIG. 1.

FIG. 72 is a schematic diagram showing the process transition among the routines performed by the mat system in accordance with the embodiment 7 of the present invention.

### BEST MODE FOR CARRYING OUT THE INVENTION

In what follows, several embodiments of the present invention will be explained in conjunction with the accompanying drawings. Meanwhile, like references indicate the same or functionally similar elements throughout the respective drawings, and therefore redundant explanation is not repeated. Incidentally, the unit of calorie consumption “Cal” is “kcal”.

### Embodiment 1

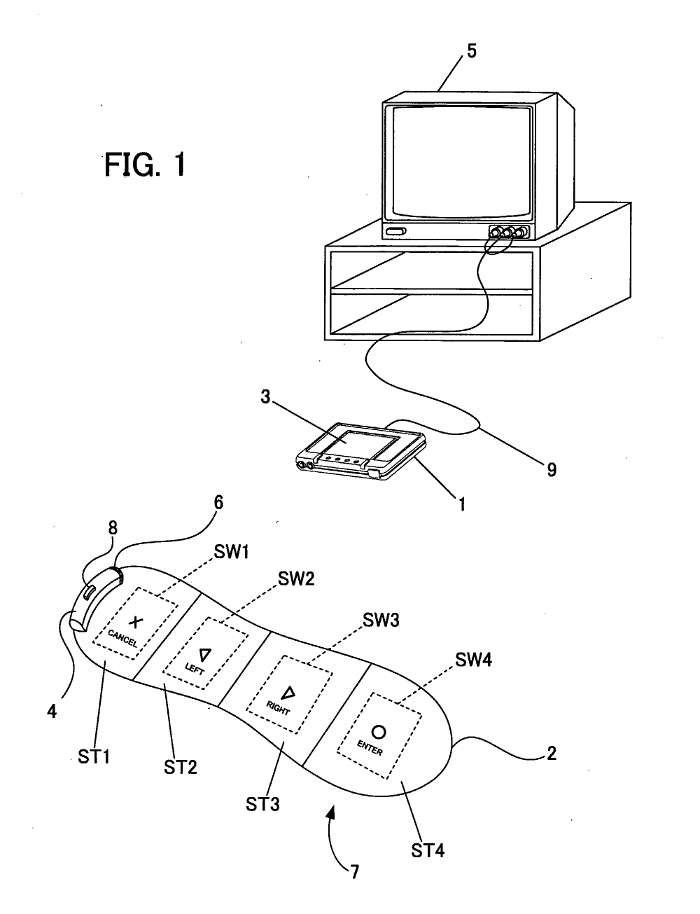

FIG. 1 is a schematic diagram showings the entire configuration of a mat system in accordance with an embodiment 1 of the present invention. As shown in FIG. 1, this mat system comprises an adapter 1, a cartridge 3, a mat unit 7 and a television monitor 5. The cartridge 3 is inserted into the adapter 1. On the other hand, the adapter 1 is connected to the television monitor 5 through an AV cable 9.

The mat unit 7 comprises a mat 2 and a circuit box 4. The circuit box 4 is fixed to one end of the mat 2. The circuit box 4 is provided with a power supply switch 8 at its upper surface and an infrared filter 6 which transmits only infrared light at one end thereof. Infrared light emitting diodes 210 and 212 (to be described below) are located behind this infrared filter 6. On the other hand, four step areas ST1, ST2, ST3 and ST4 are formed in the surface of the mat 2. The mat 2 is also provided with foot switches SW1, SW2, SW3 and SW4 inside thereof corresponding respectively to the step areas ST1, ST2, ST3 and ST4. When one of the step areas ST1, ST2, ST3 and ST4 is stepped on, the corresponding one of the foot switches SW1, SW2, SW3 and SW4 is turned on.

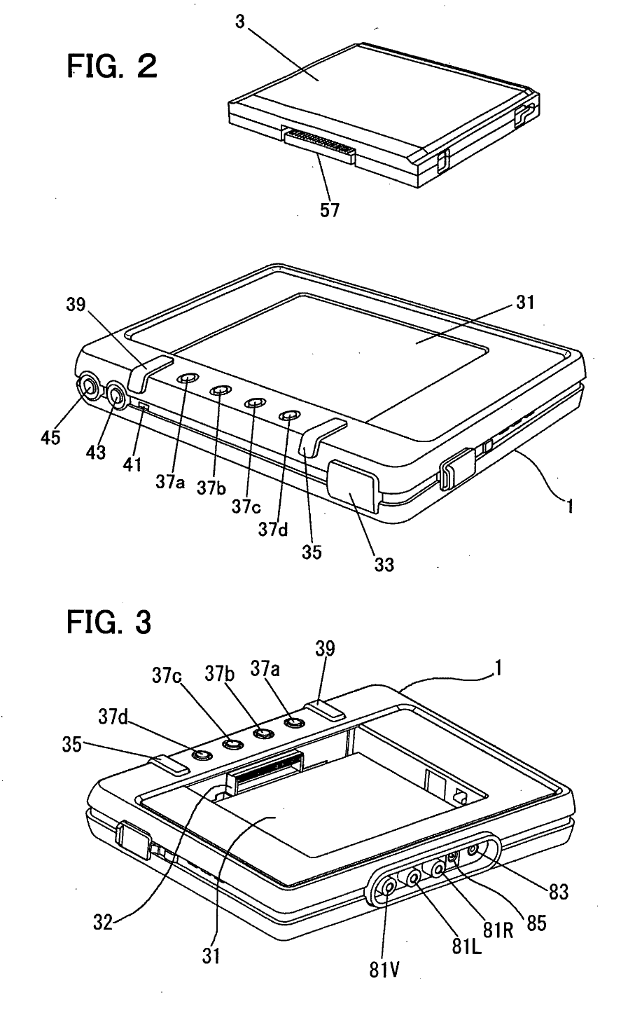

FIG. 2 is a perspective view showing the adapter 1 and the cartridge 3 of FIG. 1. FIG. 3 is a perspective view showing the adapter 1 as seen from the back side.

As shown in FIG. 2, the adapter 1 has a flat rectangular parallelepiped shape with an upper face, a lower face, a right and a left side face, a front and a back face. The adapter 1 is provided with a power supply switch 45, a reset switch 43 and a power lamp 41 in the left hand side of the front face, and an infrared filter 33 in the right hand side of the front face. This infrared filter 33 is a filter capable of removing incident light except infrared light in order to only pass infrared light, and provided with an infrared sensor (for making up an IR receiver circuit 71 to be described below) located behind this infrared filter 33. In addition, direction keys 37a to 37d are provided on the upper face of the adapter 1 in the vicinity of the front edge thereof. Furthermore, there are provided a cancel key 39 in the left hand side of the direction key 37a and an enter key 35 in the right hand side of the direction key 37d.

As shown in FIG. 3, an AV jack 83, a power jack 85, a video jack 81V, an L channel audio jack 81L and an R channel audio jack 81R are provided in the back face of the adapter 1. Incidentally, the term “AV jack 81” is used to generally represent the video jack 81V, the L channel audio jack 81L and the R channel audio jack 81R. The AV jack 83 is an external output terminal, and connected to an external input terminal of the television monitor 5 through the AV cable 9. On the other hand, the AV jack 81 is an input terminal which can be connected to the output terminal of a variety of external equipments (for example, DVD (digital versatile disc) player).

An opening is formed in the middle position of the upper surface of the adapter 1 while a top plate 31 is disposed therein so that its upper face is approximately flush with the upper face of the adapter 1. Inside the adapter 1, there is an elevator mechanism which urges upward the top plate 31 and supports the top plate 31 so that the upper face of the top plate 31 is located at the height as described above. The top plate 31 is provided to freely move up and down in the opening by this elevator mechanism. The cartridge 3 can be connected to a connector 32 by placing and pushing down the cartridge 3 on this top plate 31, and sliding the cartridge 3 toward the front face (refer to FIG. 1). This cartridge 3 contains a high speed processor 91, a memory 93 and the like to be described below. Also, needless to say, when the cartridge 3 is pushed down on the top plate 31, the downward movement distance of the top plate 31 is restricted by the elevator mechanism so that the cartridge 3 stops at a predetermined height.

Returning to FIG. 2, the cartridge 3 comprises a flat rectangular parallelepiped main body. The front face of the main body of the cartridge 3 is provided with a connector section 57 having terminals t1 to t24 to be described below with which it is connected to the connector 32 of the adapter 1.

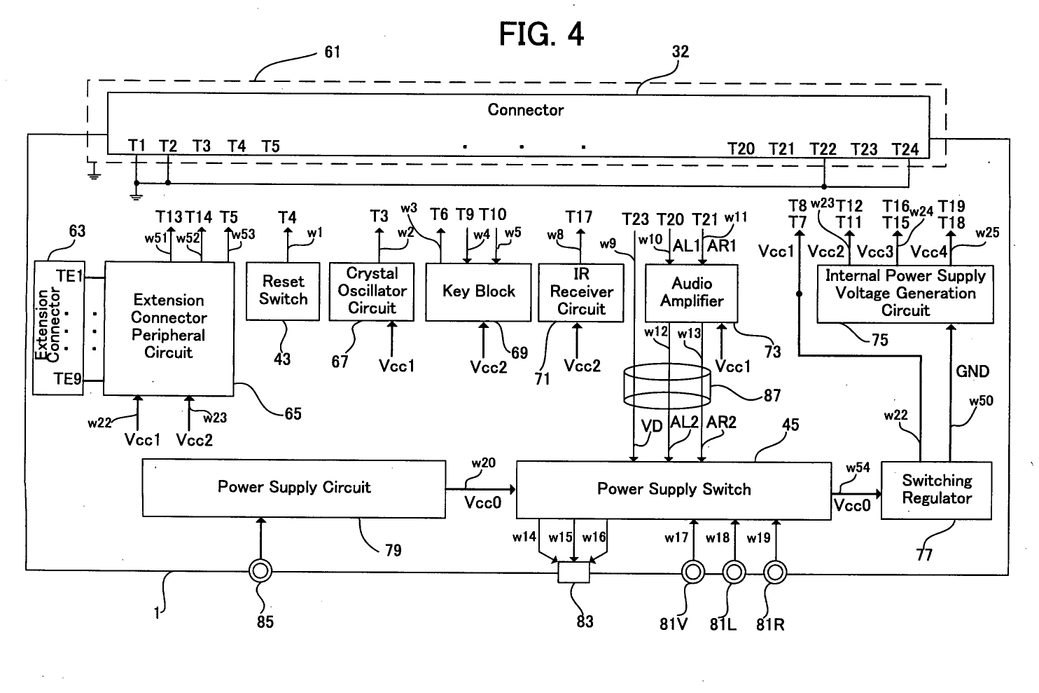

FIG. 4 is a block diagram which shows the internal configuration of the adaptor 1. As shown in FIG. 4, this adapter 1 includes the connector 32, an extension connector 63, an extension connector peripheral circuit 65, the reset switch 43, a crystal oscillator circuit 67, a key block 69, an infrared signal receiver circuit (IR receiver circuit) 71, an audio amplifier 73, an internal power supply voltage generation circuit 75, a power supply circuit 79 comprising an AC/DC converter and the like, the power supply switch 45, a switching regulator 77, the power jack 85, the AV jack 83, the video jack 81V, the L channel audio jack 81L, and the R channel audio jack 81R. The connector 32 has 24 terminals T1 to T24 and is covered by a shield member 61 which is grounded. The terminals T1, T2, T22 and T24 of the connector 32 are grounded.

The AC voltage as supplied from a power cable (not shown in the figure) is supplied to the power supply circuit 79 through the power jack 85. The power supply circuit 79 converts the AC voltage as given to a DC voltage, which is then output to a line w20 as a power supply voltage Vcc0. When turned on, the power supply switch 45 connects the line w20 and a line w54 to give the switching regulator 77 the power supply voltage Vcc0, and gives the AV jack 83 a video signal “VD” from a line w9 and audio signals “AL2” and “AR2” from the lines w12 and w13 respectively through lines w14, w15 and w16. Accordingly, the video signal “VD” and the audio signals “AL2” and “AR2” are given to the television monitor 5 through the AV cable 9, while the television monitor 5 displays an images of the video signal “VD” with sounds of the audio signals “AL2” and “AR2” output from speakers (not shown in the figure).

On the other hand, when turned off, the power switch 45 connects lines w17, w18 and w19 to lines w14, w15 and w16 respectively. By this configuration, a video signal as input from the video jack 81V, an L channel audio signal as input from the L channel audio jack 81L and an R channel audio signal as input from the L channel audio jack 81R are given to the AV jack 83. Accordingly, the video signal and the audio signals as input from the jacks 81V, 81L and 81R are transferred to the television monitor 5 from the AV jack 83 through the AV cable 9. As thus described, when the power supply switch 45 is turned off, it is possible to output the video signal and the audio signals as input from an external device through the jacks 81V, 81L and 81R to the television monitor 5.

The switching regulator 77 receives the power supply voltage Vcc0 from the power supply circuit 79 through the line w54 when the power supply switch 45 is turned on, and generates a ground potential GND and the power supply voltage Vcc1 on the lines w50 and w22 respectively. On the other hand, when the power supply switch 45 is turned off, the switching regulator 77 does not receive the power supply voltage Vcc0, and thereby it does not generate the power supply voltage Vcc1.

The internal power supply voltage generation circuit 75 generates power supply voltages Vcc2, Vcc3 and Vcc4 respectively on the lines w23, w24 and w25 on the basis of the ground potential GND and the power supply voltage Vcc1 as supplied from the switching regulator 77. The line w22 is connected to the terminals T7 and T8 of the connector 32; the line w23 is connected to the terminals T11 and T12 of the connector 32; the line w24 is connected to the terminals T15 and T16 of the connector 32; and the line w25 is connected to the terminals T18 and T19 of the connector 32. It is assumed that Vcc0>Vcc1>Vcc2>Vcc3>Vcc4. Incidentally, when the power supply switch 45 is turned off, the power supply voltage Vcc1 is not generated, and thereby the power supply voltages Vcc1, Vcc2, Vcc3 and Vcc4 are not supplied to the cartridge 3 through the connector 32.

The audio amplifier 73 amplifies the R channel audio signal “AR1” as input through the line w11 which is connected to the terminal T21 and the L channel audio signal “AL1” as input through the line w10 which is connected to the terminal T20, and outputs the R channel audio signal “AR2” and L channel audio signal “AL2” as amplified to the lines w13 and w12 respectively. The line w9 for inputting the video signal “VD” to the power supply switch 45 is connected to the terminal T23 of the connector 32.

The lines w9, w12 and w13 are covered by a cylindrical ferrite 87 in order not to radiate electromagnetic waves therefrom.

The IR (infrared ray) receiver circuit 71, which includes the above infrared sensor, demodulates the digital modulated infrared signal as received, and outputs digital demodulated signal to the line w8. The line w8 is connected to the terminal T17 of the connector 32.

The key block 69 includes the cancel key 39, the direction keys 37a to 37d and the enter key 35 and is provided with a shift register (not shown in the figure). This shift register serves to convert parallel signals which are input from the respective keys 39, 37a to 37d and 35 and a terminal TE7 described below, into serial signals, and output the serial signals to the line w3. This line w3 is connected to the terminal T6 of the connector 32. In addition, the key block 69 is given a clock signal through the line w5 which is connected to the terminal T10 and a control signal through the line w4 which is connected to the terminal T9.

The crystal oscillator circuit 67 oscillates a clock signal at a predetermined frequency (for example, 3.579545 MHz), and supplies the clock signal to the line w2. The line w2 is connected to the terminal T3 of the connector 32.

The reset switch 43 outputs a reset signal, which is used for resetting the system, to the line w1. The line w1 is connected to the terminal T4 of the connector 32.

The extension connector 63 is provided with first to ninth terminals (referred to as terminals TE1 to TE9 in the following description). The terminals TE2, TE4 and TE6 are connected to the terminals T13, T14 and T5 of the connector 32 respectively through the extension connector peripheral circuit 65. Accordingly, signals can be input from and output to the external device connected to the extension connector 63 through the terminals TE2, TE4 and TE6. The lines w4 and w5 are connected to the terminal TE 9 and TE 8 respectively. Accordingly, the external device connected to the extension connector 63 can receive the same clock signal as the key block 69 through the terminal TE8, and receive the same control signal as the key block 69 through the terminal TE9.

The terminals TE3 and TE5 are supplied respectively with the power supply voltages Vcc1 and Vcc2 through the extension connector peripheral circuit 65. Accordingly, the power supply voltages Vcc1 and Vcc2 can be supplied to the external device connected to the extension connector 63 through the terminals TE3 and TE5. The terminal TE1 is grounded. The terminal TE7 is connected to a predetermined input terminal of the above shift register included in the key block 69 through the extension connector peripheral circuit 65.

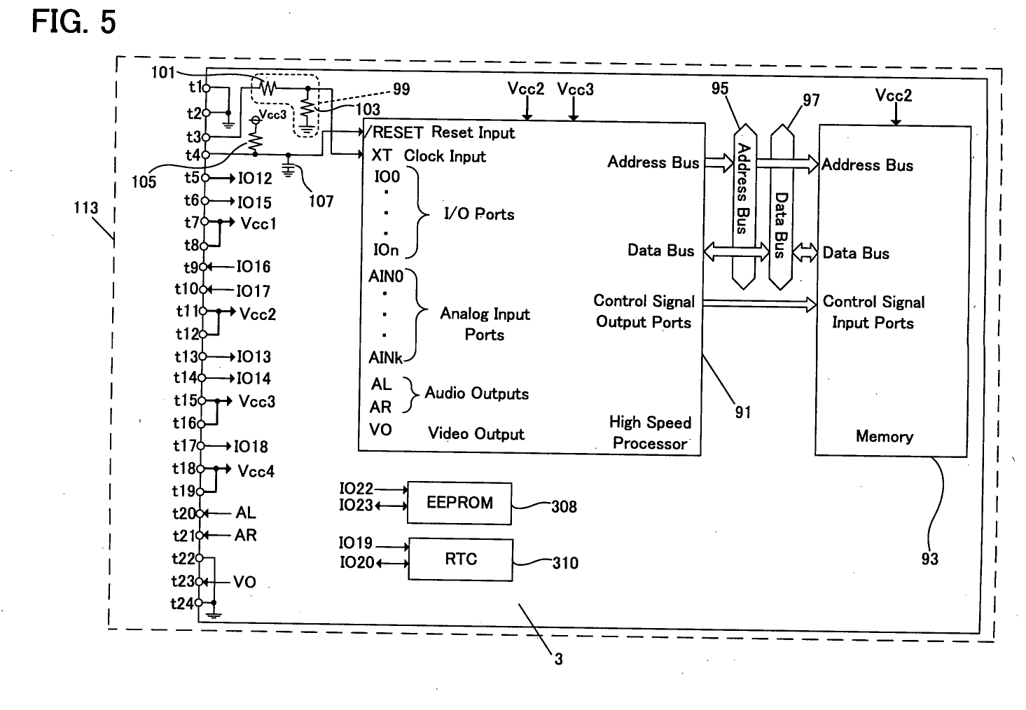

FIG. 5 is a schematic diagram showing the internal configuration of the cartridge 3. As shown in FIG. 5, the cartridge 3 includes a high speed processor 91, a memory 93, an EEPROM (electrically erasable programmable read only memory) 308, an RTC (real time clock) 310, terminals t1 to t24, an address bus 95, a data bus 97, and an amplitude setting circuit 99. The amplitude setting circuit 99 includes the resistors 101 and 103.

The high speed processor 91 includes a reset input port /RESET for inputting a reset signal, a clock input port XT for inputting a clock signal “SCLK2”, an input/output ports (I/O ports) IO0 to IOn (“n” is a natural number, for example, n=23) for inputting/outputting data, analog input ports AIN0 to AINk (“k” is a natural number, for example, k=5) for inputting analog signals, audio output ports AL and AR for outputting audio signals “AL1” and “AR1”, a video output port VO for outputting a video signal “VD”, control signal output ports for outputting control signals (for example, a chip enable signal, an output enable signal, a write enable signal and so on), a data bus, and an address bus. The memory 93 includes an address bus, a data bus, and control signal input ports for inputting control signals (for example, a chip enable signal, an output enable signal, a write enable signal and so forth). The memory 93 may be, for example, a ROM (read only memory), a flash memory, or any appropriate memory.

The control signal output ports of the high speed processor 91 are connected to the control signal input ports of the memory 93. The address bus of the high speed processor 91 and the address bus of the memory 93 are connected to the address bus 95. The data bus of the high speed processor 91 and the data bus of the memory 93 are connected to the data bus 97. In this case, the control signal output ports of the high speed processor 91 include an OE output port for outputting an output enable signal, a CE output port for outputting a chip enable signal, a WE output port for outputting a write enable signal, and so forth. Also, the control signal input ports of the memory 93 include an OE input port connected to the OE output port of the high speed processor 91, a CE input port connected to the CE output port of the high speed processor 91, a WE input port connected to the WE output port of the high speed processor 91, and so forth.

When receiving the chip enable signal, the memory 93 responds to the chip enable signal as the destination thereof to output a data signal in accordance with an address signal and the output enable signal which are given substantially at the same time as the chip enable signal. The address signal is input to the memory 93 through the address bus 95 while the data signal is input to the high speed processor 91 through the data bus 97. Also, when receiving the chip enable signal, the memory 93 responds to the chip enable signal as the destination thereof to receive and write a data signal in accordance with an address signal and the write enable signal which are given substantially at the same time as the chip enable signal. The address signal is input to the memory 93 through the address bus 95 while the data signal is input to the memory 93 from the high speed processor 91 through the data bus 97.

The EEPROM 308 is connected to some predetermined I/O ports (for example, IO22 and IO23) of the high speed processor 91. The EEPROM 308 is given a clock signal through the I/O port 22, and is given reading data, writing data, and commands through the I/O port 23 by the high speed processor 91. The RTC 310 serves to measure the time on the basis of the quartz oscillator (not shown in the figure) and generate time information which is given to the high speed processor 91. The RTC 310 is connected to some predetermined I/O ports (for example, IO19 and IO20) of the high speed processor 91. The RTC 310 is given a clock signal and commands through the I/O port IO19 and I/O port IO20 respectively by the high speed processor 91 and gives the time information through the I/O port IO20 to the high speed processor 91.

When the cartridge 3 is inserted into the adapter 1, the terminals t1 to t24 are connected to the terminals T1 to T24 of the connector 32 of the adapter 1 in a one-to-one correspondence. The terminals t1, t2, t22 and t24 are grounded. The terminal t3 is connected to the amplitude setting circuit 99. Namely, the resistor 101 of the amplitude setting circuit 99 is connected to the terminal t3 at one terminal thereof, and connected to the clock input port XT of the high speed processor 91 and one terminal of the resistor 103 at the other terminal thereof. The other terminal of the resistor 103 is grounded. Namely, the amplitude setting circuit 99 is a resistive potential divider.

The clock signal “SCLK1” generated by oscillation of the crystal oscillator circuit 67 of the adapter 1 is input through the terminal t3 to the amplitude setting circuit 99 which then generates a clock signal “SCLK2” having an amplitude smaller than the clock signal “SCLK1” and outputs the clock signal “SCLK2” to the clock input port XT. In other words, the amplitude of the clock signal “SCLK2” is set to a value which is determined by the ratio between the resistor 101 and the resistor 103.

The terminal t4 is connected to the reset input port /RESET of the high speed processor 91. Also, one terminal of the resistor 105 and one terminal of the capacitor 107 are connected to the line through which the reset input port /RESET is connected to the terminal t4. The other terminal of the resistor 105 is supplied with the power supply voltage Vcc3, and the other terminal of the capacitor 107 is grounded.

The terminals t5, t13 and t14 are connected respectively to the I/O ports IO12, IO13 and IO14 of the high speed processor 91. Accordingly, the high speed processor 91 can input/output signals from/to an external device connected to the extension connector 63 of FIG. 5 through the terminals t5, t13 and t14.

The power supply voltage Vcc1 is supplied from the terminals t7 and t8. The power supply voltage Vcc2 is supplied from the terminals t11 and t12. The power supply voltage Vcc3 is supplied from the terminals t15 and t16. The power supply voltage Vcc4 is supplied from the terminals t18 and t19. The power supply voltage Vcc2 is supplied to the analog circuitry of the high speed processor 91 while the power supply voltage Vcc3 is supplied to the digital circuitry of the high speed processor 91.

The terminals t6, t9, t10 and t17 are connected respectively to the I/O ports IO15, IO16, IO17 and IO18 of the high speed processor 91. Accordingly, the high speed processor 91 can receive a signal output from the key block 69 through the terminal t6. Also, the high speed processor 91 can output a control signal to an external device connected to the extension connector 63 and the key block 69 through the terminal t9. Furthermore, the high speed processor 91 can supply a clock signal to an external device connected to the extension connector 63 and the key block 69 through the terminal t10. Still further, the high speed processor 91 can receive the output signal of the IR receiver circuit 71 through the terminal t17.

The terminals t20 and t21 are connected to the audio output ports AL and AR of the high speed processor 91. The terminal t23 is connected to the video output port VO of the high speed processor 91. Accordingly, the high speed processor 91 can output the audio signals “AL1” and “AR1” to the audio amplifier 73 of the adapter 1 through the terminals t20 and t21, and output the video signal “VD” to the power supply switch 45 of the adapter 1 through the terminal t23.

Incidentally, the cartridge 3 is provided with a shield member 113. By virtue of the shield member 113, electromagnetic waves can be prevented, as much as possible, from leaking from the high speed processor 91 and the like as external radiation.

Next, the internal configuration of the high speed processor 91 will be briefly explained. Although not shown in the figure, the high speed processor 91 includes a CPU (central processing unit), a graphics processor, a sound processor and a DMA controller and so forth, and in addition to this, includes an A/D converter for receiving analog signals, and an input/output control circuit for receiving input signals such as key manipulation signals and infrared signals and giving the output signals to external devices.

The CPU takes control of the entire system and performs various types of arithmetic operations in accordance with a program stored in the memory 93.

The graphics processor constructs graphics data on the basis of data stored in the memory 93, and outputs a video signal “VD” which is generated on the basis of the graphics data and compatible with the television monitor 5. The graphics processor constructs graphics data by the use of a background screen, sprites and a bitmap screen. The background screen comprises a rectangular set of pixels as a two-dimensional array, and has a size covering the entirety of the screen of the television monitor 5. There are a first background screen and a second background screen respectively prepared as the background screen for showing depths in the background. The sprite consists of a rectangular set of pixels which can be relocated in any position of the screen of the television monitor 5. The bitmap screen consists of a two-dimensional pixel array, the size and position of which as displayed can be freely designated.

In addition to this, the high speed processor 91 includes a pixel plotter which is not shown in the figure but can perform drawing operations with individual pixels. The sound processor converts data stored in the memory 93 into sound data, and generates and outputs the audio signals “AL1” and “AR1” on the basis of the sound data. The sound data is synthesized by pitch conversion and amplitude modulation of PCM (pulse code modulation) data serving as the base data of tone quality. For the amplitude modulation, an envelope control function for reproducing waveforms of a music instrument is provided in addition to a volume control function performed in response to an instruction of the CPU.

In addition to this, the high speed processor 91 is provided with an internal memory (not shown in the figure) which is used as a working area, a counter area, a register area, a temporary data area, a flag area and/or the like area.

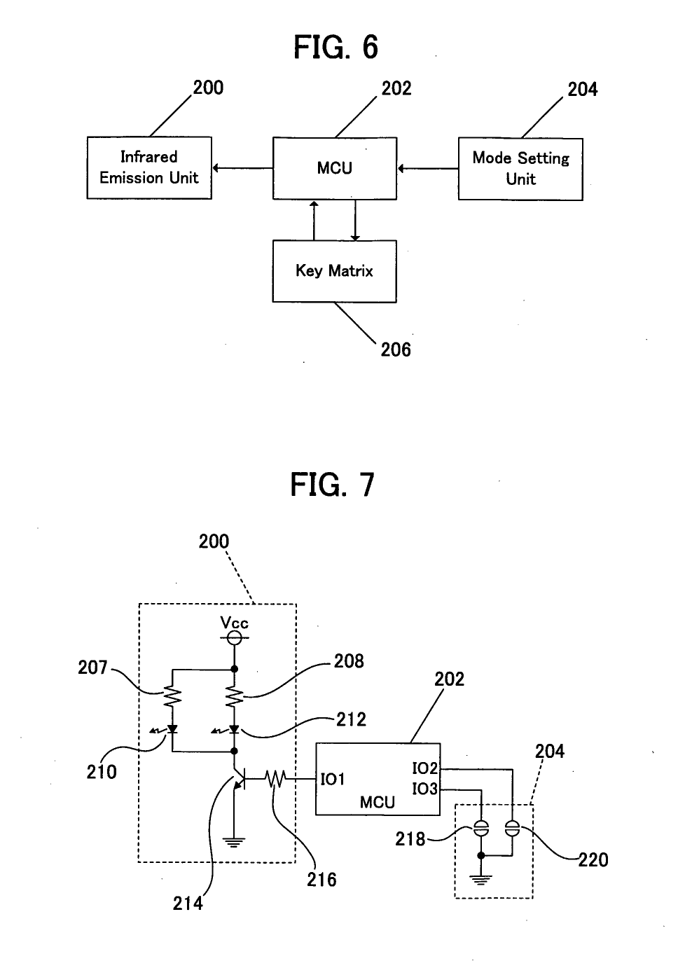

FIG. 6 is a block diagram showing the internal configuration of the mat unit 7 of FIG. 1. As shown in FIG. 6, the mat unit 7 includes an infrared emission unit 200, the MCU (microcontroller unit) 202, a mode setting unit 204 and a key matrix 206. The infrared emission unit 200, the MCU 202, the mode setting unit 204, and part of the key matrix 206 (i.e., those circuits other than the foot switches SW1 to SW4) are housed in the circuit box 4. The remaining part of the key matrix 206 (i.e., the foot switches SW1 to SW4) are located inside of the mat 2.

The mode setting unit 204 serves to set one of four modes MO1 to MO4 in accordance with the type of the key matrix 206. The MCU 202 performs various types of arithmetic operations in accordance with a program stored in an internal ROM (not shown in the figure). More specifically speaking, the MCU 202 performs key scanning of the key matrix 206 in accordance with the mode which is set by the mode setting unit 204. Then, the MCU 202 drives the infrared emission unit 200 and transmits the result of key scanning to the IR receiver circuit 71 of the adapter 1.

FIG. 7 is a circuit diagram showing the infrared emission unit 200 and the mode setting unit 204 of FIG. 6. As shown in FIG. 7, the mode setting unit 204 includes two short lands 218 and 220. The respective short lands 218 and 220 are short circuited or opened in order to set I/O ports IO2 and IO3 of the MCU 202 to a “1” (high) or a “0” (low). One of the modes MO1 to MO4 can be set in accordance with the values which are set at the I/O ports IO2 and IO3 respectively.

The infrared emission unit 200 includes resistor elements 207 and 208, the infrared light emitting diodes 210 and 212, a transistor 214 and a resistor element 216. The resistor element 207 and infrared light emitting diode 210 which are connected in series, and the resistor element 208 and infrared light emitting diode 212 which are connected in series are connected in parallel between a power potential Vcc and the collector of the transistor 214. The emitter of the transistor 214 is grounded, and the resistor element 216 is connected between the base of the transistor 214 and the I/O port IO1 of the MCU 202.

When a “1” (high) is set to the I/O port IO1 of the MCU 202, the transistor 214 is turned on to turn on the infrared light emitting diodes 210 and 212, while when a “0” (low) is set to the I/O port IO1 of the MCU 202, the transistor 214 is turned off to turn off the infrared light emitting diodes 210 and 212.

The MCU 202 sets a value to the I/O port IO1 in accordance with the result of key scanning to turn on/off the transistor 214 such that the infrared light emitting diodes 210 and 212 are turn off or on. By this configuration, the result of key scanning is transmitted to the IR receiver circuit 71 of the adapter 1, and given to the high speed processor 91 from the IR receiver circuit 71 through the terminals T17 and t17. The high speed processor 91 acquires the on/off information of the foot switches SW1 to SW4 of the mat 2 from the received data, performs arithmetic operations in accordance with the information, and generates the video signal VD and the audio signals AL1 and AR1.

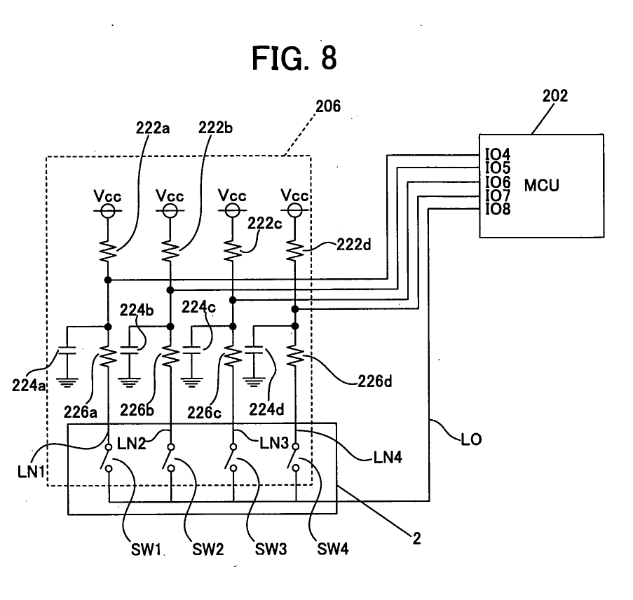

FIG. 8 is a circuit diagram showing the key matrix 206 of FIG. 6. As shown in FIG. 8, the resistor elements 222a and 226a are connected in series between one contact of the foot switch SW1 and a power supply Vcc. A capacitor 224a and the I/O port IO4 (input) are connected to the connecting point between the resistor elements 222a and 226a. Resistor elements 222b and 226b are connected between one contact of the foot switch SW2 and the power supply Vcc. A capacitor 224b and the I/O port IO5 (input) are connected to the connecting point between the resistor elements 222b and 226b.

Resistor elements 222c and 226c are connected between one contact of the foot switch SW3 and the power supply Vcc. A capacitor 224c and the I/O port IO6 (input) are connected to the connecting point between the resistor elements 222c and 226c. Resistor elements 222d and 226d are connected between one contact of the foot switch SW4 and the power supply Vcc. A capacitor 224d and the I/O port IO7 (input) are connected to the connecting point between the resistor elements 222d and 226d.

The other contacts of the foot switches SW1 to SW4 are commonly connected to the I/O port IO8 (output). In the case where the key matrix 206 as illustrated in the figure is incorporated, the mode M04 is set to the mode setting unit 204 while the short lands 218 and 220 are opened respectively.

During key scanning, the MCU 202 sets a “0” (low) to the I/O port IO8. The MCU 202 then reads the values of the respective I/O ports IO4 to IO7. For example, when the foot switch SW1 is turned on, the connecting point between the resistor elements 222a and 226a falls to a low level such that a “0” (low) is set to the I/O port IO4. On the other hand, when the foot switch SW1 is turned off, the connecting point between the resistor elements 222a and 226a becomes to a high level such that a “1” (high) is set to the I/O port IO4. As has been discussed above, when a foot switch is turned on, a “0” is set to the corresponding I/O port, and when a foot switch is turned off, a “1” is set to the corresponding I/O port.

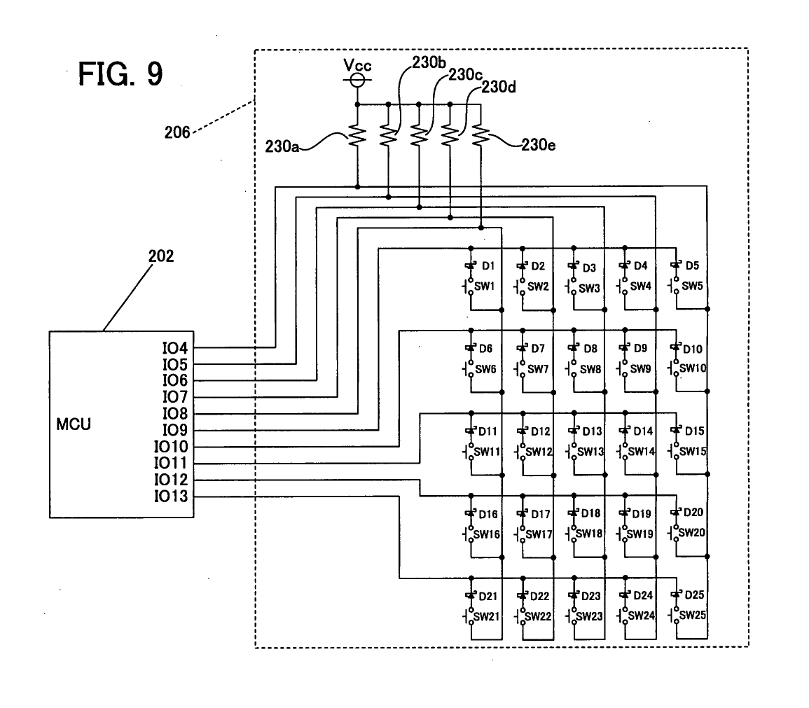

FIG. 9 is a circuit diagram showing another example of the key matrix 206 of FIG. 6. In the case where the key matrix 206 as illustrated in this figure is incorporated, the mode MO1 is set to the mode setting unit 204 while the short lands 218 and 220 are short circuited respectively.

As shown in FIG. 9, 25 key switches SW1 to SW25 are arranged in a matrix. Needless to say, in correspondence with the key switches SW1 to SW25, the mat incorporating the key matrix 206 of FIG. 9 is provided with step areas ST1 to ST25 (not shown in the figure) which are set out in five rows and five columns in the form of a rectangular array. Also, schottky diodes D1 to D25 are provided at the output contacts of the key switches SW1 to SW25 respectively in order not to prevent current from passing among these output contacts.

One contacts of the respective key switches SW1 to SW5 are connected to the I/O port IO9 (output) through the diodes D1 to D5 respectively; one contacts of the respective key switches SW6 to SW10 are connected to the I/O port IO10 (output) through the diodes D6 to D10 respectively; one contacts of the respective key switches SW11 to SW15 are connected to the I/O port IO11 (output) through the diodes D1 to D15 respectively; one contacts of the respective key switches SW16 to SW20 are connected to the I/O port IO12 (output) through the diodes D16 to D20 respectively; and one contacts of the respective key switches SW21 to SW25 are connected to the I/O port IO13 (output) through the diodes D21 to D25 respectively.

A resistor element 230a is connected between the power potential Vcc and the I/O port IO4 (input). A resistor element 230b is connected between the power potential Vcc and the I/O port IO5 (input). A resistor element 230c is connected between the power potential Vcc and the I/O port IO6 (input). A resistor element 230d is connected between the power potential Vcc and the I/O port IO7 (input). A resistor element 230e is connected between the power potential Vcc and the I/O port IO8 (input).

When performing key scanning, the MCU 202 sequentially sets the I/O ports IO9 to IO13 respectively to a “0” (low), and reads the values of the I/O ports IO4 to IO8 (input). By this configuration, the MCU 202 can acquire on/off information of all the key switch SW1 to SW25.

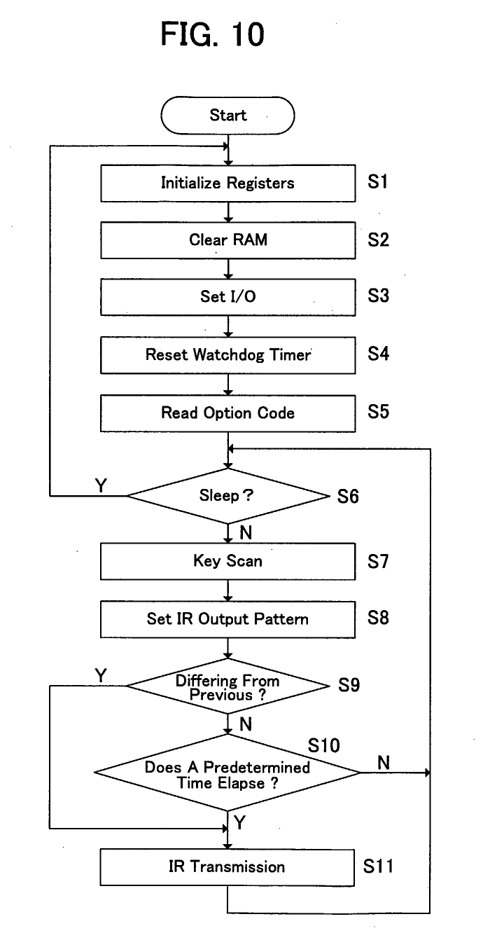

FIG. 10 is a flow chart showing the processing of the MCU 202 of FIG. 6. As shown in FIG. 10, the MCU 202 initializes the respective control registers inside thereof in step S1. In step S2, the MCU 202 clears a RAM (not shown in the figure) provided therein. In step S3, the MCU 202 sets the respective I/O ports to initial values. In step S4, the MCU 202 resets a watchdog timer (not shown in the figure) for the purpose of detecting runaway process. In step S5, the MCU 202 reads an option code. The option code comprises the values of the I/O ports IO2 and IO3 which are set by the mode setting unit 204.

In step S6, the MCU determines whether or not the system is in a sleep mode, and if it is in the sleep mode, the process proceeds to step S1, otherwise proceeds to step S7. In step S7, the MCU 202 performs key scanning of the key matrix 206 in accordance with the mode which is set by the mode setting unit 204. In step S8, the MCU 202 writes an IR (infrared ray) output pattern to the RAM in accordance with the result of key scanning. The IR output pattern is a pattern indicative of the result of key scanning.

It is determined in step S9 whether or not the IR output pattern which is set in step S8 is the same as the IR output pattern in accordance with the previous result of key scanning, and if not the same, the process proceeds to step S11, otherwise proceeds to step S10. In step S10, the MCU 202 determines whether or not a predetermined time elapses, and if it does not elapse the process proceeds to step S6, otherwise proceeds to step S11.

In step S11, the MCU 202 sets the I/O port IO1 to values in accordance with the IR output pattern which is written to the RAM, and drives the infrared light emitting diodes 210 and 212 to transmit the IR output pattern, that is the result of key scanning, to the IR receiver circuit 71 of the adapter 1. Thereafter, the processing proceeds to step S6.

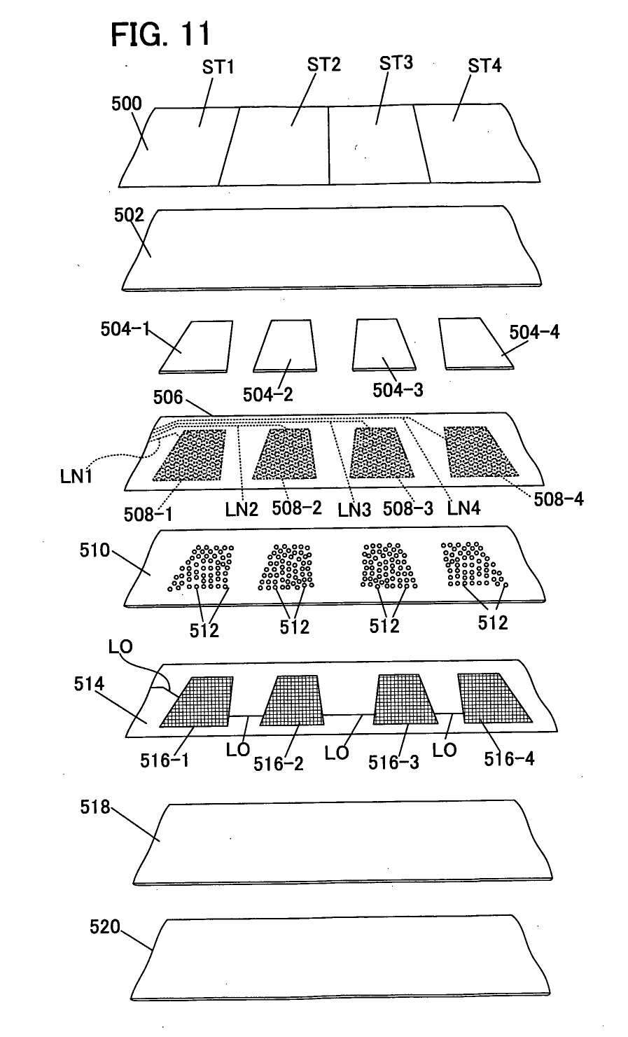

FIG. 11 is an exploded perspective view which shows the structure of the mat 2 of FIG. 1. As shown in FIG. 11, the mat 2 includes a bottom seat 520, a buffer seat 518, a lower electrode sheet 514, an insulating spacer 510, an upper electrode sheet 506, pads 504-1 to 504-4, a buffer sheet 502 and a top sheet 500.

The bottom seat 520 is provided as the undermost layer; the buffer seat 518 is provided as a layer just over the bottom seat 520; the lower electrode sheet 514 is provided as a layer just over the buffer seat 518; the spacer 510 is provided as a layer just over the lower electrode sheet 514; the upper electrode sheet 506 is provided as a layer just over the spacer 510; the pads 504-1 to 504-4 are provided as a layer just over the upper electrode sheet 506; the buffer seat 502 is provided as a layer just over the pads 504-1 to 504-4; and the top sheet 500 is provided as a layer (the uppermost layer of the mat 2) just over the buffer seat 502.

The lower electrode sheet 514 is provided with conductive regions 516-1 to 516-4 which are connected to each other by conductive regions LO. A plurality of holes 512 are formed through the spacer 510 in each of the regions corresponding respectively to the conductive regions 516-1 to 516-4. Also, the upper electrode sheet 506 is provided with conductive regions 508-1 to 508-4 which are corresponding respectively to the conductive regions 516-1 to 516-4 of the lower electrode sheet 514. Furthermore, the upper electrode sheet 506 is provided with a conductive region LN1 connected to the conductive region 508-1, a conductive region LN2 connected to the conductive region 508-2, a conductive region LN3 connected to the conductive region 508-3, and a conductive region LN4 connected to the conductive region 508-4.

The lower electrode sheet 514, the spacer 510 and the upper electrode sheet 506 are laminated in order that the conductive regions 516-1 to 516-4 of the lower electrode sheet 514 and the conductive regions 508-1 to 508-4 of the upper electrode sheet 506 are opposed respectively to each other with the spacer 510 intervening therebetween. Accordingly, the conductive regions 516-1 to 516-4 and LO are formed on the upper surface of the lower electrode sheet 514, and the conductive regions 508-1 to 508-4 and LN1 to LN4 are formed on the bottom surface of the upper electrode sheet 506. Meanwhile, the conductive regions 508-1 to 508-4 and LN1 to LN4 are illustrated with chain lines in FIG. 11 because these regions are located in the bottom surface of the upper electrode sheet 506.

The foot switch SW1 is made up of the conductive region 516-1 of the lower electrode sheet 110, the conductive region 508-1 of the upper electrode sheet 506, and the region of the spacer 510 corresponding thereto (including the plurality of holes 512). The foot switch SW2 is made up of the conductive region 516-2, the conductive region 508-2 and the region of the spacer 510 corresponding thereto (including the plurality of holes 512). The foot switch SW3 is made up of the conductive region 516-3, the conductive region 508-3 and the region of the spacer 510 corresponding thereto (including the plurality of holes 512). The foot switch SW4 is made up of the conductive region 516-4, the conductive region 508-4 and the region of the spacer 510 corresponding thereto (including the plurality of holes 512). For example, the foot switches SW1 to SW4 are membrane switches.

The top sheet 500 and the buffer seat 502 are bonded with double-stick tapes (not shown in the figure). In this case, the double-stick tapes are attached to the boundary between the step areas ST1 and ST2, the boundary between the step areas ST2 and ST3, and the boundary between the step areas ST3 and ST4. The upper surfaces of the pads 504-1 to 504-4 and the buffer seat 502 are bonded by a double-stick tape (not shown in the figure), and the lower surfaces of the pads 504-1 to 504-4 and the upper electrode sheet 506 are bonded by a double-stick tape (not shown in the figure).

Then, the bottom seat 520, the buffer seat 518, the lower electrode sheet 514, the spacer 510, the upper electrode sheet 506, the pads 504-1 to 504-4, the buffer seat 502 and the top sheet 500 are hemmed with a cloth tape (not shown in the figure) and sewed with a thread (not shown in the figure). The mat 2 are made up in this way. The cloth tape as used is, for example, a bias tape.

The material of the top sheet 500 is, for example, EVA (ethylene vinyl acetate copolymer). Also, the material of the buffer seat 502, the pads 504-1 to 504-4 and the buffer seat 518 is, for example, polyethylene foam. Also, the material of the electrode sheets 506 and 514 is, for example, a transparent sheet made of polypropylene. Also, the material of the bottom seat 520 is, for example, EVA foam.

Returning to FIG. 1, in the case of the present embodiment, a picture as illustrated in FIG. 1 is printed by screen printing on the rear surface of the top sheet 500 which is transparent.

As has been discussed above, in the case of the present embodiment, the detection result by the mat unit 7 is transmitted to the adapter 1 by infrared light, and then given to the high speed processor 91. Since the detection result by the mat unit 7 is transmitted by wireless communication in this manner, the limitation on the installation location of the mat unit 7 can be lessened. Also, as compared with wired communications, it is avoided that a cable trips the player, and safety can be secured.

### Embodiment 2

The hardware of the mat system of the embodiment 1 is used also as the hardware of the simulated experience apparatus of the embodiment 2 of the present invention.

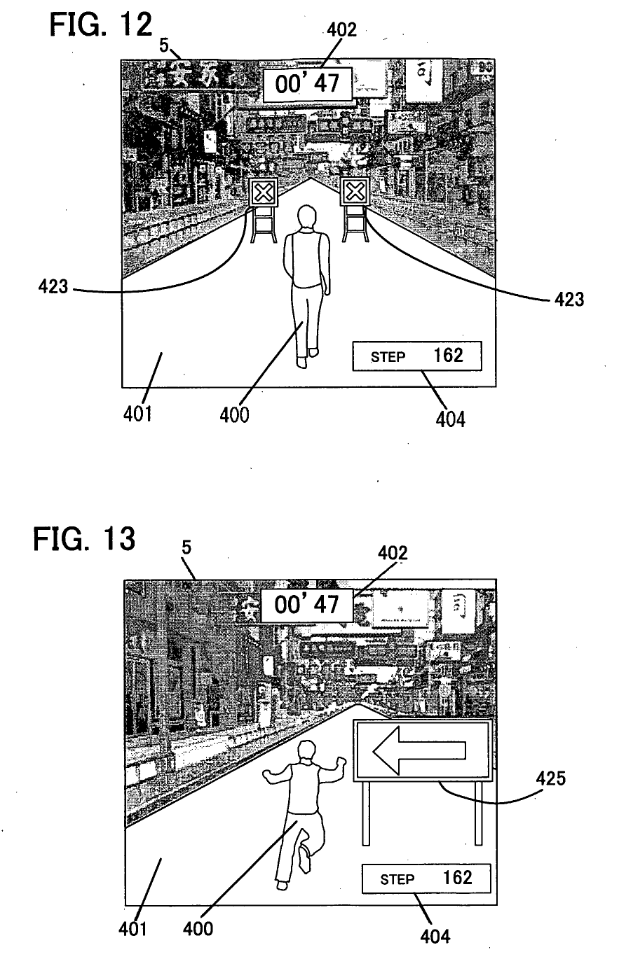

FIG. 12 is a view showing an example of a screen as displayed on the television monitor 5 of FIG. 1 by the simulated experience apparatus of the embodiment 2. As shown in FIG. 12, a background 401 including a street image, a manipulation object 400 as a human image, obstacle objects 423, an elapsed time display area 402, and a step count display area 404 are displayed on the television monitor 5.

When the player steps on the mat 2 of FIG. 1, the high speed processor 91 detects the stepping by the player by receiving the on/off signals transmitted from the foot switches SW1 to SW4, and adjusts the animation speed of the background 401 and the manipulation object 400 in accordance with the speed of stepping. This process provides a motion image depicting the manipulation object 400 walking forward in accordance with the stepping speed of the player. In other words, the player can control the walking speed of the manipulation object 400 by adjusting the stepping speed. Incidentally, the term “forward” is used to indicate the direction toward the front of a virtual space generated by the high speed processor 91.

The elapsed time display area 402 indicates the elapsed time after starting this system. The step count display area 404 is used to display the number of steps by the player after starting this system.

FIG. 13 is a view showing another example of a screen as displayed on the television monitor 5 of FIG. 1 by the simulated experience apparatus of the embodiment 2. As shown in FIG. 13, the background 401, the manipulation object 400, an obstacle object 425, the elapsed time display area 402, and the step count display area 404 are displayed on the television monitor 5.

When the player shifts the stepping position (side steps) on the mat 2, the high speed processor 91 detects the shift of the stepping position by the player by receiving the on/off signals transmitted from the foot switches SW1 to SW4, and moves the manipulation object 400 to the left or the right in accordance with the shift of the stepping position. By this configuration, the player can move the manipulation object 400 to the left or the right by adjusting the stepping position. Incidentally, the terms “left” and “right” are used to indicate the directions toward the left and right of the virtual space generated by the high speed processor 91.

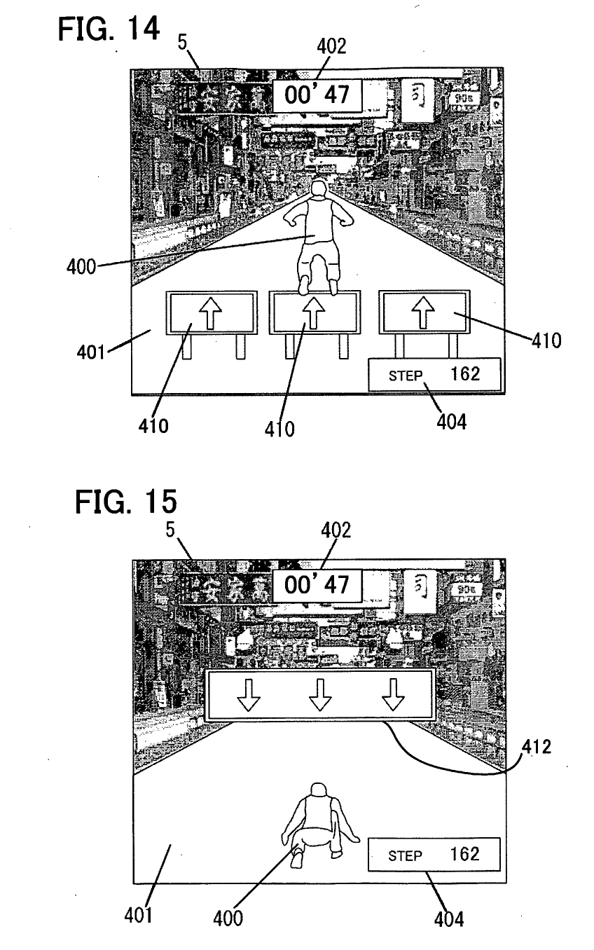

FIG. 14 is a view showing a further example of a screen as displayed on the television monitor 5 of FIG. 1 by the simulated experience apparatus of the embodiment 2. As shown in FIG. 14, the background 401, the manipulation object 400, obstacle objects 410, the elapsed time display area 402, and the step count display area 404 are displayed on the television monitor 5.

When the player jumps on the mat 2, the high speed processor 91 detects the jumping motion by the player by receiving the on/off signals transmitted from the foot switches SW1 to SW4, and lets the manipulation object 400 jump. By this configuration, the player can let the manipulation object 400 jump by jumping on the mat 2. Incidentally, the term “jump” is used to indicate the jumping motion in the virtual space generated by the high speed processor 91.

FIG. 15 is a view showing a still further example of a screen as displayed on the television monitor 5 of FIG. 1 by the simulated experience apparatus of the embodiment 2. As shown in FIG. 15, the background 401, the manipulation object 400, an obstacle object 412, the elapsed time display area 402, and the step count display area 404 are displayed on the television monitor 5.

When the player pushes either or both hands to the mat 2 while getting on the mat 2, the high speed processor 91 detects that the player squats down by receiving the on/off signals transmitted from the foot switches SW1 to SW4, and lets the manipulation object 400 squat down. By this configuration, the player can let the manipulation object 400 squat down by squatting down on the mat 2. Incidentally, the term “squat” is used to indicate the squatting motion in the virtual space generated by the high speed processor 91.

As illustrated in FIG. 12 to FIG. 15, the player controls the forward speed of the manipulation object 400 by adjusting the stepping speed in order to move forward the manipulation object 400, while performing the action of shifting the stepping position, jumping and squatting down in order to avoid the obstacle objects 423, 425, 410 and 412.

Furthermore, motion instruction marks are provided on the obstacle objects 423, 425, 410 and 412 in order to instruct the player on what direction he is to move. Namely, the obstacle object 423 is labeled a motion instruction mark of “x”; the obstacle object 425 is labeled a motion instruction mark of a left-pointing arrow (instruction to step to the left); the obstacle object 410 is labeled a motion instruction mark of an up-pointing arrow (instruction to jump); and the obstacle object 412 is labeled a motion instruction mark of an down-pointing arrow (instruction to squat down). Incidentally, although not shown in the figures, there is an obstacle object labeled a motion instruction mark of a right-pointing arrow (instruction to step to the right).

As a result, the obstacle objects 423, 425, 410 and 412 can be referred to also as indication objects.

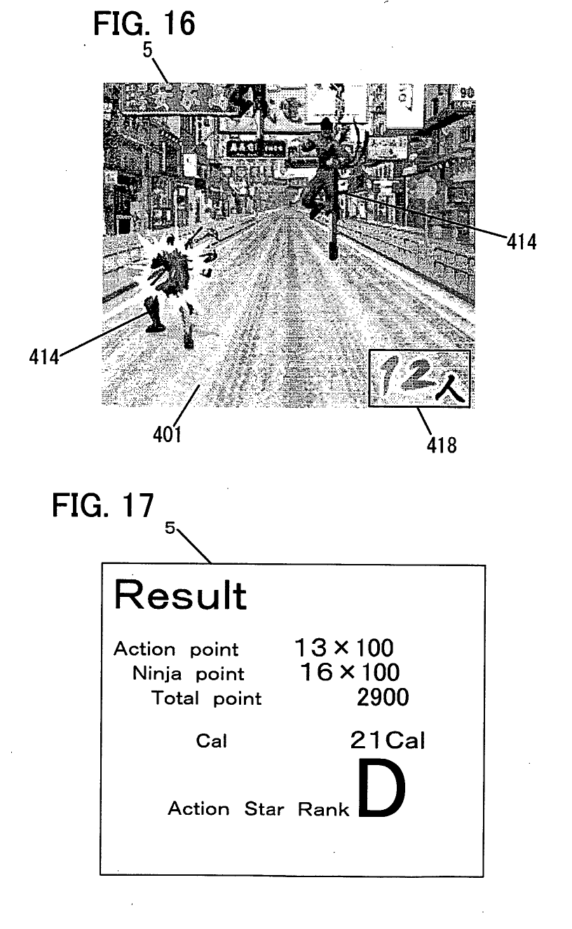

FIG. 16 is a view showing a still further example of a screen as displayed on the television monitor 5 of FIG. 1 by the simulated experience apparatus of the embodiment 2. As shown in FIG. 16, ninja objects 414 appear under certain conditions. The player can hit an attack on the ninja object 414 by stepping on the step area corresponding to the appearance position of the ninja object 414 at the time when the ninja object 414 lands to turn on the corresponding foot switch. In the figure, the ninja object 414 in the left hand side is displayed with an effect indicative of the hit of an attack.

Incidentally, four positions are set in the screen as the appearance positions of the ninja objects 414 in the horizontal direction (perpendicular to the moving direction of the manipulation object 400). These four appearance positions correspond to the step areas ST1 to ST4 (the foot switches SW1 to SW4) respectively. Also, the number of the ninja objects 414 on which an attack is hit is displayed in a hit count display area 418.

FIG. 17 is a view showing a further example of an outcome screen as displayed on the television monitor 5 of FIG. 1 by the simulated experience apparatus of the embodiment 2. As illustrated in FIG. 17, when a predetermined time (for example, five minutes) elapses after start, the play ends, and the outcome screen is displayed. This outcome screen includes the number of the obstacle objects 423, 425, 410 and 412 which were avoided, the number of points (action points) added each time when avoiding an obstacle object, the number of hits by attacking the ninja objects 414, the number of points (ninja points) added each time when an attack is hit on a ninja object, the sum of these numbers of points (total points), and the calorie consumption (Cal). In addition to this, a rank (Action Star Rank) is displayed (in this figure, “D rank”), If appropriate, it is possible to display the success rate of avoiding the obstacle objects 423, 425, 410 and 412. Furthermore, it is also possible to determine the rank in accordance with the product of the total points and the success rate of avoiding the obstacle objects 423, 425, 410 and 412.

Next, the relationship between the motion of the manipulation object 400 and the foot switches SW1 to SW4 (the step areas ST1 to ST4) of the mat 2 will be explained.

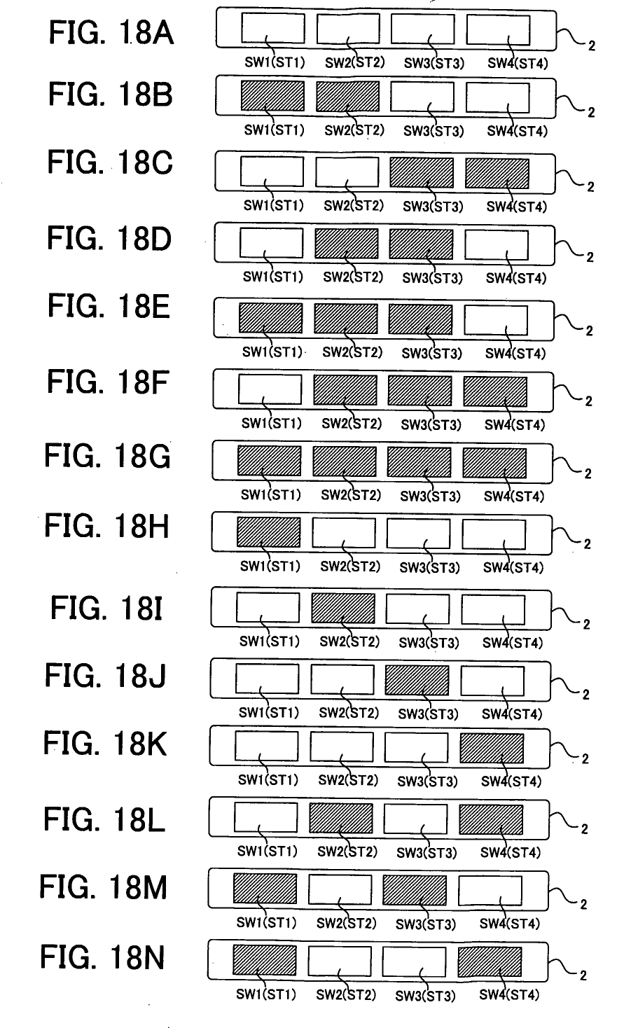

FIG. 18 is a schematic diagram showing the on/off patterns of the foot switches SW1 to SW4 of the mat 2 of FIG. 1. In FIG. 18, multiple diagonal lines are used to indicate the foot switches (step areas) which are turned on (stepped on). As shown in FIG. 18, there are 14 patterns as on/off combinations of the foot switches SW1 to SW4.

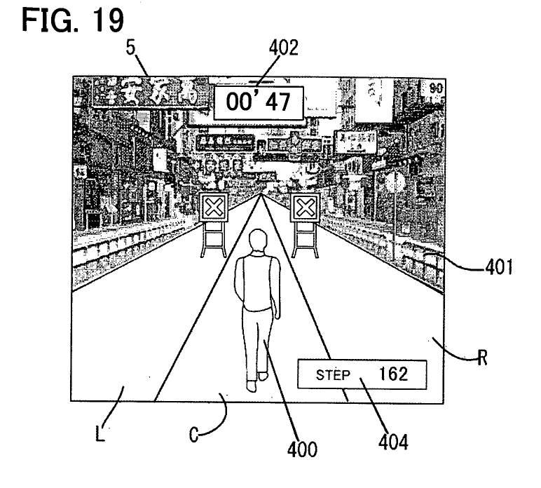

FIG. 19 is an explanatory view for showing the motion of the manipulation object 400. As shown in FIG. 19, the high speed processor 91 performs processes on the assumption that the load displayed in the background 401 comprises in a left lane L, a center lane C and a right lane R. When the mat 2 alternates the state shown in FIG. 18H and the state shown in FIG. 18I, the manipulation object 400 is displayed in order to move forward on the left lane L. When the mat 2 alternates the state shown in FIG. 18I and the state shown in FIG. 18J, the manipulation object 400 is displayed in order to move forward on the center lane C. When the mat 2 alternates the state shown in FIG. 18J and the state shown in FIG. 18K, the manipulation object 400 is displayed in order to move forward on the right lane R.

When the player jumps on the mat 2 in the state shown in FIG. 18B, FIG. 18D or FIG. 18C, the manipulation object 400 is displayed in order to jump on the left lane L, the center lane C or the right lane R respectively.

When the mat 2 is in the state shown in FIG. 18E, FIG. 18G or FIG. 18F, the manipulation object 400 is displayed in order to squat down on the left lane L, the center lane C or the right lane R respectively. Particularly, when the mat 2 is in the state shown in FIG. 18E, it is determined that the player places the feet on the step areas ST1 and ST2 and presses one hand to the step area ST3 (in a squatting position). Also, when the mat 2 is in the state shown in FIG. 18G, it is determined that the player places the feet on the step areas ST2 and ST3 and presses left and right hands to the step areas ST1 and ST4 respectively (in a squatting position). Furthermore, when the mat 2 is in the state shown in FIG. 18F, it is determined that the player places the feet on the step areas ST3 and ST4 and presses the other hand to the step area ST2 (in a squatting position).

When the stepping position of the player shifts from the state shown in FIG. 18H and FIG. 18I to the state shown in FIG. 18I and FIG. 18J, the manipulation object 400 moves from the left lane L to the center lane C. When the stepping position of the player shifts from the state shown in FIG. 18H and FIG. 18I to the state shown in FIG. 18J and FIG. 18K, the manipulation object 400 moves from the left lane L to the right lane R.

When the stepping position of the player shifts from the state shown in FIG. 18I and FIG. 18J to the state shown in FIG. 18H and FIG. 18I, the manipulation object 400 moves from the center lane C to the left lane L. When the stepping position of the player shifts from the state shown in FIG. 18I and FIG. 18J to the state shown in FIG. 18J and FIG. 18K, the manipulation object 400 moves from the center lane C to the right lane R.

When the stepping position of the player shifts from the state shown in FIG. 18J and FIG. 18K to the state shown in FIG. 18I and FIG. 18J, the manipulation object 400 moves from the right lane R to the center lane C. When the stepping position of the player shifts from the state shown in FIG. 18J and FIG. 18K to the state shown in FIG. 18H and FIG. 18I, the manipulation object 400 moves from the right lane R to the left lane L.

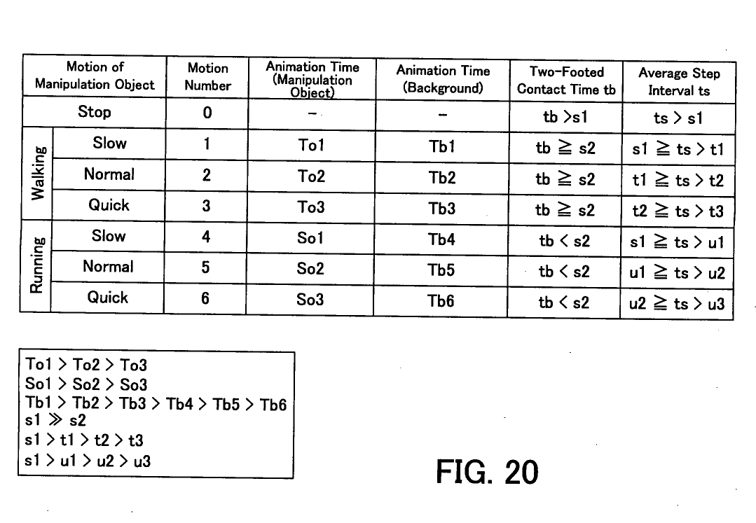

FIG. 20 is an explanatory view of a table (hereinafter referred to as “animation control table”) showing the relation among the motion of the manipulation object 400, the motion number, the animation time of the manipulation object, the animation time of the background, the two-footed contact time for which both feet are placed on the mat 2, and the average step interval. As shown in FIG. 20, the motion numbers “0” to “6” are numbers assigned to the respective motions of the manipulation object 400.

In the case of the present embodiment, motion images of the manipulation object 400 are prepared corresponding respectively to a stop state, a walking state (slow walking, normal walking and quick walking), and a running state (slow running, normal running, quick running). More specifically speaking, these motion images include one image frame showing that the manipulation object 400 stops, 12 image frames showing that the manipulation object 400 walks, and 12 image frames showing that the manipulation object 400 runs. In this description, with respect to an animation of an object or a background, the term “image frame” is used to represent one of the image elements (static images) of which the animation (motion image) is made up. Also, in the case of the present embodiment, there are 32 image frames as motion images of the background 401.

In this case, the slow walking, normal walking and quick walking of the manipulation object 400 can be represented by adjusting the playback time (animation time) of the respective 12 image frames showing that the manipulation object 400 walks and the playback time (animation time) of the respective 32 image frames of the background 401 in synchronization. In a like manner, the slow running, normal running and quick running of the manipulation object 400 can be represented by adjusting the playback time (animation time) of the respective 12 image frames showing that the manipulation object 400 runs and the playback time (animation time) of the respective 32 image frames of the background 401 in synchronization.

In other words, animation times T1, T2 and T3 are assigned to the slow walking, normal walking and quick walking respectively. Needless to say, T1>T2>T3. Also, animation times S1, S2 and S3 are assigned to the slow running, normal running and quick running respectively. Needless to say, S1>S2>S3. In the stop state, a single still image is continuously displayed.

Also, animation times “Tb1”, “Tb2”, “Tb3”, “Tb4”, “Tb5” and “Tb6” of the background 401 are assigned respectively to the slow walking, normal walking and quick walking, and the slow running, normal running and quick running. Incidentally, Tb1>Tb2>Tb3>Tb4>Tb5>Tb6. In the stop state, a single still image is continuously displayed.

The two-footed contact time “tb” of the player is the period of time for which two of the foot switches SW1 to SW4 are turned on at the same time. If the two-footed contact time “tb” is longer than a predetermined time “s1” (for example, 50 video frames), the stopping image of the manipulation object 400 and the background 401 which is stopped are displayed. If the two-footed contact time “tb” is not longer than the predetermined time “s1” but the two-footed contact time “tb” is longer than a predetermined time “s2” (for example, 7 video frames), the walking motion image of the manipulation object 400 is displayed. On the other hand, if the two-footed contact time “tb” is smaller than the predetermined time “s2”, the running motion image of the manipulation object 400 is displayed.

Next, the average step interval “ts” will be explained. The step interval of the player is defined as the interval between the time when one foot switch of the foot switches SW1 to SW4 is turned on and the time when another foot switch is turned on. The average of such step intervals are called the average step interval “ts”. In the case of the present embodiment, the average step interval “ts” is calculated as the average of latest four step intervals. Incidentally, the average step interval “ts” is calculated as an integer.

If the two-footed contact time “tb” as measured satisfies that tb>s1 or if the average step interval “ts” as calculated satisfies that ts>s1, the high speed processor 91 selects the stop state (motion number “0”). Also, the high speed processor 91 determines which of the two-footed contact time “tb” and the predetermined time “s2” is greater than the other, and selects either the walking state (motion numbers 1 to 3) or the running state (motion numbers 4 to 6) in accordance with the determination. Then, in the case where the motion state as selected is the walking state, the high speed processor 91 selects one of the motion numbers (one of 1 to 3) corresponding to the range within which the average step interval “ts” falls. On the other hand, in the case where the motion state as selected is the running state, the high speed processor 91 selects one of the motion numbers (one of 4 to 6) corresponding to the range within which the average step interval “ts” falls.

Furthermore, the high speed processor 91 calculates the motion average “May” of the selected motion numbers. In the case of the present embodiment, the motion average “Mav” of the eight motion numbers as selected in the latest and past times (the following equation) is calculated. In the following equation, “Sum/8” is the motion average calculated in the last time. Incidentally, the motion average “May” is obtained as an integer.

Sum#=Sum−(Sum/8)+the latest motion number (1)

Mav=Sum#/8 (2)

Then, the high speed processor 91 refers to the animation control table, and generates the animation of the manipulation object 400 and the background 401 in the motion state assigned to the motion number corresponding to the current value of the motion average “Mav”.

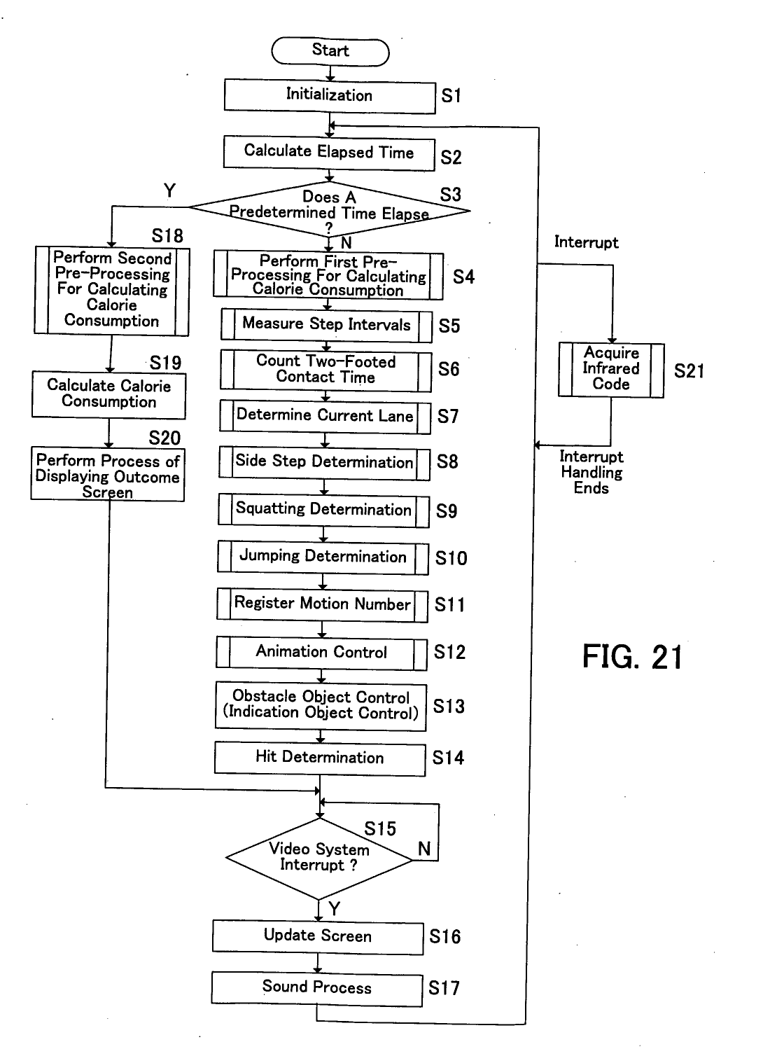

FIG. 21 is a flow chart showing an example of the overall process flow by the high speed processor 91 of FIG. 5 which is used in the simulated experience apparatus in accordance with the embodiment 2 of the present invention. As shown in FIG. 21, the high speed processor 91 performs the general initialization of the system in step S1. Specifically, the system and the respective variables are initialized.

In step S2, the high speed processor 91 calculates the elapsed time from the start time. In the case of the present embodiment, since the video frame is updated at 1/60 second intervals (in step S15 to be described below), the elapsed time can be calculated by counting the video frames when updated. In step S3, the high speed processor 91 determines whether or not a predetermined time “Tc” (for example, five minutes) elapses, and if it elapses, the process proceeds to step S18, otherwise proceeds to step S4.

In step S4, the high speed processor 91 performs a first pre-processing for calculating the calorie consumption of the player. In step S5, the high speed processor 91 measures the step intervals of the player and calculates the average step interval “ts”. In step S6, the high speed processor 91 counts the two-footed contact time “tb” of the player.

In step S7, the high speed processor 91 determines the lane (referred to hereinafter as the “current lane”) in which the manipulation object 400 is to be located in the next video frame on the basis of the previous lane information and the latest on/off information of the foot switches SW1 to SW4. The previous lane is the lane in which the manipulation object 400 being currently displayed is located. The lane is either the left lane L, the center lane C or the right lane R (refer to FIG. 19).

In step S8, the high speed processor 91 determines whether or not the player performs a side step on the basis of the information about the current lane and the information about the previous lane. In step S9, the high speed processor 91 determines whether or not the player squats down on the basis of the previous lane information and the latest on/off information of the foot switches SW1 to SW4. In step S10, the high speed processor 91 determines whether or not the player jumps. More specifically speaking, in the case where the two-footed contact time “tb” is longer than the predetermined time “tj” (for example, 10 video frames) just before the no input state (in which all the foot switches SW1 to SW4 are turned off), the high speed processor 91 determines the player jumps.

In step S1, the high speed processor 91 acquires the motion number on the basis of the average step interval “ts”, the motion average “Mav” as calculated from the motion numbers, and the animation control table (refer to FIG. 20). In step S12, the high speed processor 91 controls the animation of the background 401 and the animation of the manipulation object 400 in accordance with the acquired motion number.

When predetermined conditions are satisfied in step S13, the high speed processor 91 performs the process of displaying the obstacle objects 423, 425, 410 or 412, or the ninja object 414. More specifically speaking, the high speed processor 91 sets the storage location information and display location information of the image data showing the corresponding object(s) in the internal memory (not shown in the figure).

The predetermined conditions will be explained here. For example, successive 32 image frames are prepared as the background. Then, a motion image is provided to depicting the manipulation object 400 which is walking forward by playing back looping these images. In this case, the differential walking speed of the manipulation object 400 can be expressed by adjusting the playback time of the respective image frames. The above predetermined conditions are provided in terms of how many image frames of the background have been displayed.

In step S14, the high speed processor 91 determines whether or not the manipulation object 400 collides with the obstacle object 423, 425, 410 or 412 as displayed in the virtual space, and counts the number of times that collision is avoided. Also, the high speed processor 91 determines whether or not an attack on the ninja object 414 is hit on the basis of the on/off information of the foot switches SW1 to SW4 and the land position and timing of the ninja object 414, and counts the number of hits of attacks. On the other hand, the process of displaying an effect is performed when an attack is hit. More specifically speaking, the high speed processor 91 sets the storage location information and display location information of the image data showing the effect in the internal memory (not shown in the figure).

Incidentally, in step S18, the high speed processor 91 performs a second pre-processing for calculating the calorie consumption of the player. In step S19, the high speed processor 91 calculates the calorie consumption of the player on the basis of the first and second pre-processings for calculating the calorie consumption. In step S20, the high speed processor 91 performs the process of displaying the outcome screen (refer to FIG. 17). More specifically speaking, the high speed processor 91 sets the storage location information and display location information of the image data showing the background and the respective objects (letters, numerals and the like) as the components of the outcome screen in the internal memory (not shown in the figure)

If there is an interrupt by a video system synchronous signal in step S15, the process proceeds to step S16, otherwise the process repeats the same step S15. The interrupt by the video system synchronous signal is issued at 1/60 second intervals.

In response to the interrupt by the video system synchronous signal, in step S16, the high speed processor 91 updates the display image (video frame) of the television monitor 5 on the basis of the information (the storage location information and display location information of the image data) which is set in step S12 to S14 or S20. Also, in response to the interrupt by the video system synchronous signal, the sound process in step S17 is performed, and thereby music and sound effects are output. Thereafter, the processing proceeds to step S2.

When the signal transmitted from the IR receiver circuit 71 of the adapter 1 rises from a low level to a high level, i.e., when the value of the I/O port IO18 rises from a low level to a high level, an interrupt is issued in response to this, and the process of acquiring an infrared code (IR code) is performed in step S21.

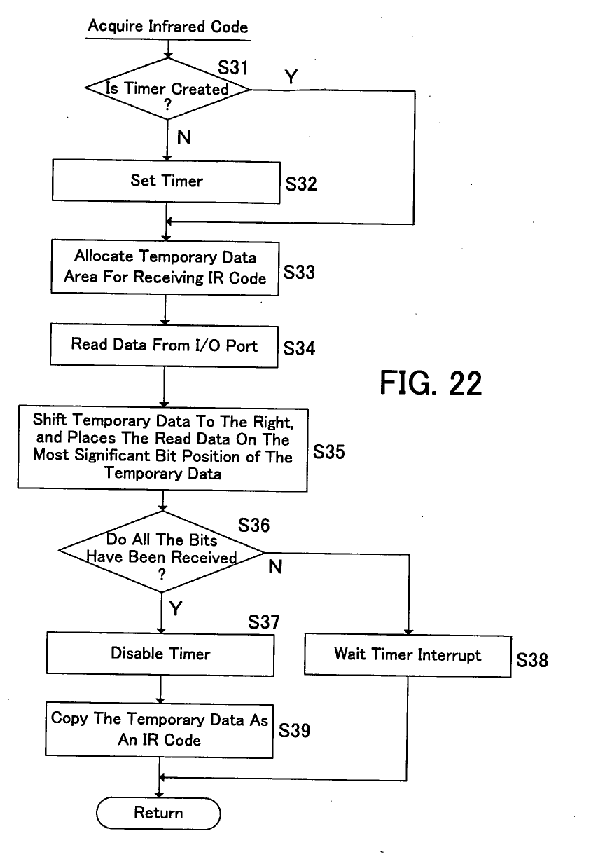

FIG. 22 is a flow chart showing an example of the process of acquiring IR codes in step S21 of FIG. 21. This IR code acquiring process is performed in response to timer interrupts, and therefore the high speed processor 91 determines whether or not a timer is operating in the first step S31. If it is “NO”, a timer is set to periodically issue interrupts in step S32, and if it is “YES” the process proceeds to step S33, skipping the step S32.

In step S33, the high speed processor 91 allocates a temporary data area for receiving an IR code in the internal memory (not shown in the figure). Then, in the next step S34, the high speed processor 91 reads data from the I/O port IO18 to which the output signal from the IR receiver circuit 71 is input. In the next step S35, the high speed processor 91 shifts the temporary data to the right, and places the data read in step S34 on the most significant bit position of the temporary data.

Thereafter, it is determined whether or not all the bits have been received in step S36, and if it is “NO” the high speed processor 91 waits for the next timer interrupt in step S38. If it is “YES”, the timer is disabled to halt issuing interrupts in step S37, the temporary data is copied as an IR code in step S39. The high speed processor 91 performs the process of FIG. 21 by the use of the IR code, i.e., the on/off information of the foot switches SW1 to SW4 of the mat 2.

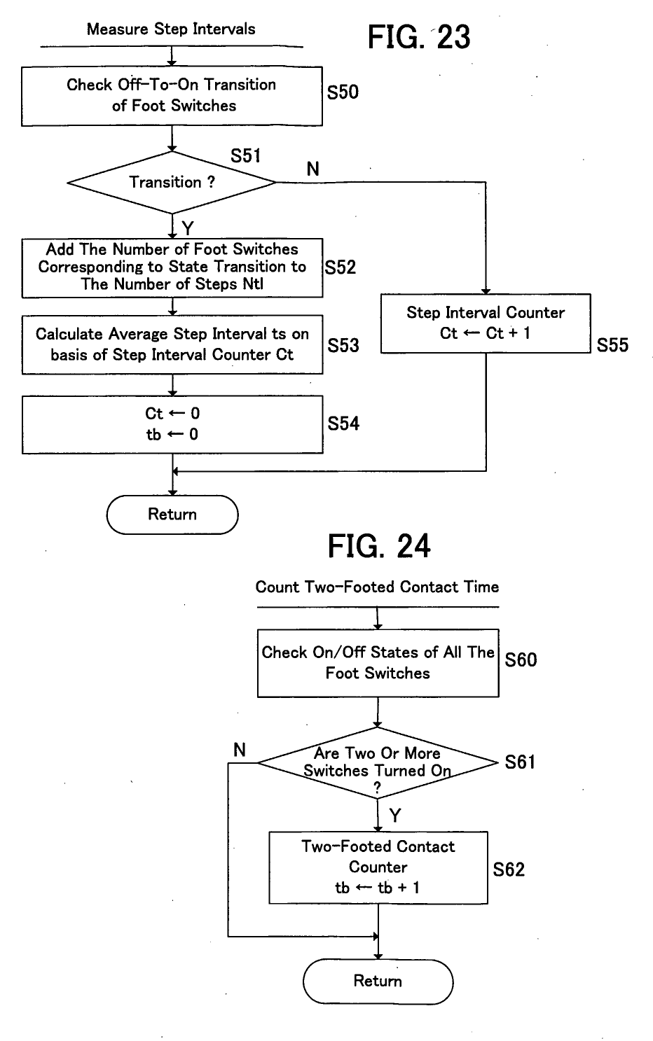

Incidentally, as has been discussed above, the process of FIG. 22 serves as the interrupt handler that is called when the value of the I/O port IO18 rises from a low level to a high level at the start of the IR code acquiring process and also serves as the interrupt handler that is called in response to the timer interrupts. FIG. 23 is a flow chart showing an example of the process of measuring the step interval in step S5 of FIG. 21. As shown in FIG. 23, in step S50, the high speed processor 91 checks the foot switches SW1 to SW4 as to whether or not there is an off-to-on state transition on the basis of the IR code as acquired at the previous time (the on/off information of the foot switches SW1 to SW4) and the IR code as acquired at the current time (the on/off information of the foot switches SW1 to SW4). If a state transition occurs in step S51, the high speed processor 91 proceeds to step S52, otherwise proceeds to step S55.

In step S55, the high speed processor 91 increments a step interval counter Ct indicative of the step interval of the player by one, and returns to the main routine. On the other hand, in step S52, the high speed processor 91 adds the number of foot switches, the states of which are changed from an off-state to an on-state, to the number of count “Ntl”. In other words, the number of count “Ntl” indicates the total number of off-to-on state transitions. The final result of the number of count “Ntl” is the total number of steps performed by the player. In step S553, the high speed processor 91 calculates the average value (average step interval) “ts” of the latest four values of the step interval counter “Ct”. Then, in step S54, the high speed processor 91 clears the step interval counter “Ct” and a two-footed contact counter “tb” indicative of the two-footed contact time of the player, and returns to the main routine.

FIG. 24 is a flow chart showing an example of the process for counting the two-footed contact time in step S6 of FIG. 21. As shown in FIG. 24, the high speed processor 91 checks the IR code as acquired at the current time, i.e., the on/off information of the foot switches SW1 to SW4 in step S60. If two or more foot switches are turned on in step S61, the high speed processor 91 proceeds to step S62 in which the two-footed contact counter “tb” is incremented by one, otherwise returns to the main routine.

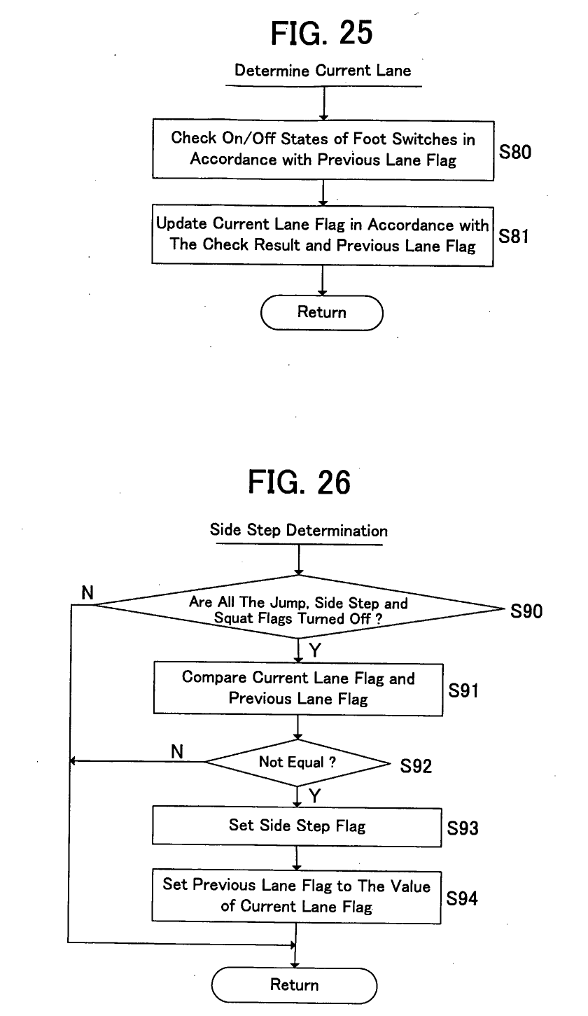

FIG. 25 is a flow chart showing an example of the process for determining the current lane in step S7 of FIG. 21. As shown in FIG. 25, the high speed processor 91 checks the IR code as acquired at the current time, i.e., the on/off information of the foot switches SW1 to SW4 in step S80 with reference to a flag indicative of the previous lane (hereinafter referred to as a “previous lane flag”). More specifically speaking, in the case where the previous lane flag indicates the left lane L, the on/off information of the foot switches SW3 and SW4 is checked. In the case where the previous lane flag indicates the center lane C, the on/off information of the foot switches SW1 and SW4 is checked. In the case where the previous lane flag indicates the right lane R, the on/off information of the foot switches SW1 and SW2 is checked.

In step S81, the high speed processor 91 sets a flag indicative of the current lane (hereinafter referred to as a “current lane flag”) to an appropriate value with reference to the check result in step S80 and the value of the previous lane flag. More specifically speaking, in the case where the previous lane flag indicates the left lane L, the current lane flag is set to a value indicative of the center lane C if the foot switch SW3 is turned on, and the current lane flag is set to a value indicative of the right lane R if the foot switch SW4 is turned on. In the case where the previous lane flag indicates the center lane C, the current lane flag is set to a value indicative of the left lane L if the foot switch SW1 is turned on, and the current lane flag is set to a value indicative of the right lane R if the foot switch SW4 is turned on. In the case where the previous lane flag indicates the right lane R, the current lane flag is set to a value indicative of the center lane C if the foot switch SW2 is turned on, and the current lane flag is set to a value indicative of the left lane L if the foot switch SW1 is turned on.

FIG. 26 is a flow chart showing an example of the side step determination process in step S8 of FIG. 21. As shown in FIG. 26, in step S90, the high speed processor 91 accesses a jump flag indicating that the manipulation object 400 is jumping, a side step flag indicating that the manipulation object 400 is laterally moving (side stepping) and a squat flag indicating that the manipulation object 400 is squatting down, and if all these flags are turned off (“0”), the process proceeds to step S91, otherwise returns to the main routine.

In step S91, the high speed processor 91 compares the current lane flag and the previous lane flag. If the lane indicated by the current lane flag is different from the lane indicated by the previous lane flag in step S92, the high speed processor 91 proceeds to step S93. In other words, if the value of the current lane flag is different from the value of the previous lane flag, it means that the lane on which the manipulation object 400 is displayed is changed in the next video frame.

Accordingly, in step S93, the high speed processor 91 sets the side step flag to a value corresponding to the change of the lane. The kinds of changing the lane include changing from the left lane L to the center lane C, changing from the left lane L to the right lane R, changing from the center lane C to the left lane L, changing from the center lane C to the right lane R, changing from the right lane R to the center lane C, or changing from the right lane R to the left lane L. Accordingly, the side step flag is set to one of values which indicate these changes respectively. Incidentally, if the lane is not changed, the side step flag is turned off (“0”). In step S94, the high speed processor 91 sets the previous lane flag to the value of the current lane flag, and returns to the main routine.

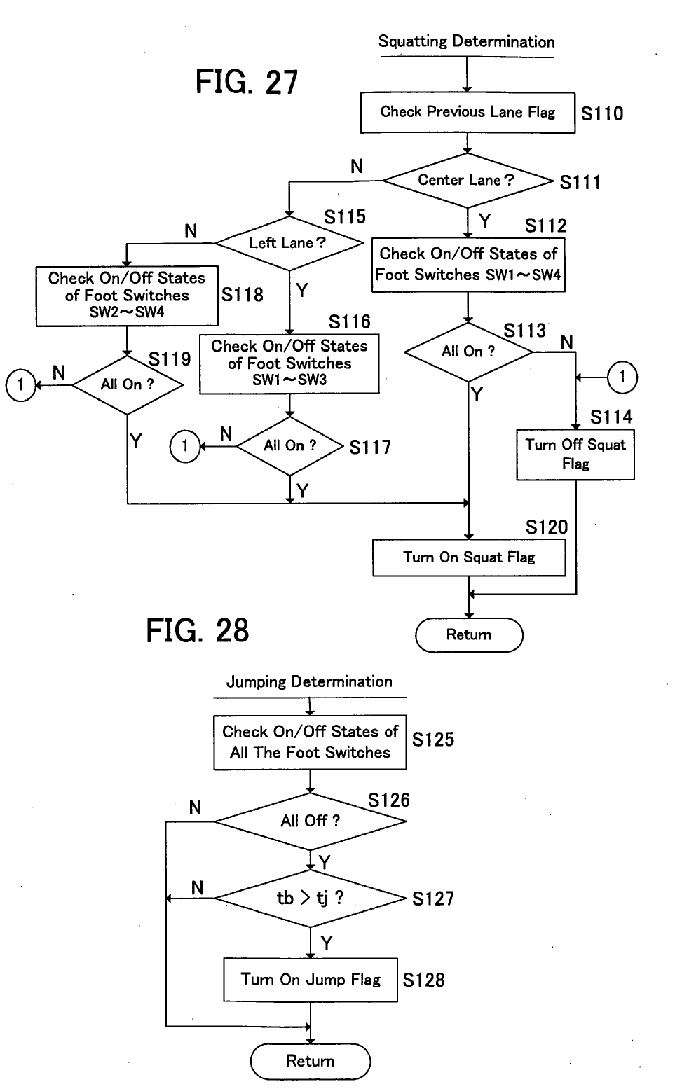

FIG. 27 is a flow chart showing an example of the squatting determination process in step S9 of FIG. 21. As shown in FIG. 27, the high speed processor 91 checks the previous lane flag in step S110. When the previous lane flag indicates the center lane C in step S111, the high speed processor 91 proceeds to step S112, otherwise proceeds to step S115. Since the previous lane flag is set to the value of the current lane flag in step S94 of FIG. 26, the previous lane flag indicates the lane on which the manipulation object 400 is to be located in the next video frame in the process of FIG. 27.

In step S112, the high speed processor 91 checks the on/off information of the foot switches SW1 to SW4 with reference to the IR code as acquired at the current time. When all the foot switches SW1 to SW4 are turned on in step S113, the high speed processor 91 proceeds to step S120, otherwise proceeds to step S114.

When the previous lane flag indicates the left lane L in step S115, the high speed processor 91 proceeds to step S116, otherwise, i.e., when the previous lane flag indicates the right lane R, the process proceeds to step S118. In step S116, the high speed processor 91 checks the on/off information of the foot switches SW1 to SW3 with reference to the IR code as acquired at the current time. When all of the foot switches SW1 to SW3 are turned on in step S117, the high speed processor 91 proceeds to step S120, otherwise proceeds to step S114.

In step S118, the high speed processor 91 checks the on/off information of the foot switches SW2 to SW4 with reference to the IR code as acquired at the current time. When all of the foot switches SW2 to SW4 are turned on in step S119, the high speed processor 91 proceeds to step S120, otherwise proceeds to step S114.

In step S120, the high speed processor 91 determines that the player squats down, turns on the squat flag, and returns to the main routine. On the other hand, in step S114, the high speed processor 91 determines that the player does not squats down, turns off the squat flag, and returns to the main routine.

FIG. 28 is a flow chart showing an example of the jumping determination process in step S10 of FIG. 21. As shown in FIG. 28, the high speed processor 91 checks the on/off information of the foot switches SW1 to SW4 with reference to the IR code as acquired at the current time in step S125. When all the foot switches SW1 to SW4 are turned off in step S126, the high speed processor 91 proceeds to step S127, otherwise returns to the main routine.

In step S127, if the value of the two-footed contact counter “tb” (i.e., the two-footed contact time “tb”) is larger than the predetermined time “tj”, the high speed processor 91 determines that the player jumps and proceeds to step S128, otherwise returns to the main routine. In step S128, the high speed processor 91 turns on the jump flag, and returns to the main routine.

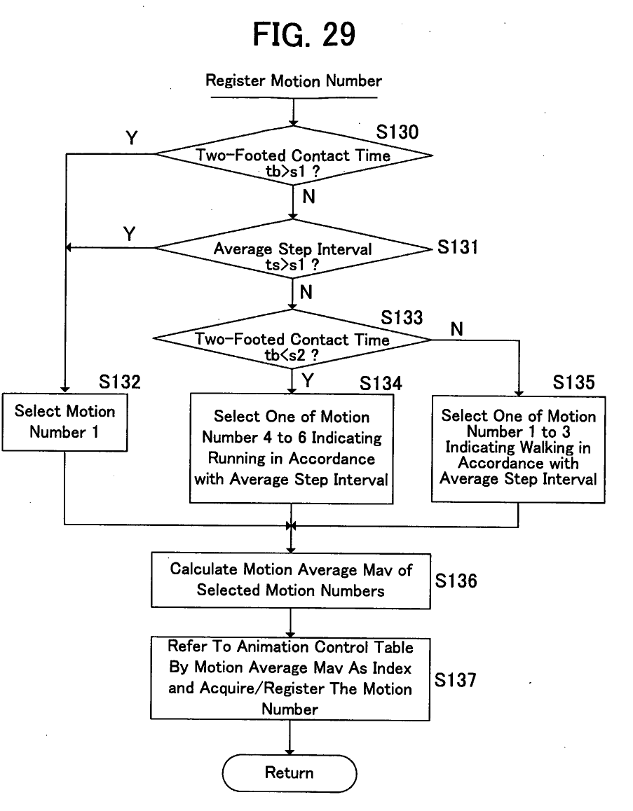

FIG. 29 is a flow chart showing an example of the process of registering a motion number in step S11 of FIG. 21. As illustrated in FIG. 29 and FIG. 20, in step S130, the high speed processor 91 determines whether or not the two-footed contact time “tb” is larger than the constant number “s1”, and if it is larger the process proceeds to step S132, otherwise proceeds to step S131. In step S131, the high speed processor 91 determines whether or not the average step interval “ts” is larger than the constant number “s1”, and if it is larger the process proceeds to step S132, otherwise proceeds to step S133.

In step S132, the high speed processor 91 selects the motion number “1”. On the other hand, in step S133, the high speed processor 91 determines whether or not the two-footed contact time “tb” is smaller than the constant number “s2”, and if it is smaller the process proceeds to step S134, otherwise proceeds to step S135.

In step S134, the high speed processor 91 selects a motion number (4, 5 or 6) corresponding to the range (s1≧ts>u1, u1≧ts>u2 or u2≧ts>u3) within which the average step interval “ts” falls. The motion numbers 4 to 6 are used to indicate the running state respectively. On the other hand, in step S135, the high speed processor 91 selects a motion number (1, 2 or 3) corresponding to the range (s1≧ts>t1, t1≧ts>t2 and t2≧ts>t3) within which the average step interval “ts” falls. The motion numbers 1 to 3 are used to indicate walking states respectively.

In step S136, the high speed processor 91 calculates the motion average “Mav” of the motion numbers selected in step S132, S134 and/or S135 on the basis of the equation (1) and the equation (2). In step S137, the high speed processor 91 refers to the animation control table by the motion average “Mav” of the motion number as an index, and acquires and registers the motion number. Then, the process returns to the main routine.

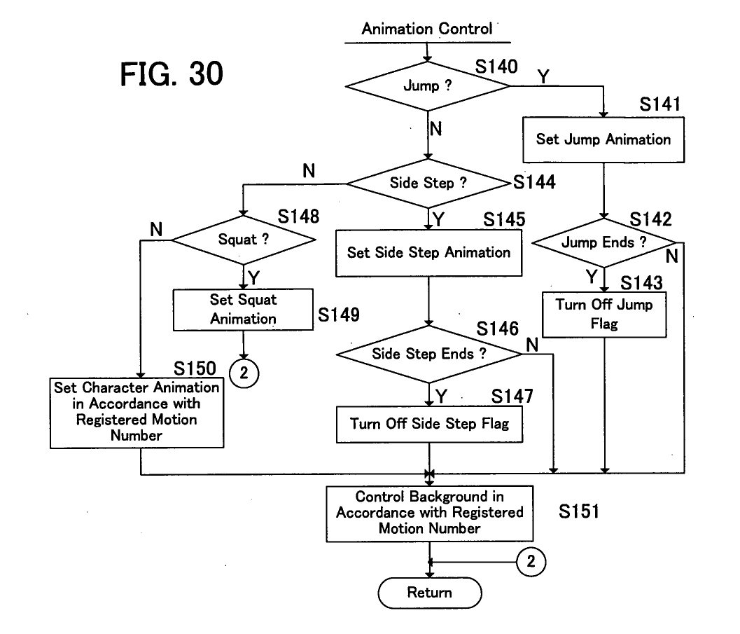

FIG. 30 is a flow chart showing an example of the process of controlling animation in step S12 of FIG. 21. As shown in FIG. 30, the high speed processor 91 checks the on/off information of the jump flag in step S140, and if the jump flag is turned on, the process proceeds to step S141, otherwise proceeds to step S144.

In step S141, the high speed processor 91 sets jump animation in order to make the manipulation object 400 jump. More specifically speaking, the jump animation of the manipulation object 400 is composed of a plurality of image frames, and the storage location information and display location information of the data of the respective image frames are set in the internal memory (not shown in the figure) in accordance with the playback times of the respective image frames. The high speed processor 91 determines whether or not the jump animation of the manipulation object 400 is finished in step S142, and if it is finished the process proceeds to step S151 after the jump flag is turned off in step S143, otherwise the process proceeds to step S151 without modifying the jump flag.

On the other hand, the high speed processor 91 accesses the side step flag in step S144, and if the side step flag is turned off (“0”) the process proceeds to step S148, otherwise proceeds to step S145. In step S145, the high speed processor 91 sets side step animation in order to side step the manipulation object 400 in accordance with the kind of side stepping as indicated by the side step flag. More specifically speaking, the side step animation of the manipulation object 400 is composed of a plurality of image frames, and the storage location information and display location information of the data of the respective image frames are set in the internal memory (not shown in the figure) in accordance with the value of the side step flag and the playback times of the respective image frames. The high speed processor 91 determines whether or not the side step animation of the manipulation object 400 is finished in step S146, and if it is finished the process proceeds to step S151 after the side step flag is turned off in step S147, otherwise the process proceeds to step S151 without modifying the side step flag.

On the other hand, the high speed processor 91 accesses the squat flag in step S148, and if the squat flag is turned off, the process proceeds to step S150, otherwise proceeds to step S149. In step S149, the high speed processor 91 sets squatting animation in order to make the manipulation object 400 squat down. More specifically speaking, the squatting animation of the manipulation object 400 is composed of a plurality of image frames, and the storage location information and display location information of the data of the respective image frames are set in the internal memory (not shown in the figure) in accordance with the playback times of the respective image frames. Step S149 is not followed by step S151 because the background is stopped when making the manipulation object 400 squat. Also, the squat flag is not turned off after step S149 because the image of the manipulation object 400 which is squatting is maintained in the screen unless the on/off information of the foot switches SW1 to SW4 is changed.

On the other hand, in step S150, the animation of the manipulation object 400 is set in accordance with the motion number registered in step S137 of FIG. 29. This is because all the jump flag, the side step flag and the squat flag are turned off so that the motion state of the manipulation object 400 is either the motionless state in the standing up position, the walking state or the running state. In particular, in the case where the motion number “0” is registered, the storage location information and display location information of the image data of the manipulation object 400 representing the motionless state in the standing up position are set in the internal memory (not shown in the figure), and in the case where any of the motion numbers 1 to 6 is registered, the storage location information and display location information of the data of the respective image frames are set in the internal memory (not shown in the figure) in accordance with the animation time (manipulation object) of the animation control table corresponding to the motion number as registered.

In step S151, the high speed processor 91 controls the background in accordance with the motion number registered in step S137 of FIG. 29. More specifically speaking, the storage location information and display location information of the data of the respective image frames are set in the internal memory (not shown in the figure) in accordance with the animation time (background) of the animation control table corresponding to the motion number as registered.

In advance of explaining the process in steps S4 and S18 of FIG. 21 in detail, several related matters will be explained here. At first, the courses on which the manipulation object 400 walks or runs in the virtual space will be explained as a matter relevant to this. The each course may for example be arbitrary combinations of 16 course segments. The obstacle objects 423, 425, 410 and/or 412 and/or the ninja object 414 are arranged respectively in predetermined positions of the course segments. In this case, the positions of the obstacle objects and the ninja object are determined in accordance with the distance from the starting point of the course segment. This distance is the distance in the virtual space.

An exemplary method of representing the distance in the virtual space will be explained. There are successive 32 image frames prepared as the background 401 including a street image as described above. Then, the progress of one image frame of the background image represents the progress of the manipulation object 400 corresponding to a predetermined distance in the virtual space. Accordingly, in the case of the present embodiment, the distance in the virtual space is represented by the number of the image frames of the background image. For this reason, the entire length of a course segment and the distance from the starting point of the course segment are represented by the numbers of the image frames of the background image. Incidentally, in the case of the present embodiment, the respective course segments have the same entire length. Needless to say, the course segments can have different entire lengths respectively.

Taking into consideration the entire length of each course segment and the types and numbers of the obstacle objects arranged in the each course segment, the number of count “Nsp” (hereinafter referred to as an “estimated step count “Nsp”) that the manipulation object 400 would take for walking or running, the number of count “Nss” (hereinafter referred to as an “estimated short side step count “Nss”) that the manipulation object 400 would take for short side stepping, the number of count “Nls” (hereinafter referred to as an “estimated long side step count “Nls”) that the manipulation object 400 would take for long side stepping, the number “Njp” of times of jumping (hereinafter referred to as an “estimated jump count “Njp”) that the manipulation object 400 would performs, and the number “Ndw” of times of squatting down (hereinafter referred to as an “estimated squat count “Ndw”) that the manipulation object 400 would performs, are set for the each course segment. Since the types and numbers of the obstacle objects as arranged in the respective course segments are different, the estimated step count “Nsp”, the estimated short side step count “Nss”, the estimated long side step count “Nls”, the estimated jump count “Njp” and the estimated squat count “Ndw” are set to be different among the respective course segments.

In this description, the short side step means that the manipulation object 400 moves to an adjacent lane, and the long side step means that the manipulation object 400 moves over the center lane C to an opposite side lane. More specifically speaking, if the player moves from the step position shown in FIG. 18H and FIG. 18I to the step position shown in FIG. 18I and FIG. 18J or vice versa, or if the player moves from the step position shown in FIG. 18I and FIG. 18J to the step position shown in FIG. 18J and FIG. 18K or vice versa, the motion of the player is called the short side step. On the other hand, if the player moves from the step position shown in FIG. 18H and FIG. 18I to the step position shown in FIG. 18J and FIG. 18K or vice versa, the motion of the player is called the long side step.

The calorie consumption when the player performs a stepping motion (steps) is actually measured, and the calorie consumption “Csp” (hereinafter referred to as a “unit step calorie consumption “Csp”) per stepping motion is calculated. This “one stepping motion” is the motion of lifting one foot and putting it down. In other words, one stepping motion of the player corresponds to one step which is counted by the high speed processor 91 (refer to step S52 of FIG. 23).

Also, the calorie consumption when the player performs a short side stepping motion is actually measured, and the calorie consumption per short side stepping motion is calculated. As described above, the transition from the off-state to the on-state of a foot switch is counted as one step in step S52 of FIG. 23. Accordingly, the step count when the player performs the short side step motion once is 3 steps. Because of this, a unit short side step calorie consumption “Css” is defined as the calorie consumption corresponding to one short side stepping motion minus (2× the unit step calorie consumption “Csp”). In other words, the two steps as landing motions during the short side stepping motion are recognized simply as stepping motions.

Furthermore, the calorie consumption when the player performs a long side stepping motion is actually measured, and the calorie consumption per long side stepping motion is calculated. And, a unit long side step calorie consumption “Cls” is defined as the calorie consumption corresponding to one long side stepping motion minus (2× the unit step calorie consumption “Csp”) in the same manner as the unit short side step calorie consumption. In other words, the two steps as landing motions during the long side stepping motion are recognized simply as stepping motions.

Furthermore, the calorie consumption when the player performs a jumping motion is actually measured, and the calorie consumption per jumping motion is calculated. The step count when the player performs the jumping motion once is 4 steps. Because of this, a unit jumping calorie consumption “Cjp” is defined as the calorie consumption corresponding to one jumping motion minus (2× the unit step calorie consumption “Csp”). In other words, the two steps corresponding to takeoff just before the jumping motion are recognized simply as stepping motions.

Furthermore, the calorie consumption when the player performs a squatting motion is actually measured, and the calorie consumption per squatting motion is calculated. The step count when the player performs the squatting motion once while pushing both hands to the mat is 4 steps (refer to FIG. 18G). Because of this, a unit squatting calorie consumption “Cdw” is defined as the calorie consumption corresponding to one squatting motion minus (2× the unit step calorie consumption “Csp”). In other words, the two steps just before the squatting motion are recognized simply as stepping motions.

As has been discussed above, the manipulation object 400 is manipulated in accordance with the on/off information of the foot switches SW1 to SW4. In other words, the manipulation object 400 can be manipulated in response to the motion of the player. Accordingly, the kinds of the motions of the manipulation object 400 (short side step/long side step/jump/squatting/walking/running) are considered equivalent or nearly equivalent to the kinds of the motions of the player. In other words, the player moves in the same manner as the manipulation object 400 as displayed. Accordingly, the calorie consumption “Csg” per course segment of the player can be calculated in accordance with the following equation.

Csg=Cbn+Nrs×Csp (3)

Cbn=Cas×(Nrs/Nsp) (4)

Cas=(Nss×Css+Nls×Cls+Njp×Cjp+Ndw×Cdw) (5)

Accordingly, the calorie consumption “Ctl” after the play is finished (i.e., after the predetermined time “Tc” elapses) is the sum of the calorie consumptions Csg which are calculated for the respective course segments, and calculated in accordance with the following equation.

Ctl=ΣCsg (6)

Here, the bonus calorie consumption “Cbn” in the equation (3) will be explained. The calorie consumption corresponding to the normal stepping motions during walking, running and so forth corresponds to the second term (Nrs×Csp) of the equation (3). In other words, this calorie consumption is represented by the product of the actual step count “Nrs” and the unit step calorie consumption “Csp”. The actual step count “Nrs” is the number of steps the player actually takes when the manipulation object 400 starts from the starting point of a course segment and reaches the end point of the course segment. However, the side step motion, the jumping motion and the squatting motion require more calories than the normal stepping motions. The bonus calorie consumption “Cbn” is added in consideration of the additional calories.

As understood from the equation (5), the estimated bonus calorie consumption “Cas” in the equation (4) is the estimated calories consumed by the player who performs the side step motions, the jumping motions and the squatting motions when the manipulation object 400 starts from the starting point and reaches the end point of the course segment while avoiding all the obstacle objects which appear in the course segment. On the other hand, the term (Nrs/Nsp) of the equation (4) indicates what percentages of the course segment the manipulation object 400 moves.

Accordingly, in the case where the actual step count “Nrs” is equal to the estimated step count “Nsp”, the estimated bonus calorie consumption “Cas” is added to the second term of the equation (3) as it is. In the case where the actual step count “Nrs”<the estimated step count “Nsp”, it means that the player performs more stepping motions so that the bonus calorie consumption “Cbn” higher than the estimated bonus calorie consumption “Cas” is added to the second term of the equation (3) in accordance with the stepping motions as performed. On the other hand, in the case where the actual step count “Nrs”<the estimated step count “Nsp”, it means that the player performs fewer stepping motions so that the bonus calorie consumption “Cbn” lower than the estimated bonus calorie consumption “Cas” is added to the second term of the equation (3) in accordance with the stepping motions as performed.

Needless to say, the calculation process corresponding to the equations (3) to (6) can be performed by a program which may not necessarily be written to calculate the equations (3) to (6) as they are, but can be written to calculate the equations (3) to (6) after expansion and/or rearrangement. In the following example, these equations are not calculated as they are, but calculated after expansion and/or rearrangement.

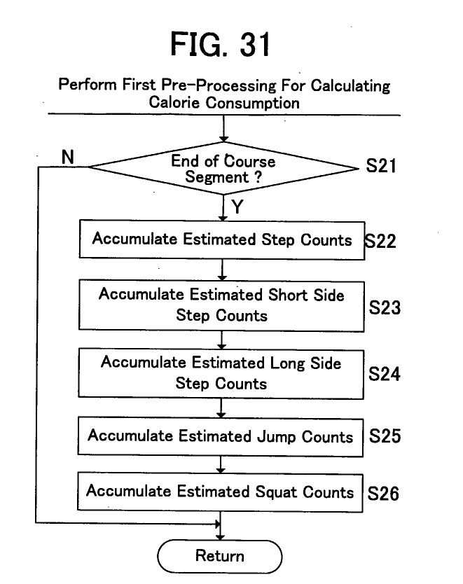

FIG. 31 is a flow chart showing an example of the first pre-processing of calculating the calorie consumption in step S4 of FIG. 21. As shown in FIG. 31, the high speed processor 91 determines whether or not the manipulation object 400 arrives at the end of the course segment in step S21, and if arrives, the process proceeds to step S22, otherwise returns to the main routine.

In step S22, the high speed processor 91 accumulates the estimated step count “Nsp” assigned to the current course segment. Accordingly, the sum of the estimated step counts Nsp of all the course segments except for the latest course segment used during the one play can be obtained by this process.

In step S23, the high speed processor 91 accumulates the estimated short side step count “Nss” assigned to the current course segment. Accordingly, the sum of the estimated short side step counts Nss of all the course segments except for the latest course segment used during the one play can be obtained by this process.

In step S24, the high speed processor 91 accumulates the estimated long side step count “Nls” assigned to the current course segment. Accordingly, the sum of the estimated long side step counts Nls of all the course segments except for the latest course segment used during the one play can be obtained by this process.

In step S25, the high speed processor 91 accumulates the estimated jump count “Njp” assigned to the current course segment. Accordingly, the sum of the estimated jump count “Njp” of all the course segments except for the latest course segment used during the one play can be obtained by this process.

In step S26, the high speed processor 91 accumulates the estimated squat count “Ndw” assigned to the current course segment, and returns to the main routine. Accordingly, the sum of the estimated squat count “Ndw” of all the course segments except for the latest course segment used during the one play can be obtained by this process.

FIG. 32 is a flow chart showing an example of the second pre-processing of calculating the calorie consumption in step S18 of FIG. 21. As shown in FIG. 32, in step S160, the high speed processor 91 calculates the ratio “R” of the distance the manipulation object 400 moves forward in the latest course segment to the entire length of it.

In step S161, the high speed processor 91 calculates the product of the estimated step count “Nsp” of the latest course segment and the ratio “R”. In step S162, the high speed processor 91 adds the above product (in step S161) to the result of accumulation of the estimated step counts (step S22).

In step S163, the high speed processor 91 calculates the product of the estimated short side step count “Nss” of the latest course segment and the ratio “R”. In step S164, the high speed processor 91 adds the above product (in step S163) to the result of accumulation of the estimated short side step counts (step S23).

In step S165, the high speed processor 91 calculates the product of the estimated long side step count “Nls” of the latest course segment and the ratio “R”. In step S166, the high speed processor 91 adds the product (in step S165) to the result of accumulation of the estimated long side step counts (step S24).

In step S167, the high speed processor 91 calculates the product of the estimated jump count “Njp” of the latest course segment and the ratio “R”. In step S168, the high speed processor 91 adds the product (in step S167) to the result of accumulation of the estimated jump counts (step S25).

In step S169, the high speed processor 91 calculates the product of the estimated squat count “Ndw” of the latest course segment and the ratio “R”. In step S170, the high speed processor 91 adds the product (in step S169) to the result of accumulation of the estimated squat counts (step S26).

As a result, even if the player halts the exercise in the middle of the latest course segment after the predetermined time “Tc” elapses to end the one play, the estimated step count, the estimated short side step count, the estimated long side step count, the estimated jump count and the estimated squat count can be obtained in correspondence with the final position of the manipulation object 400 by the processes in steps S161, S163, S165, S167 and S169.

Then, the sum of the estimated step counts, the sum of the estimated short side step counts, the sum of the estimated long side step counts, the sum of the estimated jump counts and the sum of the estimated squat counts of all the course segments during the one play can be obtained by the processes in steps S162, S164, S166, S168 and S170.

Returning to FIG. 21, the calorie consumption “Ctl” of the player is calculated in step S19 on the basis of the sum of the estimated step counts, the sum of the estimated short side step counts, the sum of the estimated long side step counts, the estimated jump counts and the sum of the estimated squat counts, which are obtained respectively in step S18, and the sum Ntl of the step counts of the player which is obtained in step S52.

Namely, the result of multiplying the sum of the estimated short side step counts by the unit short side step calorie consumption “Css”, the result of multiplying the sum of the estimated long side step counts by the unit long side step calorie consumption “Cls”, the result of multiplying the sum of the estimated jump counts by the unit jumping calorie consumption “Cjp”, and the result of multiplying the sum of the estimated squat counts by the unit squatting calorie consumption “Cdw”, are added together. Then, the result of addition is multiplied by (the total step counts Ntl of the player/the sum of the estimated step counts). Furthermore, this product is then multiplied by (the total step counts Ntl of the player×the unit step calorie consumption “Csp”). This product is equal to the calorie consumption “Ctl” of the player as calculated by the equation (6).

When the processes in step S4, step S5, step S18 and step S19 have been performed, it means that the equation (3) to the equation (6) have been calculated.

Alternatively, the high speed processor 91 can more finely calculate the calorie consumption “Crl” by taking account of the age, sex and weight of the player which are entered by the player. This point will be explained in detail.

The unit step calorie consumption “Csp”, the unit short side step calorie consumption “Css”, the unit long side step calorie consumption “Cls”, the unit jump calorie consumption “Cjp” and the unit squat calorie consumption “Cdw” as described above are acquired in advance as values per unit time and unit weight of the model person. In the case of the present embodiment, the value per unit time (one minute) and unit weight (one kg) of Japanese women aged 20 is actually measured (cal/min·kg).

In accordance with this alternative, since the calorie consumption “Ctl” calculated in step S19 is a value per unit time and unit weight, the high speed processor 91 multiplies the calorie consumption “Ctl” by the play time “Tc” and the weight (kg) of the player which is entered by the player. By this process, a calorie consumption “Cwh” reflecting the weight of the player is obtained.

Also, an age coefficient “AC” is set. In the case of the present embodiment, the age coefficient “AC”=0.008 for players aged 20 to 59, and the age coefficient “AC”=0.006 for players aged 60 or older. Then, the high speed processor 91 calculates the calorie consumption “Cag”, reflecting the age by the use of the age “Ag” which is entered by the player, in accordance with the following equation.

Cag=Cwh×(1−(Ag−20)×AC) (7)

Furthermore, a sex coefficient “SC” is set. Since a female value is used as the base value in the case of the present embodiment, the calorie consumption “Cag” is multiplied by the sex coefficient “SC” if the sex as entered by the player is male. In the case of the present embodiment, the sex coefficient “SC”=1.347.

In other words, in the case where the player is male, the final calorie consumption “Crl” is calculated in accordance with the equation (8), and in the case where the player is female, the final calorie consumption “Crl” is calculated in accordance with the equation (9).

Crl=Cag×SC (8)

Crl=Cag×1 (9)

Furthermore, a race coefficient “EC” can be used in order to calculate the calorie consumption reflecting the race. In the case of the example as has been discussed above, it is assumed that the player is Japanese, and therefore for example in the case where the player is American, the calorie consumption “Crl” is multiplied by the race coefficient “EC” which is prepared separately for a male player and a female player (for example, male: 1.10, female: 1.13) in order to obtain the final calorie consumption.

By the way, in advance of performing the above process, the high speed processor 91 can perform the process of displaying a tutorial screen (individualized instruction) as described below.

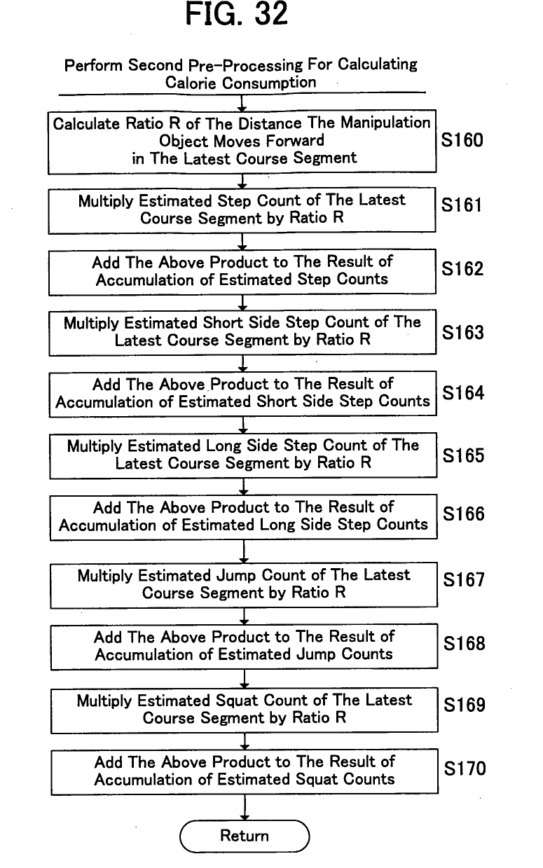

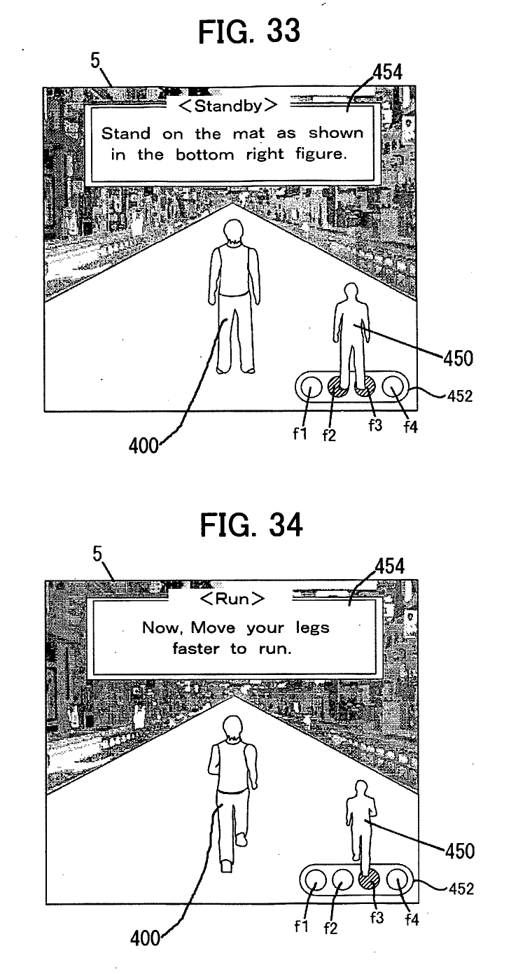

FIG. 33 is a view showing an example of the tutorial screen (Stop) as displayed on the television monitor 5 of FIG. 1. As shown in FIG. 33, this screen includes the manipulation object 400, an instruction display area 454, a guide object 450 and a mat object 452. The mat object 452 corresponds to the mat 2, and the areas f1 to f4 of the mat object 452 corresponds respectively to the step areas ST1 to ST4 of the mat 2.

This tutorial screen is provided for teaching to the player the way of making the manipulation object 400 stop. This screen shows the guide object 450 which is in a motionless state on the areas f2 and f3 of the mat object 452, and the manipulation object 400 which is in a motionless state on the center lane C. The player can know how to stop the manipulation object 400 by watching the motion of the guide object 450.

FIG. 34 is a view showing an example of the tutorial screen (Walk/Run) as displayed on the television monitor 5 of FIG. 1. As shown in FIG. 34, this tutorial screen is provided for teaching to the player the way of making the manipulation object 400 walk or run. This screen depicts the guide object 450 which is stepping on the areas f2 and f3 of the mat object 452, and the manipulation object 400 which is walking or running on the center lane C. The player can know how to make the manipulation object 400 walk or run by watching the motion of the guide object 450.

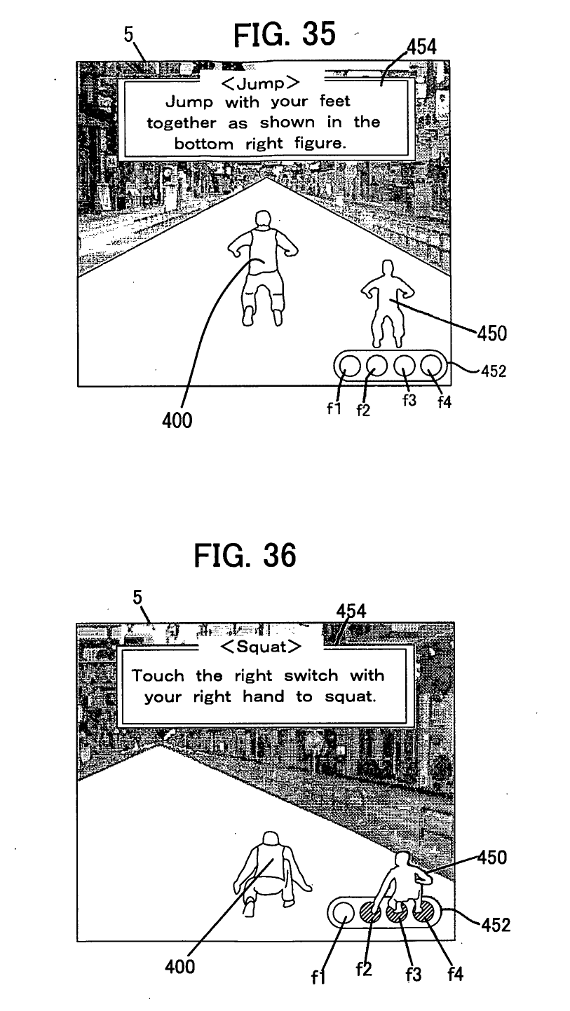

FIG. 35 is a view showing an example of the tutorial screen (Jump) as displayed on the television monitor 5 of FIG. 1. As shown in FIG. 35, this tutorial screen is provided for teaching to the player the way of making the manipulation object 400 jump. This screen depicts the guide object 450 which is jumping on the mat object 452, and the manipulation object 400 which is jumping on the center lane C. The player can know how to make the manipulation object 400 jump by watching the motion of the guide object 450.

FIG. 36 is a view showing an example of the tutorial screen (Squat) as displayed on the television monitor 5 of FIG. 1. As shown in FIG. 36, this tutorial screen is provided for teaching to the player the way of making the manipulation object 400 squat. This screen depicts the guide object 450 which is squatting down to push the left hand to the area f2 from the standing up position on the areas f3 and f4 of the mat object 452, and the manipulation object 400 which is squatting down on the right lane R. The player can know how to make the manipulation object 400 squat by watching the motion of the guide object 450.

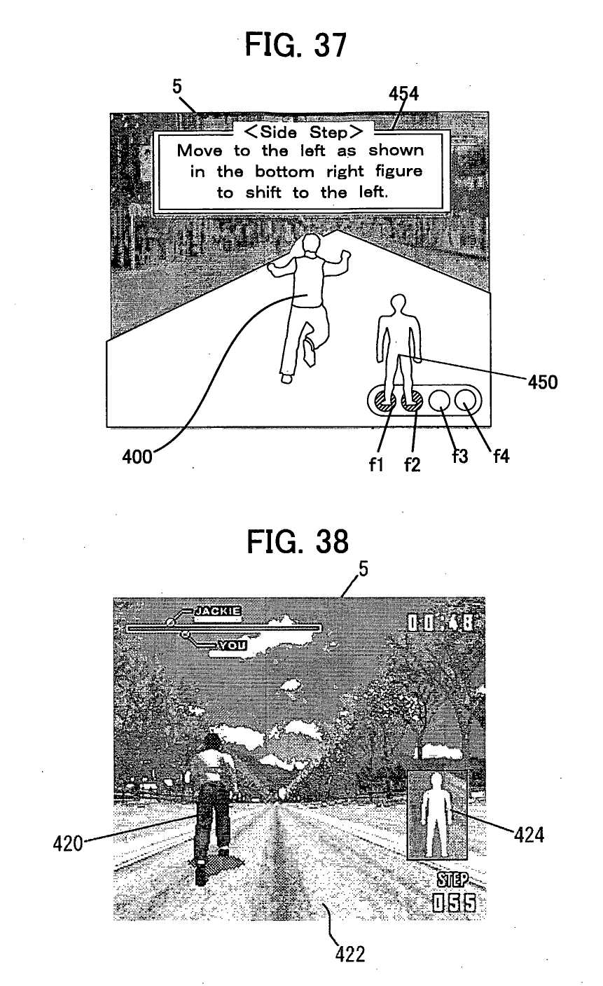

FIG. 37 is a view showing an example of the tutorial screen (Side Step) as displayed on the television monitor 5 of FIG. 1. As shown in FIG. 37, this tutorial screen is provided for teaching to the player the way of making the manipulation object 400 side step. This screen depicts the guide object 450 which is stepping from the areas f2 and f3 to the areas f1 and f2 of the mat object 452, and the manipulation object 400 which is side stepping from the center lane C to the left lane L. The player can know how to make the manipulation object 400 side step by watching the motion of the guide object 450.

FIG. 38 is an explanatory view for showing a first exemplary modification of the simulated experience apparatus in accordance with the embodiment 2 of the present invention. As shown in FIG. 38, in accordance with the first exemplary modification, the high speed processor 91 displays an image shown in FIG. 38 on the television monitor 5. More specifically speaking, a background 422, a character 420, a pacemaker 424, the elapsed time in the upper right position, an object visually indicating in the upper left position the difference between the position of the player and the position of the character 420 in the virtual space, and the step count of the player (the number of off-to-on state transitions of the foot switches SW1 to SW4) in the lower right position are displayed on the television monitor 5.

The high speed processor 91 makes the character 420 move (run) forward in the virtual space at a speed as specified in a program. This speed may not necessarily be constant.

The player can generate off-to-on state transitions of the foot switches SW1 to SW4 by stepping on the mat 2 to push down the step areas ST1 to ST4 in synchronization with the motion of the character 420. The high speed processor 91 moves backward the background 422 in the virtual space every time when any one of the foot switches SW1 to SW4 is turned on from its off-state in order to display such images on the television monitor 5 as if the player were moving forward in the virtual space. In this case, the high speed processor 91 changes the speed of the background 422 moving backward in accordance with the time interval between the off-to-on state transitions of the foot switches SW1 to SW4. That is, when the time interval becomes longer (i.e., the player is stepping more slowly) the speed is decreased, and conversely when the time interval becomes shorter (i.e., the player is stepping more quickly) the speed is increased. As has been discussed above, the background 422 is displayed always from the view point of the player.

Accordingly, while the player is stepping at a speed corresponding to the moving speed of the character 420, the character 420 is displayed always with the same size as if the player were running at the same speed as the character 420 in the virtual space. On the other hand, if the player is stepping at a speed slower than the moving speed of the character 420, the backward moving speed of the background 422 is slowed down, and the character 420 is going ahead and shrinking in the screen. However, if the character 420 goes ahead of the player with a predetermined distance therebetween, the character 420 is stopped. If the player is stepping at a speed faster than the moving speed of the character 420, the backward moving speed of the background 422 is increased, and the player can catch up with the character 420 and eventually overtake the character 420.

In this case, the pacemaker 424 is provided for the purpose of assisting the stepping motion of the player. This pacemaker 424 has an entire profile representing the human body and is an animated image which performs stepping in accordance with the moving speed of the character 420. The player can step at a speed corresponding to the speed of the character 420 by watching this pacemaker 424.

Also, the high speed processor 91 scrolls the screen to the left when the foot switch SW4 is changed from an off-state to an on-state. On the other hand, when the foot switch SW1 is changed from an off-state to an on-state, the high speed processor 91 scrolls the screen to the right. By this configuration, it is possible to reflect the left or right motion of the player in the image on the television monitor 5.

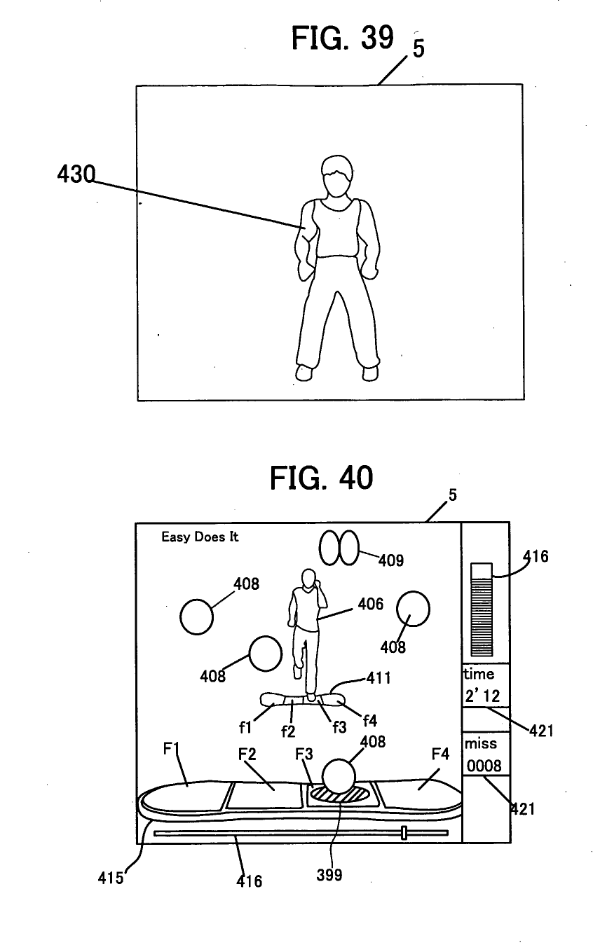

FIG. 39 is an explanatory view for showing a second exemplary modification of the simulated experience system in accordance with the embodiment 2 of the present invention. Referring to FIG. 39, the player can control a character 430 displayed on the television monitor 5 through the mat 2. In other words, the high speed processor 91 displays the character 430 on the television monitor 5, and can move the limbs of the character 430 in accordance with the off-to-on state transitions of the foot switches SW1 to SW4. More specifically speaking, the high speed processor 91 moves the left leg of the character 430 in response to the off-to-on state transition of the foot switch SW1, moves the left hand of the character 430 in response to the off-to-on state transition of the foot switch SW2, moves the right hand of the character 430 in response to the off-to-on state transition of the foot switch SW3, and moves the right leg of the character 430 in response to the off-to-on state transition of the foot switch SW4.

Then, in the case of the present embodiment as has been discussed above, the manipulation object 400 performs various motions in the same manner as the player (the motionless state, the walking motion, the running motion, the side stepping motion, the jumping motion and the squatting motion). Thus, the player can have an experience by performing these motions as if he were actually moving in the virtual space through the manipulation object 400. In other words, it is possible to have a simulated experience in the virtual space.

Also, in the case of the present embodiment, it is possible to detect not only the motions relating to stepping motions of the player (the motionless state, the walking motion, the running motion, the side stepping motion and the jumping motion), but also the squatting motion with ease. This is because, while the state of putting both feet on two step areas can be detected by two foot switches, a further one or two foot switch is turned on to detect an input if the player pushes either or both hands to a further one or two step area, and in such a case it can be assumed that the player is squatting.

Furthermore, in the case of the present embodiment, the approximative value of the energy which is consumed by the player can be calculated only by measuring the actual step count “Nrs” of the player (refer to the equation (3)). Still further, the energy value “Cas” (i.e., the estimated bonus calorie consumption) which is determined in advance corresponding to predetermined motions (refer to the equation (5)) is corrected in accordance with the actual step count “Nrs” of the player (refer to the equation (4)), and the corrected value “Cbn” (i.e., the bonus calorie consumption) is added to the total energy value (refer to the equation (3)), so that it is possible to improve the accuracy of the energy value as finally calculated.

That is, while the predetermined motions are not normal stepping motions but special motions including the short side stepping motion, the long side stepping motion, the jumping motion and the squatting motion, the energy consumptions corresponding to these special motions are added to the energy consumptions corresponding to the normal stepping motions on the assumption that the player performs these special motions in addition to the normal stepping motions in order to improve the accuracy of the energy value as calculated.

As has been discussed above, the indication objects (i.e., the obstacle objects) 423, 425, 410 and 412 are displayed to appear in the course of the virtual space as displayed on the television monitor 5 for the purpose of instructing the player to perform specified motions. Accordingly, it is possible to predict how the player moves from the starting point to the end point of the course because the player will move as instructed. The estimated bonus calorie consumption “Cas” is set on the basis of this prediction.

The estimated bonus calorie consumption “Cas” is corrected because, if the estimated bonus calorie consumption “Cas” is equally added irrespective of the actual step count “Nrl”, the motion of the player cannot be reflected, but rather the accuracy is degraded.

### Embodiment 3

The hardware of the mat system of the embodiment 1 is used also as the hardware of the exercise support apparatus of the embodiment 3 of the present invention.

FIG. 40 is a view showing an example of a screen as displayed on the television monitor 5 of FIG. 1 by the exercise support apparatus of the embodiment 3. As shown in FIG. 40, the high speed processor 91 displays a mat object 415 corresponding to the mat 2, a character 406, a mat object 411 provided for the character 406, a time display area 421, a miss count display area 404 and a decoration indicator 416 on the television monitor 5. The mat object 415 comprises response objects F1 to F4 which correspond respectively to the step area ST1 (the foot switch SW1) to ST4 (the foot switch SW4) of the mat 2.

Also, a single or a plurality of moving objects 408 and/or 409 are displayed in each of the motion lane corresponding to the response object F1 (on a perpendicular line passing through the response object F1), the motion lane corresponding to the response object F2 (on a perpendicular line passing through the response object F2), the motion lane corresponding to the response object F3 (on a perpendicular line passing through the response object F3), and the motion lane corresponding to the response object F4 (on a perpendicular line passing through the response object F4).

Each of the moving objects appears from the upper edge of the corresponding motion lane, and vertically falls at a predetermined acceleration. In this case, the appearance intervals of the moving objects are set to values in synchronization with music. The moving object 408 instructs the player to step one of the step areas ST1 to ST4 of the mat 2 with one foot, and the moving object 409 instructs the player to step one of the step areas ST1 to ST4 of the mat 2 with both feet.

The high speed processor 91 detects the off-to-on state transition of a foot switch in response to the step on the corresponding step area. Then, the high speed processor 91 changes the color of the response object corresponding to the foot switch (the step area) which is turned on from its off-state to green, and just thereafter returns the color to the original. Accordingly, at the moment when the player steps on a step area, the color of the response object corresponding to the step area as stepped is changed to green, and returns to the original.

However, if a foot switch is turned on from its off-state when the corresponding moving object reaches the corresponding response object (i.e., there is a hit), the high speed processor 91 changes the color of the response object to red, and just thereafter returns the color to the original. The example stored in FIG. 40 depicts the area 399 of the response object F3 the color of which is changed to red. In the case where there is such a hit, the high speed processor 91 outputs predetermined sound from the television monitor 5, moves (hits back) the moving object, which is hit, in the counter direction, and makes the moving object disappear into the upper edge of the screen. On the other hand, if a foot switch is not turned on from its off-state even when the corresponding moving object reaches the corresponding response object (i.e., there is a miss), the high speed processor 91 makes the response object immediately disappear at that time.

As has been discussed above, the appearance intervals of the moving objects are set to values in synchronization with music. Thus, if the player successfully steps on a step area at the time when the corresponding moving object reaches the corresponding response object (i.e., the corresponding foot switch is turned on from its off-state), the stepping motion is eventually in synchronization with the music.

Furthermore, the areas f1 to f4 of the mat object 411 also correspond respectively to the step areas ST1 to ST4. Accordingly, the high speed processor 91 controls the motion of the feet of the character 406 on the mat object 411 (i.e., the areas f1 to f4) in order to suggest the timing of stepping on the step areas ST1 to ST4. Needless to say, this timing corresponds to the timing in which a moving object reaches the corresponding response object. In addition, the high speed processor 91 controls the motion of the hands of the character 406 in synchronization with the music in order to suggest the motion of the hands of the player.

As has been discussed above, the player can do an exercise only by performing stepping motions and the motion of the hands in accordance with the moving objects 408 and 409 and the character 406. In other words, the player can enjoy an exercise while synchronizing the motion of limbs with music. Accordingly, it is possible to assist the player to continue exercise which is often abandoned by the wayside.

In the example of the present embodiment, the character 406 gives a performance of aerobic dance to guide the player how to move hands and feet (and what position of the mat 2 the player is to step on). The high speed processor 91 displays the elapsed time or the remaining time of music in the time display area 421. In addition, the high speed processor 91 displays the number of misses in stepping motions, i.e., the number of the moving objects which have disappeared without hitting back in the miss count display area 404. Furthermore, the high speed processor 91 changes the color of the decoration indicator 416 in accordance with the number of the moving objects at the upper end of the screen, i.e., the number of the moving objects when appearing in the screen. More specifically speaking, the decoration indicator 416 is divided into four areas, and, for example, when the number of the moving objects which appear is one, one divided area is changed. This process is performed every time when the moving object appears. Each of the divided areas is divided into five elements, and the high speed processor 91 returns the color to the original sequentially from the upper element each time when a predetermined time elapses.

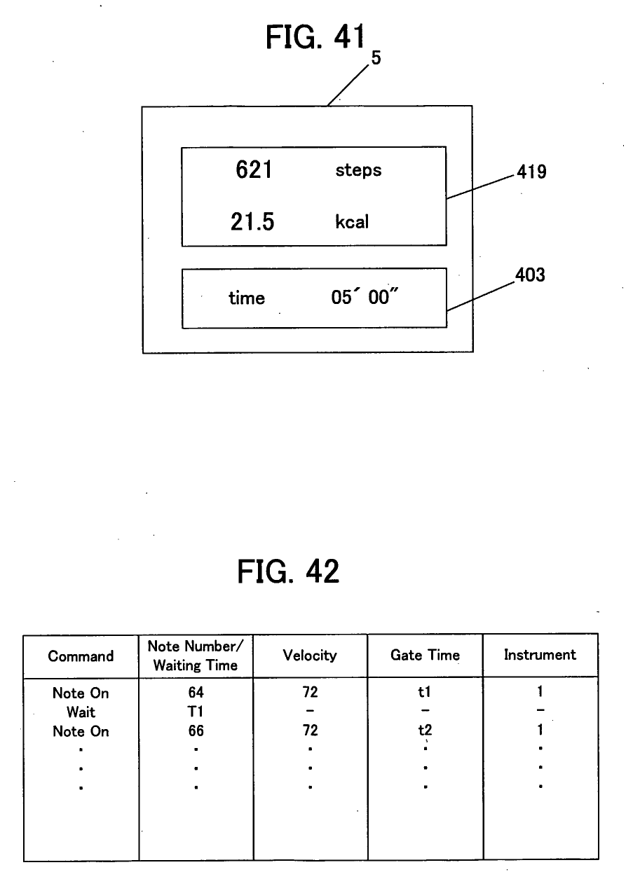

The high speed processor 91 calculates the calorie consumption when the player has exercised in accordance the motion (aerobic dance) of the hands and feet of the character 406 for guiding, and displays the calorie consumption on the television monitor 5 (refer to FIG. 41 to be described below). For example, the calorie consumption of a model player when he exercises in such a way as the character 406 moves hands and feet for guiding is measured and kept on record in advance. Then, the calorie consumption of the model player is corrected in accordance with the weight, sex and age of the player to calculate the calorie consumption of the player.

FIG. 41 is a view showing an example of an outcome screen as displayed on the television monitor 5 of FIG. 1. As shown in FIG. 41, the outcome screen is displayed when one exercise is finished. This outcome screen includes an exercise amount display area 419 and a time display area 403. The total number of steps and the calorie consumption of the one exercise are displayed in the exercise amount display area 419. The time of the one exercise is displayed in the time display area 403.

Next, musical score data for melody which is used by the high speed processor 91 for playing back melody will be explained. The musical score data for melody is data in which melody control information is arranged in a time series.

FIG. 42 is a table for explaining the musical score data for melody. As shown in FIG. 42, the melody control information contains fields for command, note number/waiting time information, velocity, gate time and instrument designation information.

“Note On” is a command to output sound, and “Wait” is a command to set a waiting time. The waiting time is the time period to elapse before reading the next command (the time period between one musical note and the next musical note). The note number is information for designating a pitch of a sound. The waiting time information is information for designating a waiting time to be set. The instrument designation information is information for designating a musical instrument whose tone quality is to be used. The velocity is information for designating the magnitude of sound, i.e., a sound volume. The gate time is information for designating a period for which a musical note is to be continuously output.

Next, musical score data for dance code which is used by the high speed processor 91 for controlling the motion of the character 406 will be explained. The musical score data for dance code is data in which dance control information is arranged in a time series.

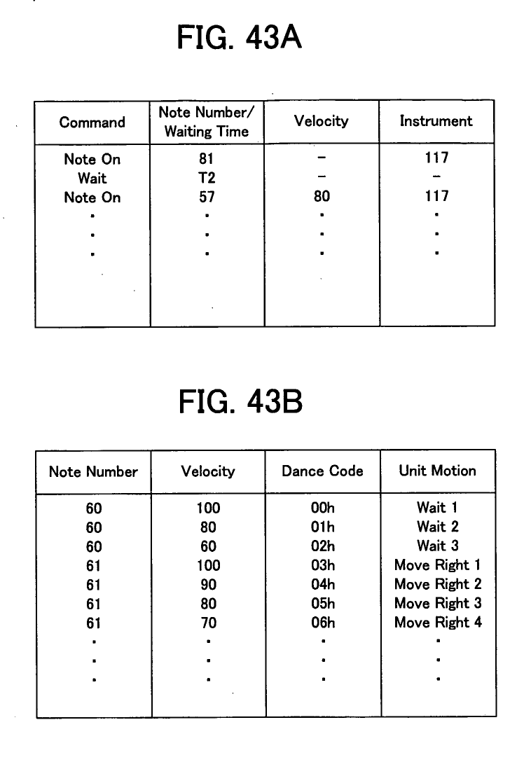

FIG. 43A is a table for explaining the musical score data for dance code. As shown in FIG. 43A, the dance control information contains fields for command, note number/waiting time information, velocity, and instrument designation information. The instrument designation information of the musical score data for dance code does not designate the instrument number (tone quality) corresponding to the instrument which outputs the sound, but rather designates the musical instrument for making, as it were, the character 406 perform a dance. By the use of such instrument designation information, the musical score data for dance code is recognized as musical score data for making the character 406 perform a dance, rather than musical score data for playing back music.

Accordingly, “Note On” in this case is not a command to output sound but a command to designate the motion of the character 406. On the other hand, the note number is not information for designating a pitch of a sound, and the velocity is not information for designating a magnitude of sound. The note number and the velocity are information for designating the motion of the character 406, and combined to generate a dance code which designates the motion of the character 406. This point will be explained in detail.

FIG. 43B is a view showing the relationship among the note number, the velocity, the dance code and the motion of the character 406. As shown in FIG. 43B, a dance code is made up of the combination of a note number and a velocity. Then, the motion of the character 406 is designated by the dance code. In other words, the motion of the character 406 is designated by the combination of a note number and a velocity. In the case of the present embodiment, 100 motions are prepared as elements of the motion of the character 406. Each of these 100 motions is called as a “unit motion” in this description. Likewise, the animation for representing a unit motion is sometimes called also as a “unit animation” in this description.

For example, a unit motion of “Wait 1” designated by the dance code “00h” represents the image of the character 406 in the standing state on the areas f2 and f3 of the mat object 411. Also, for example, a unit motion of “Move To Right 1” designated by the dance code “03h” represents the animated image of the character 406 shifting the positions of feet placed on the areas f1 and f2 to the positions of the feet placed on the areas f1 and f3 of the mat object 411 (i.e., the foot placed on the area f2 is moved to the area f3). In this manner, a variety of unit motions can be designated by a variety of dance codes. Of course, the unit motions include not only the motions of feet of the character 406 but also the motions of the hands of the character 406.

The aerobic dance that the character 406 performs is constructed by combination of the unit motions as designated by such dance codes. Meanwhile, in the case of the present embodiment, the note number “81” is dummy data placed on top of the musical score data for dance code and not used to construct a dance code. By this configuration, the top positions of the musical score data for melody and the musical score data for dance code are aligned with each other.

Next, musical score data for moving object which is used by the high speed processor 91 for controlling the moving objects 408 and 409 will be explained. The musical score data for moving object is data in which moving object control information is arranged in a time series.

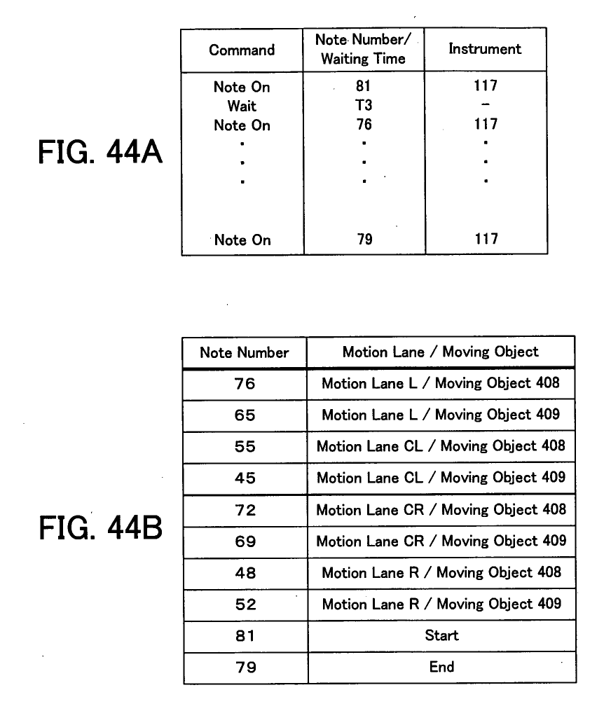

FIG. 44A is a table for explaining the musical score data for moving object. As shown in FIG. 44A, the moving object control information contains fields for command, note number/waiting time information, and instrument designation information.

The instrument designation information of the musical score data for moving object does not designate the instrument number (tone quality) corresponding to the instrument which outputs the sounds, but rather designates the musical instrument for making, as it were, the moving objects 408 and 409 appear. By the use of such instrument designation information, the musical score data for moving object is recognized as musical score data for making the moving objects 408 and 409 appear, rather than musical score data for playing back music.

Accordingly, “Note On” in this case is not a command to output sound but a command to make the moving objects 408 and 409 appear. On the other hand, the note number is not information for designating a pitch of a sound, but is information about which moving object is to appear and about on which motion lane the moving object is to appear. This point will be explained in detail.

FIG. 44B is a view showing the relationship between the note number of the musical score data for moving object and the motion lane/the moving object. As shown in FIG. 44B, for example, the note number “76” means that the moving object 408 is to appear in the motion lane L. Also, for example, the note number “65” means that the moving object 409 is to appear in the motion lane L.

In this description, the motion lane L is the lane along a vertical virtual line on the response object F1, the motion lane CL is the lane along a vertical virtual line on the response object F2, the motion lane CR is the lane along a vertical virtual line on the response object F3, and the motion lane R is the lane along a vertical virtual line on the response object F4.

Also, for example, the note number “81” is dummy data placed on top of the musical score data for moving object and not information about which moving object is to appear and about on which motion lane the moving object is to appear. By this configuration, the top positions of the musical score data for melody and the musical score data for moving object are aligned with each other. Furthermore, for example, the note number “79” is data indicative of the end of exercise, and arranged at the bottom of the musical score data for moving object. Incidentally, the note number “79” is not information about which moving object is to appear and about on which motion lane the moving object is to appear.

Next, the control of the character 406 (dance code registration, dance management, dance control) by the high speed processor 91 will be explained.

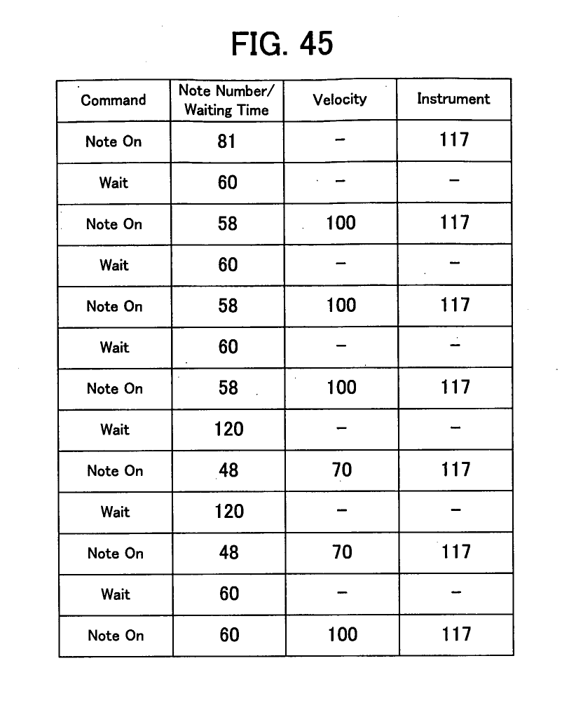

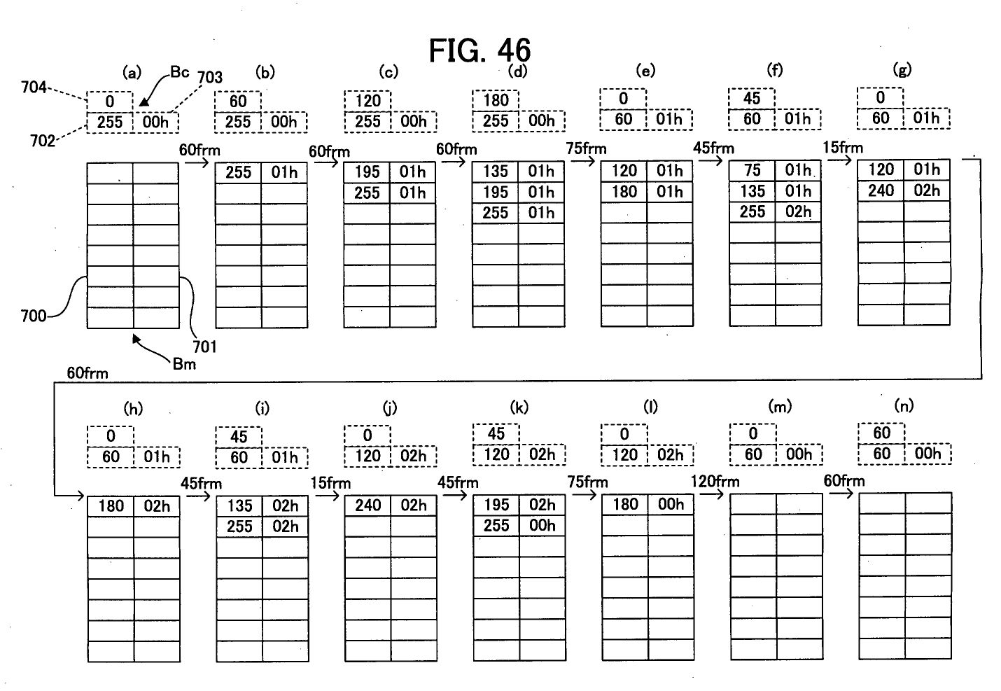

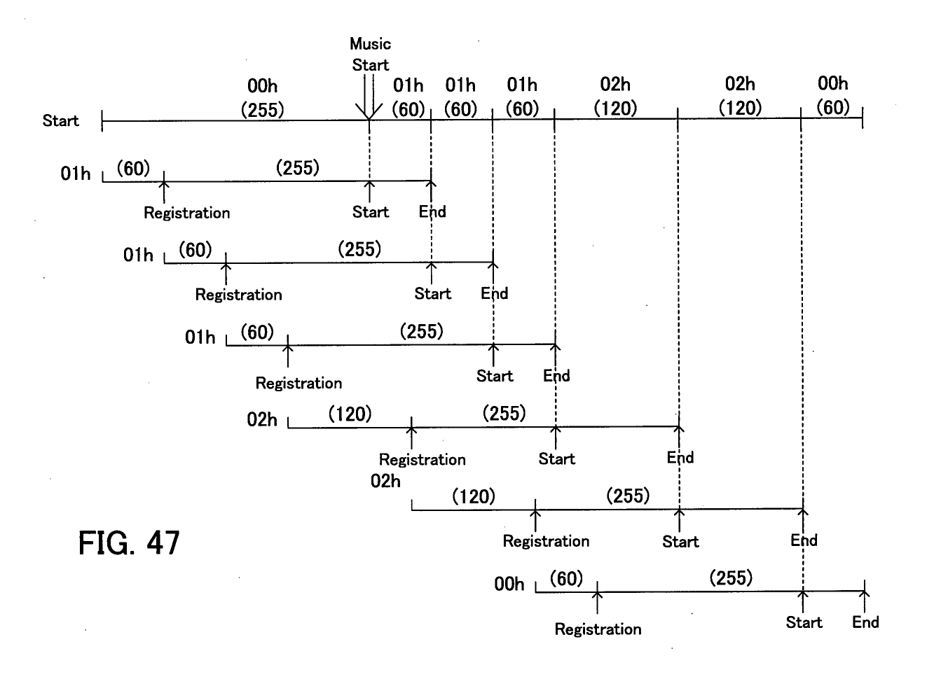

FIG. 45 is a view showing an example of the musical score data for dance code. FIG. 46, is a view for explaining the dance management and control performed on the basis of the musical score data for dance code of FIG. 45. FIG. 47, is a time chart for explaining the dance management and control of FIG. 46.

As shown in FIG. 46, the high speed processor 91 allocates a buffer area (a dance management buffer “Bm” and a dance control buffer “Bc”) in the internal memory (not shown in the figure) for use in controlling the character 406. The dance management buffer “Bm” comprises a buffer 700 for storing information about the number of video frames, and a buffer 701 for storing dance codes. Each of the buffers 700 and 701 is an FIFO (first-in-first-out) buffer and has a memory size of 8 bytes.

Also, the dance control buffer “Bc” comprises a buffer 702 for storing playback time information “Pf”, a buffer 703 for storing a dance code, and a buffer 704 for storing a playback counter value “Pc”. The playback counter value “Pc” is increased by one every time the video frame is updated. Each of the buffers 702 to 704 has a memory size of, for example, 1 byte.

The high speed processor 91 determines an image frame to be played back on the basis of the values stored in the dance control buffer “Bc”. This point will be explained in detail. The number of image frames of the animated image designated by a dance code is represented by a symbol “St”, and the ordinal number of the image frame to be displayed (called the playback image frame number in the following explanation) is represented by a symbol “Sc”. In the case of the present embodiment, the high speed processor 91 calculates the playback image frame number “Sc” by the following equation, and displays the image frame corresponding to the playback image frame number “Sc” on the television monitor 5.

Sc=St×(Pc/Pf) (10)

However, the fractional residue is discarded. In this case, the numbers of the image frames of an animated image are sequential numbers starting from “0”. Also, in the figure, the playback time information “Pf” and the playback counter value “Pc” are provided on the basis of the number of video frames.

With the above information in mind, the control of the character 406 will be explained with examples with reference to FIG. 45 to FIG. 47.

At first, the high speed processor 91 stores a playback time of “255”, a dance code of “00h” and a count of “0” respectively in the buffers 702, 703 and 704 of the dance control buffer “Bc” as initial values (refer to (a) of FIG. 46), and starts incrementing the playback counter value “Pc”. This initial values designates an animation of the character 406 (the animation of the character 406 in the standby state of waiting the playback of music) which is not necessarily synchronized with music and will be described below.

Since the command subsequent to the header note number “81” is “Wait”, the high speed processor 91 waits for the “60” video frames which are set as the waiting time in advance of reading information of the musical score data for dance code (refer to FIG. 45) During this period, the high speed processor 91 counts up the playback counter value “Pc” and calculates the playback image frame number “Sc” in order to control the motion of the character 406.

After the “60” video frames as the waiting time elapse, the high speed processor 91 reads the next command (Note On), and the dance code “01h” is generated from the corresponding note number “58” and the velocity “100” (refer to FIG. 45). Then, the dance code “01h” as generated is stored at the bottom position (the bottom position=the top position at this time) of the buffer 701, and the number “255” of video frames is stored at the bottom position (the bottom position=the top position at this time) of the buffer 700 (refer to (b) of FIG. 46).

Since the next command is “Wait”, the high speed processor 91 waits for the “60” video frames which are set as the waiting time in advance of reading information of the musical score data for dance code (refer to FIG. 45). During this period, the high speed processor 91 counts up the playback counter value “Pc” and calculates the playback image frame number “Sc” in order to control the motion of the character 406. At the same time, the high speed processor 91 counts down the number of video frames stored in the buffer 700.

After the “60” video frames as the waiting time elapse, the high speed processor 91 reads the next command (Note On), and the dance code “01h” is generated from the corresponding note number “58” and the velocity “100” (refer to FIG. 45). Then, the dance code “01h” as generated is stored at the bottom position of the buffer 701, and the number “255” of video frames is stored at the bottom position of the buffer 700 (refer to (c) of FIG. 46).

Since the next command is “Wait”, the high speed processor 91 waits for the “60” video frames which are set as the waiting time in advance of reading information of the musical score data for dance code (refer to FIG. 45). During this period, the high speed processor 91 counts up the playback counter value “Pc” and calculates the playback image frame number “Sc” in order to control the motion of the character 406, while counting down the number of video frames stored in the buffer 700.

After the “60” video frames as the waiting time elapse, the high speed processor 91 reads the next command (Note On), and the dance code “01h” is generated from the corresponding note number “58” and the velocity “100” (refer to FIG. 45). Then, the dance code “01h” as generated is stored at the bottom position of the buffer 701, and the number “255” of video frames is stored at the bottom position of the buffer 700 (refer to (d) of FIG. 46).

Since the next command is “Wait”, the high speed processor 91 waits for the number of video frames, i.e. “120” video frames which are set as the waiting time in advance of reading information of the musical score data for dance code (refer to FIG. 45). During this period, the high speed processor 91 counts up the playback counter value “Pc” and calculates the playback image frame number “Sc” in order to control the motion of the character 406, while counting down the number of video frames stored in the buffer 700.

However, the time when the playback counter value “Pc”=the playback time information “Pf” arrives before the waiting time as set elapses, i.e., when the “75” video frames elapse. At this time, the high speed processor 91 fetches the number “60” of the video frames and the dance code “01h” placed on top of the buffers 700 and 701, and stores them respectively in the buffers 702 and 703, while the playback counter value “Pc” is reset to “0” (refer to (e) of FIG. 46).

When the “45” video frames as the waiting time elapse, the high speed processor 91 reads the next command (Note On), and the dance code “02h” is generated from the corresponding note number “48” and the velocity “70” (refer to FIG. 45). Then, the dance code “02h” as generated is stored at the bottom position of the buffer 701, and the number “255” of video frames is stored at the bottom position of the buffer 700 (refer to (f) of FIG. 46).

Since the next command is “Wait”, the high speed processor 91 waits for the number of video frames, i.e. “120” video frames which are set as the waiting time in advance of reading information of the musical score data for dance code (refer to FIG. 45). During this period, the high speed processor 91 counts up the playback counter value “Pc” and calculates the playback image frame number “Sc” in order to control the motion of the character 406, while counting down the number of video frames stored in the buffer 700.

However, the time when the playback counter value “Pc”=the playback time information “Pf” arrives before the waiting time as set elapses, i.e., when the “15” video frames elapse. At this time, the high speed processor 91 fetches the number “60” of the video frames and the dance code “01h” placed on top of the buffers 700 and 701, and stores them respectively in the buffers 702 and 703 (refer to (g) of FIG. 46).

Furthermore, the time when the playback counter value “Pc”=the playback time information “Pf” arrives before the waiting time as set elapses, i.e., when the “60” video frames elapse. At this time, the high speed processor 91 fetches the number “60” of the video frames and the dance code “01h” placed on top of the buffers 700 and 701, and stores them respectively in the buffers 702 and 703 (refer to (h) of FIG. 46).

When the “45” video frames as the waiting time elapse, the high speed processor 91 reads the next command (Note On), and the dance code “02h” is generated from the corresponding note number “48” and the velocity “70” (refer to FIG. 45). Then, the dance code “02h” as generated is stored at the bottom position of the buffer 701, and the number “255” of video frames is stored at the bottom position of the buffer 700 (refer to (i) of FIG. 46).

Since the next command is “Wait”, the high speed processor 91 waits for the “60” video frames which are set as the waiting time in advance of reading information of the musical score data for dance code (refer to FIG. 45). During this period, the high speed processor 91 counts up the playback counter value “Pc” and calculates the playback image frame number “Sc” in order to control the motion of the character 406, while counting down the number of video frames stored in the buffer 700.

However, the time when the playback counter value “Pc”=the playback time information “Pf” arrives before the waiting time as set elapses, i.e., when the “15” video frames elapse. At this time, the high speed processor 91 fetches the number “120” of the video frames and the dance code “02h” placed on top of the buffers 700 and 701, and stores them respectively in the buffers 702 and 703 (refer to (j) of FIG. 46).

When the “45” video frames as the waiting time elapse, the high speed processor 91 reads the next command (Note On), and the dance code “00h” is generated from the corresponding note number “60” and the velocity “100” (refer to FIG. 45). Then, the dance code “00h” as generated is stored at the bottom position of the buffer 701, and the number “255” of video frames is stored at the bottom position of the buffer 700 (refer to (k) of FIG. 46).

When the “75” video frames elapse and the playback counter value “Pc”=the playback time information “Pf”, the high speed processor 91 fetches the number “120” of the video frames and the dance code “02h” placed on top of the buffers 700 and 701, and stores them respectively in the buffers 702 and 703, while the playback counter value “Pc” is reset to “0” (refer to (l) of FIG. 46).

Furthermore, when the “120” video frames elapse and the playback counter value “Pc”=the playback time information “Pf”, the high speed processor 91 fetches the number “60” of the video frames and the dance code “00h” placed on top of the buffers 700 and 701, and stores them respectively in the buffers 702 and 703, while the playback counter value “Pc” is reset to “0” (refer to (m) of FIG. 46).

Then, the high speed processor 91 displays the animated image indicated by the last dance code “00h” on the television monitor 5 until the playback counter value “Pc”=the playback time information “Pf” (refer to (n) of FIG. 46).

The above example will be explained from another point of view. As understood from FIG. 45 and FIG. 47, while the playback end time of the animated image of a unit motion is designated, the playback start time of the animated image is not designated. This will be explained in detail with examples. Referring to FIG. 47, the dance code “02h” fourth registered in the dance management buffer “Bm” is considered (corresponding to the fifth horizontal line from the top of FIG. 47). The start time of playing back the dance code “02h” is the playback end time of the dance code “01h” which is scheduled just before the dance code “02h”. On the other hand, the playback end time of the dance code “02h” is designated by the number “255” of video frames registered when this dance code “02h” is registered in the dance management buffer “Bm”. In other words, the playback end time of this dance code “02h” is the time when the “255” video frames elapse after the registration thereof. Other dance codes are processed in the same manner.

With the same example, how to determine the playback time will be explained. This is determined by the timing of registering the dance code “02h”. As can be seen from FIG. 47, the dance code “02h” under consideration is registered when the “120” video frames elapse after the previous dance code “01h” is registered. This number “120” of video frames eventually functions to determine the playback time of the dance code “02h”. That is to say, in the musical score data for dance code of FIG. 45, the playback time of the dance code “02h” is designated by the waiting time “120” of the waiting command just before the “Note On” command corresponding the dance code “02h” (i.e., the note number “48” and the velocity “70”).

From this fact, it can understand that the musical score data for dance code designates the playback end time of the dance code “02h”. Other dance codes are processed in the same manner. As has been discussed above, the “Note On” command and the “Wait” command have the reverse relationship to those of the musical score data for melody. Namely, in the case of the musical score data for melody, the “Wait” command next to (i.e., just after) a “Note On” command determines the length of the musical note designated by the “Note On” command. From this fact, it can understand that the musical score data for melody designates the playback start time of the musical note. This is true also for the musical score data for moving object.

As has been discussed above, the “Wait” command just before a “Note On” command is used to control the timing of registering the dance code corresponding to the note number and the velocity information of the “Note On” command (refer to FIG. 45). Then, the countdown of the number “255” of video frames starts at the same time as the dance code is registered. These processes are performed by the use of the dance management buffer “Bm” (refer to FIG. 46). Furthermore, when the playback of a dance code stored in the dance control buffer “Bc” is finished, the number of video frames and the dance code placed on top of the dance management buffer “Bm” are stored in the dance control buffer “Bc”, and the playback counter value “Pc” is cleared. By this configuration, the playback of the next dance code is started (refer to FIG. 46). As has been discussed above, the playback end time of the previous dance code is the playback start time of the current dance code anew (refer to FIG. 47).

In this case, when the playback of the dance code stored in the dance control buffer “Bc” is finished, the number of video frames which is placed on top of the dance management buffer “Bm” designates the playback time of the dance code placed on top of the dance management buffer “Bm” (refer to FIG. 46). This is because, as shown in FIG. 47, the registration of the above top dance code is performed when the waiting time corresponding to the playback time of the above top dance code (refer to FIG. 45) elapses after registering the above finished dance code in the dance management buffer “Bm”, and the initial value of the number of video frames as registered in the dance management buffer “Bm” is common to all the dance codes (i.e., the initial value is “255”).

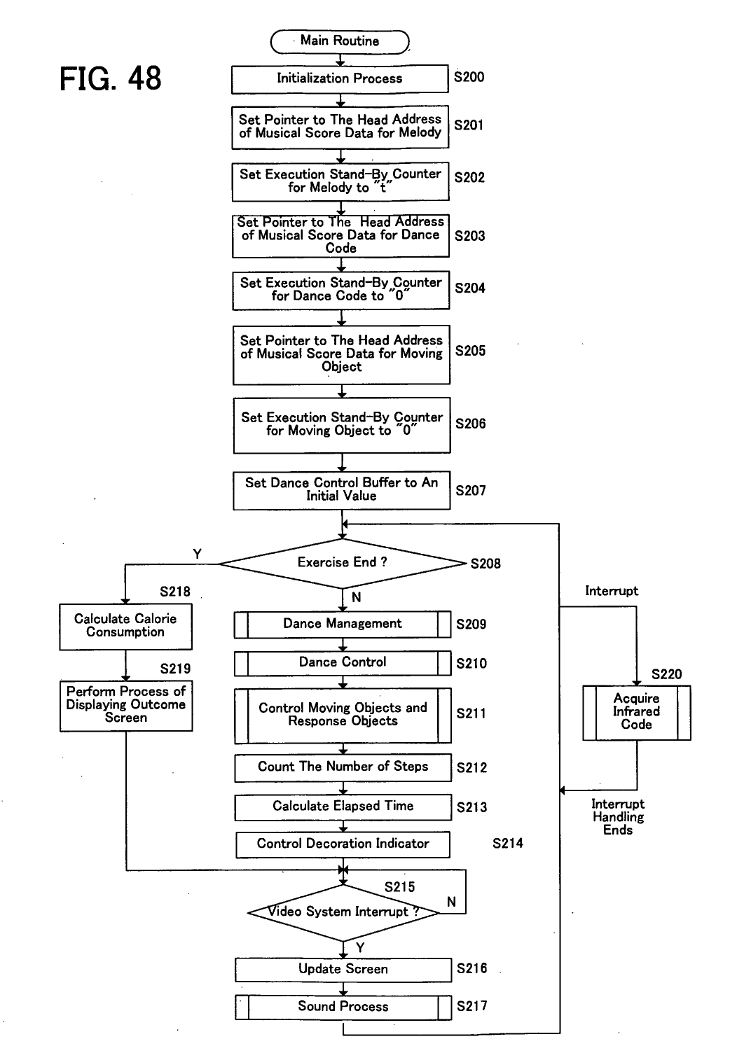

FIG. 48 is a flow chart showing an example of the overall process flow by the high speed processor 91 of FIG. 5 which is used in the exercise support apparatus of the embodiment 3 of the present invention. As shown in FIG. 48, the high speed processor 91 performs the general initialization of the system in step S200. Specifically, the system and the respective variables are initialized.

In step S201, the high speed processor 91 sets a musical score data pointer to the head address of the musical score data for melody. This musical score data pointer is a pointer pointing to the address from which reading the musical score data for melody is started. In step S202, the high speed processor 91 sets an execution stand-by counter for melody to a time “t”.

In step S203, the high speed processor 91 sets a musical score data pointer to the head address of the musical score data for dance code. This musical score data pointer is a pointer pointing to the address from which reading the musical score data for dance code is started. In step S204, the high speed processor 91 sets an execution stand-by counter for dance code to a time of “0”.

In step S205, the high speed processor 91 sets a musical score data pointer to the head address of the musical score data for moving object. This musical score data pointer is a pointer pointing to the address from which reading the musical score data for moving object is started. In step S206, the high speed processor 91 sets an execution stand-by counter for moving object to a time of “0”.

In step S207, the high speed processor 91 sets the initial values in the dance control buffer “Bc”. Namely, the high speed processor 91 stores a playback time of “255”, a dance code of “00h” and a count of “0” respectively in the buffers 702, 703 and 704 as initial values (refer to (a) of FIG. 46).

The high speed processor 91 refers to an exercise end flag in step S208, and if the flag is turned on (i.e., the exercise is over) the process proceeds to step S218, otherwise proceeds to step S209. In step S209, the high speed processor 91 performs the dance management process of the character 406. In step S210, the high speed processor 91 performs the dance control process of the character 406.

In step S211, the high speed processor 91 performs the control of the moving objects 408 and 409 and the response objects F1 to F4. In step S212, the high speed processor 91 detects the off-to-on state transitions of the foot switches SW1 to SW4 in order to calculate the step count “Ntl” of the player. The step count of the player is the number of off-to-on state transitions of the foot switches. Every time the video frame is updated, in step S213, the high speed processor 91 increments the counter by one in order to calculate the elapsed time “Tc” from the start to the end of the exercise. In step S214, the high speed processor 91 performs the control of the decoration indicator 416.

On the other hand, in step S218, the high speed processor 91 calculates the calorie consumption in accordance with the step count “Ntl” of the player which is calculated in step S212. This point will be explained in detail. The calorie consumption “Cst” (hereinafter referred to as the “estimated calorie consumption “Cst”) of the model player is actually measured in advance when he do one exercise of the same aerobic dance as the character 406 do. Then, the calorie consumption “Ctl” of the player is calculated by the following equation on the basis of this estimated calorie consumption “Cst”, the number of steps that the character 406 takes when doing one exercise (hereinafter referred to as the “estimated step count “Nst”), the total number “Ntl” of steps that the player takes as counted in step S212.

Ctl=Cst×(Ntl/Nst) (11)

Alternatively, the high speed processor 91 can more finely calculate the calorie consumption “Crl” by taking account of the age, sex and weight of the player which are entered by the player. This point will be explained in detail.

The estimated calorie consumption “Cst” described above is acquired in advance as values per unit time and unit weight of the model person. In the case of the present embodiment, the values per unit time (one minute) and unit weight (one kg) of Japanese women aged 20 are actually measured (cal/min·g).

In accordance with this alternative, since the calorie consumption “Ctl” calculated in step S18 is a value per unit time and unit weight, the high speed processor 91 multiplies the calorie consumption “Ctl” by the play time “Tc” and the weight (kg) of the player which is entered by the player. By this process, a calorie consumption “Cwh” reflecting the weight of the player is obtained.

Also, an age coefficient “AC” is set in the same manner as in the embodiment 2. The high speed processor 91 calculates the calorie consumption “Cag” reflecting the age by the use of the age “Ag” which is entered by the player, in accordance with the equation (7).

Furthermore, a sex coefficient “SC” is set in the same manner as in the embodiment 2. Since a female value is used as the base value in the case of the present embodiment, the calorie consumption “Cag” is multiplied by the sex coefficient “SC” if the sex as input by the player is male.

In other words, in the case where the player is male, the final calorie consumption “Crl” is calculated in accordance with the equation (8), and in the case where the player is female, the final calorie consumption “Crl” is calculated in accordance with the equation (9).

Furthermore, a race coefficient “EC” can be used in order to calculate the calorie consumption reflecting the race in the same manner as in the embodiment 2.

In step S219, the high speed processor 91 performs the process of displaying the outcome screen (refer to FIG. 41). More specifically speaking, the high speed processor 91 sets the storage location information and display location information of the image data showing the background and the respective objects (letters, numerals and the like) as the components of the outcome screen in the internal memory (not shown in the figure) in accordance with the total number of steps “Ntl” of the player, the calorie consumption “Crl” of the player and the elapsed time “Tc”.

If there is an interrupt by a video system synchronous signal in step S215, the process proceeds to step S216, otherwise the process repeats the same step S215. The interrupt by the video system synchronous signal is issued at 1/60 second intervals.

In response to the interrupt by the video system synchronous signal, in step S216, the high speed processor 91 updates the display image (video frame) of the television monitor 5 on the basis of the information (the storage location information and display location information of the image data) which is set in step S210 to S214 or S219. Also, in response to the interrupt by the video system synchronous signal, the sound process in step S217 is performed, and thereby music and sound effects are output. Thereafter, the processing proceeds to step S208.

When the signal transmitted from the IR receiver circuit 71 of the adapter 1 rises from a low level to a high level, i.e., when the value of the I/O port IO18 rises from a low level to a high level, an interrupt is issued in response to this, and the process of acquiring an infrared code (IR code) is performed in step S220. The details of the process in step S220 are the same as the process in step S21 of FIG. 21, and thereby no redundant description is repeated.

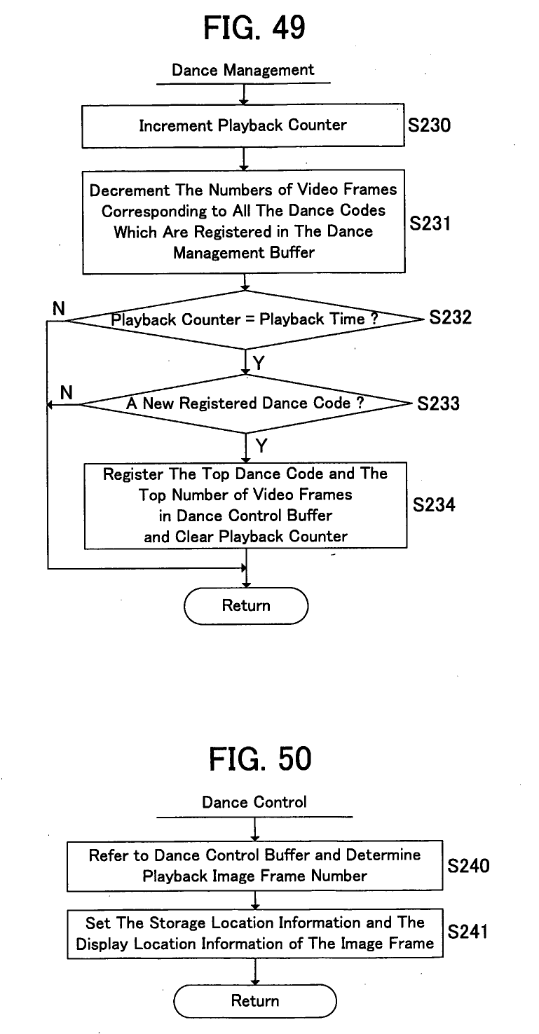

FIG. 49 is a flow chart showing an example of the dance management process in step S209 of FIG. 48. As shown in FIG. 49, the high speed processor 91 increments the playback counter value “Pc” of the dance control buffer “Bc” by one in step S230. In step S231, the high speed processor 91 decrements the numbers of video frames corresponding to all of the dance codes which are registered in the dance management buffer “Bm”.

In step S232, the high speed processor 91 refers to the dance control buffer “Bc”, and if the value of the playback counter value “Pc” is equal to the value of the playback time “Pf” the process proceeds to step S233 otherwise returns to the main routine. In step S233, the high speed processor 91 refers to the dance management buffer “Bm” in order to determine whether or not there is a dance code registered therein, and if there is a dance code registered therein the process proceeds to step S234 otherwise returns to the main routine. In step S234, the high speed processor 91 stores the dance code and the number of video frames placed on top of the dance management buffer “Bm” in the dance control buffer “Bc”, clears the playback counter value “Pc”, and returns to the main routine.

FIG. 50 is a flow chart showing an example of the dance control process in step S210 of FIG. 48. As shown in FIG. 50, in step S240, the high speed processor 91 refers to the dance control buffer “Bc”, and calculates the playback image frame number “Sc” by the use of the equation (10). In step S241, the high speed processor 91 stores the storage location information and display location information of the data of the image frame corresponding to the playback image frame number as calculated in step 240 in the internal memory (not shown in the figure), and returns to the main routine.

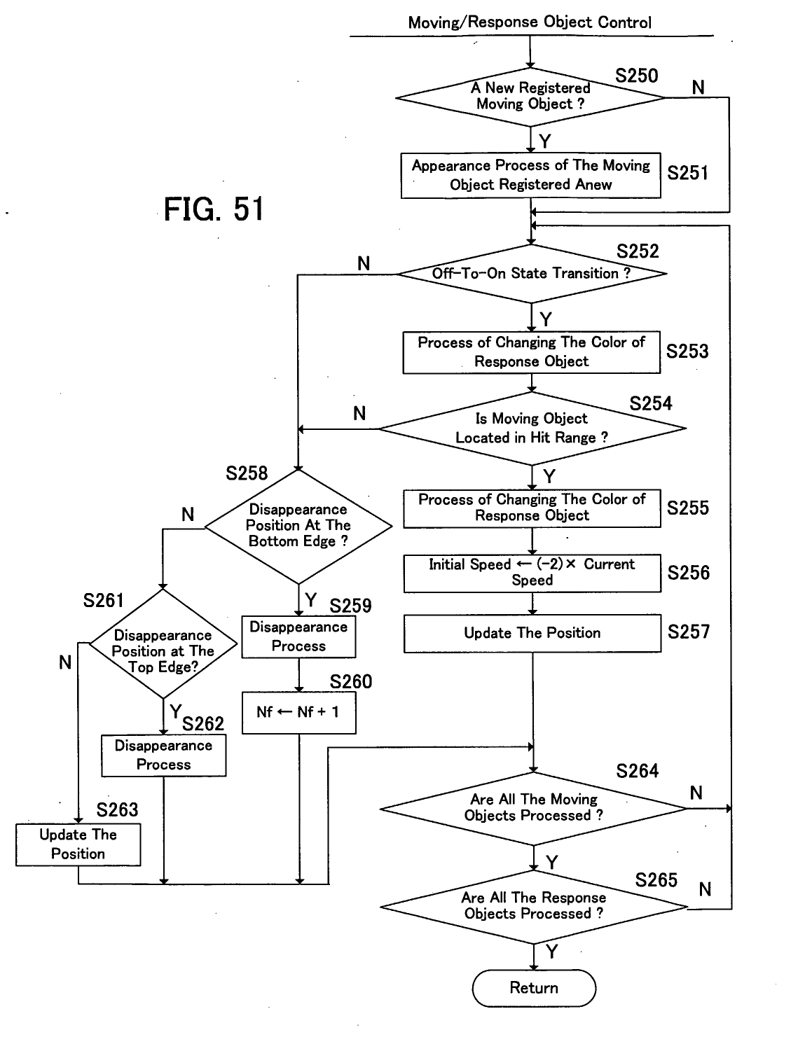

FIG. 51 is a flow chart showing an example of the moving/response object control process in step S211 of FIG. 48. As shown in FIG. 51, the high speed processor 91 determines in step S250 whether or not a moving object is registered anew, and if it is registered anew the process proceeds to step S251 otherwise proceeds to step S252.

In step S251, the high speed processor 91 performs the appearance process of displaying the moving object registered anew. More specifically speaking, the high speed processor 91 sets the storage location information and display location information of the image data of the moving object in the internal memory (not shown in the figure).

In step S252, the high speed processor 91 determines whether or not there is the off-to-on state transition of a foot switch, and if there is, the process proceeds to step S253 otherwise proceeds to step S258. In step S253, the high speed processor 91 performs the process of changing the color of the response object to green. In step S254, the high speed processor 91 determines whether or not the moving object is located in a hit range, and if it is located in the hit range the process proceeds to step S255 otherwise proceeds to step S258.

In this case, the hit range is a predetermined range having its bottom edge located in the line where the response object is located, and the player can hit back the moving object (get a hit) by stepping on the corresponding step area to turn on the corresponding foot switch when the moving object is located within the hit range.

In step S255, the high speed processor 91 performs the process of changing the color of the response object to red. In step S256, the high speed processor 91 sets the initial speed of the moving object to twice the current speed. In step S257, the high speed processor 91 calculates the display coordinates of the moving object on the basis of the initial speed as set in step S256 and sets the display coordinates in the internal memory (not shown in the figure). By this configuration, the moving object is hit back in the upward direction at twice the falling speed.

On the other hand, in step S258, the high speed processor 91 determines whether or not the moving object reaches the disappearance position at the bottom of the screen, and if it reaches the process proceeds to step S259 otherwise proceeds to step S261. In step S259, the high speed processor 91 performs the disappearance process of the moving object. More specifically speaking, the high speed processor 91 sets the display coordinates of the moving object to coordinates outside of the screen of the television monitor 5. By this configuration, the moving object the player fails to hit disappears at the bottom of the screen. Then, in step S260, the high speed processor 91 increments a miss counter value “Nf” indicative of the number of times of failing to hit back the moving object.

On the other hand, in step S261, the high speed processor 91 determines whether or not the moving object reaches the disappearance position at the top of the screen, and if it reaches the process proceeds to step S262 otherwise (i.e., if the moving object is located in the middle of the motion lane) proceeds to step S263. In step S262, the high speed processor 91 performs the disappearance process of the moving object. This process is performed in the same manner as the disappearance process at the bottom of the screen.

On the other hand, in step S263, the high speed processor 91 performs the process of updating the position of the moving object. Specifically, the high speed processor 91 calculates the display coordinates of the moving object on the basis of the initial speed and the acceleration which are currently set, and stores the display coordinates in the internal memory (not shown in the figure). Accordingly, in accordance with the initial speed as currently set, the moving object is moved in the upward or downward direction.

On the other hand, in step S264, the high speed processor 91 determines whether or not the processes in steps S252 to S263 are completed for all the moving objects, and if not performed yet, the process proceeds to step S252 otherwise proceeds to step S265. In step S265, the high speed processor 91 determines whether or not the processes of step S252 to S264 are completed for all the response objects, and if not performed yet, the process proceeds to step S252 otherwise returns to the main routine.

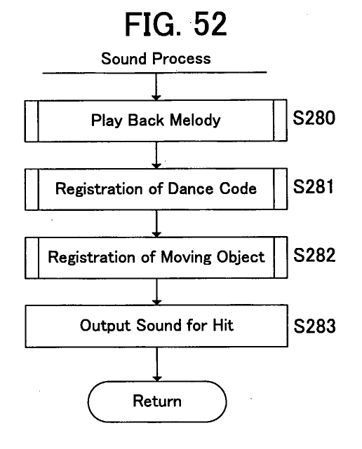

FIG. 52 is a flow chart showing an example of the sound process in step S217 of FIG. 48. As shown in FIG. 52, in step S280, the high speed processor 91 performs the process of playing back melody. In step S281, the high speed processor 91 performs the process of registering a dance code. In step S282, the high speed processor 91 performs the process of registering a moving object. In step S283, the high speed processor 91 performs the process of performing sound effect when the moving object is hit.

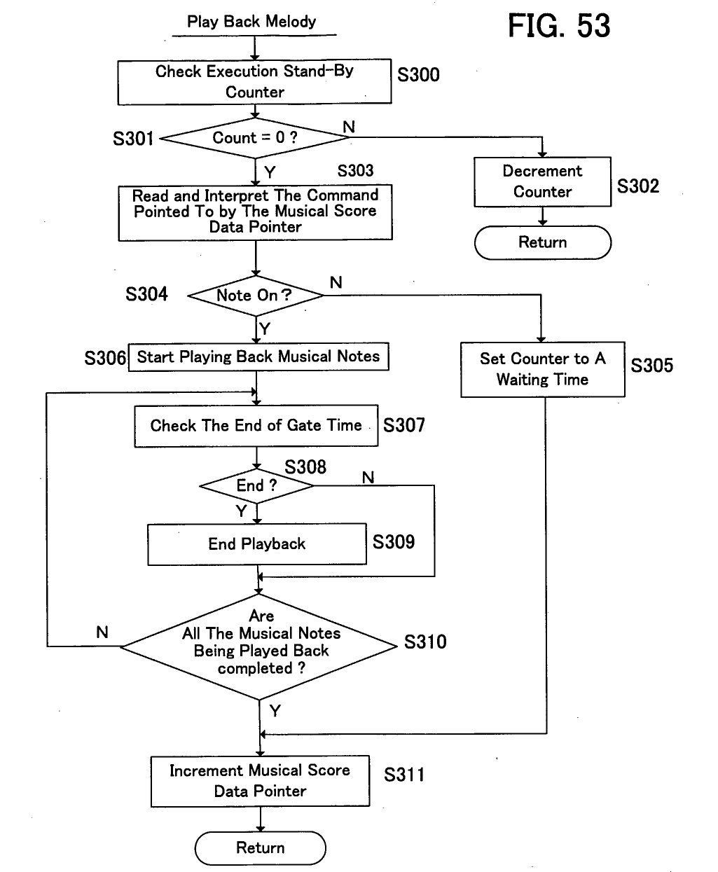

FIG. 53 is a flow chart showing an example of the process of playing back melody in step S280 of FIG. 52. As shown in FIG. 53, in step S300, the high speed processor 91 checks the execution stand-by counter for melody. If the value of the execution stand-by counter for melody is “0”, the process proceeds to step S303 otherwise proceeds to step S302 in which the execution stand-by counter is decremented and returns to the routine of FIG. 52.

In step S303, the high speed processor 91 reads the command pointed to by the musical score data pointer for melody, and interprets the command. In step S304, if the command is “Note On”, the process proceeds to step S306 otherwise (i.e., “Waiting”) proceeds to step S305.

In step S306, the high speed processor 91 starts playing back musical notes in accordance with the melody control information pointed to by the musical score data pointer for melody. In step S307, the high speed processor 91 checks the remaining time of the gate time of the current musical note being played back. It is confirmed that the gate time elapses in step S308, the high speed processor 91 proceeds to step S309 in which the playback of the musical note is terminated, and proceeds to step S310. Conversely, it is confirmed that the gate time does not elapse in step S308, the process proceeds directly to step S310. In step S310, the high speed processor 91 determines whether or not the process of step S307 is completed for all the musical notes being played back, and if not completed yet the process proceeds to step S307 otherwise proceeds to step S311.

On the other hand, in step S305, the high speed processor 91 sets the execution stand-by counter for melody to the waiting time. In step S311, the high speed processor 91 increments the musical score data pointer for melody, and returns to the routine of FIG. 52.

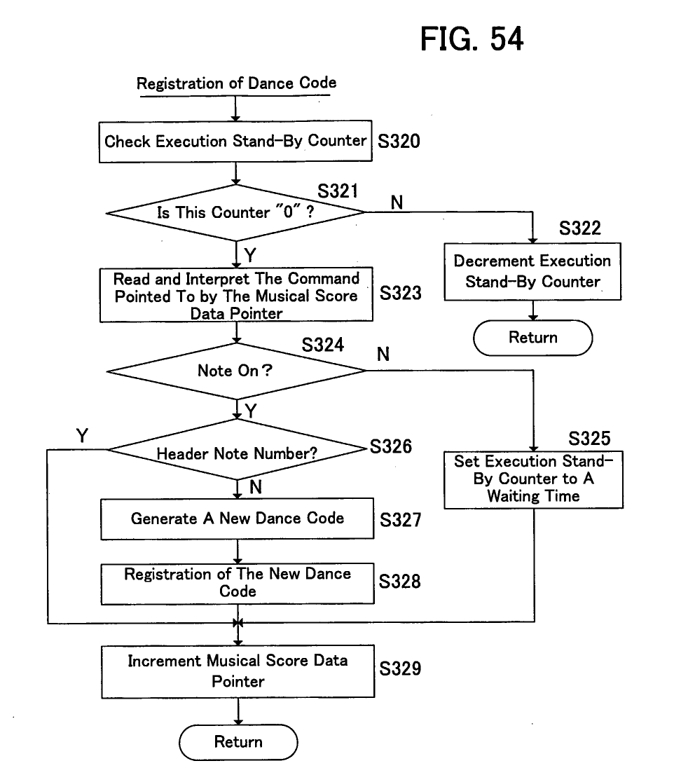

FIG. 54 is a flow chart showing an example of the process of registering a dance code in step S281 of FIG. 52. As shown in FIG. 54, in step S320, the high speed processor 91 checks the execution stand-by counter for dance code. If the value of the execution stand-by counter for dance code is “0” in step S321, the process proceeds to step S323 otherwise proceeds to step S322 in which the execution stand-by counter is decremented and returns to the routine of FIG. 52.

On the other hand, in step S323, the high speed processor 91 reads the command pointed to by the musical score data pointer for dance code, and interprets the command. If the command is “Note On” in step S324, the process proceeds to step S326 otherwise (i.e., “Waiting”) proceeds to step S325.

In step S326, if the note number as read is the header note number, the high speed processor 91 proceeds to step S329 otherwise proceeds to step S327. In step S327, the high speed processor 91 generates a dance code from the note number and velocity as read. In step S328, the high speed processor 91 registers the dance code as generated in the dance management buffer “Bm” anew together with the number “255” of video frames.

On the other hand, in step S325, the high speed processor 91 sets the execution stand-by counter for dance code to a waiting time. In step S329, the high speed processor 91 increments the musical score data pointer for dance code, and returns to the routine of FIG. 52.

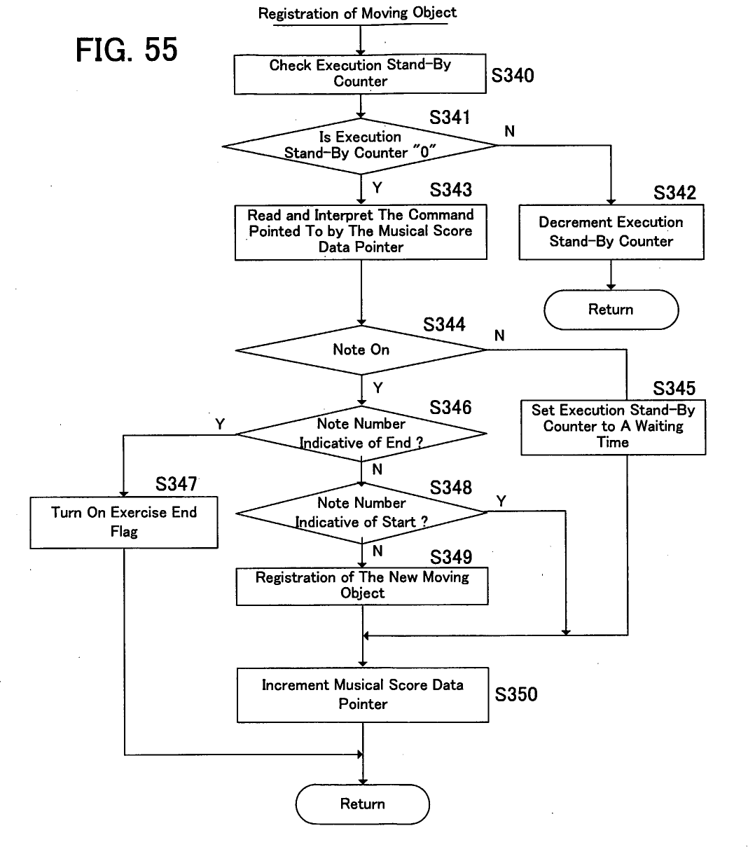

FIG. 55 is a flow chart showing an example of the process of registering a moving object in step S282 of FIG. 52. As shown in FIG. 55, in step S340, the high speed processor 91 checks the execution stand-by counter for registering a moving object. If the value of the execution stand-by counter for registering a moving object is “0” in step S341, the process proceeds to step S343 otherwise proceeds to step S342. In step S342, the high speed processor 91 decrements the execution stand-by counter for registering a moving object and returns to the routine of FIG. 52.

On the other hand, in step S343, the high speed processor 91 reads the command pointed to by the musical score data pointer for registering a moving object, and interprets the command. If the command is “Note On” in step S344, the process proceeds to step S346. On the other hand, if the command is not “Note On”, i.e., “Waiting”, the process proceeds to step S345. In step S345, the high speed processor 91 sets the execution stand-by counter for registering a moving object to a waiting time.

On the other hand, if the note number indicates the end of music in step S346, the process proceeds to step S347 otherwise proceeds to step S348. In step S347, the high speed processor 91 turns on an exercise end flag.

On the other hand, if the note number indicates the start of music in step S348, the process proceeds to step S350 otherwise proceeds to step S349. In step S349, the high speed processor 91 registers a moving object anew. Specifically, the initial speed, initial coordinate and acceleration of the new moving object are set. In step S350, the high speed processor 91 increments the musical score data pointer for registering a moving object and returns to the routine of FIG. 52.

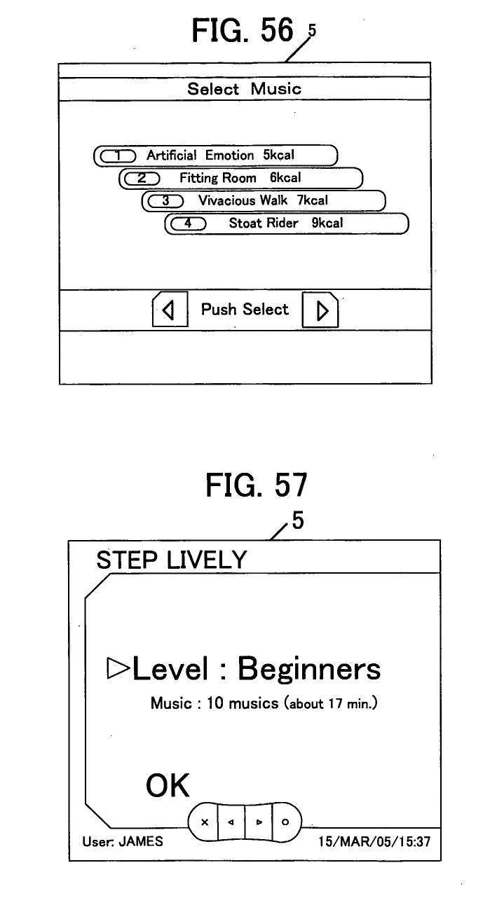

FIG. 56 is a view showing an example of the selection screen which is displayed on the television monitor 5 of FIG. 1. The selection screen of FIG. 56 is provided for selecting music which is played back in synchronization with the motion image of FIG. 40, and displaying music titles. The player can select a favorite music title by stepping on the step areas ST1 to ST4 (the foot switches SW1 to SW4). The motion of the character 406, the number and appearance timings of the moving objects are changed in accordance with the music title as selected. Also, in association with the music title, the calorie consumption of the player when he do an exercise following the motion of the character 406 in synchronization with the music, i.e., the estimated calorie consumption “Cst” as described above is displayed.

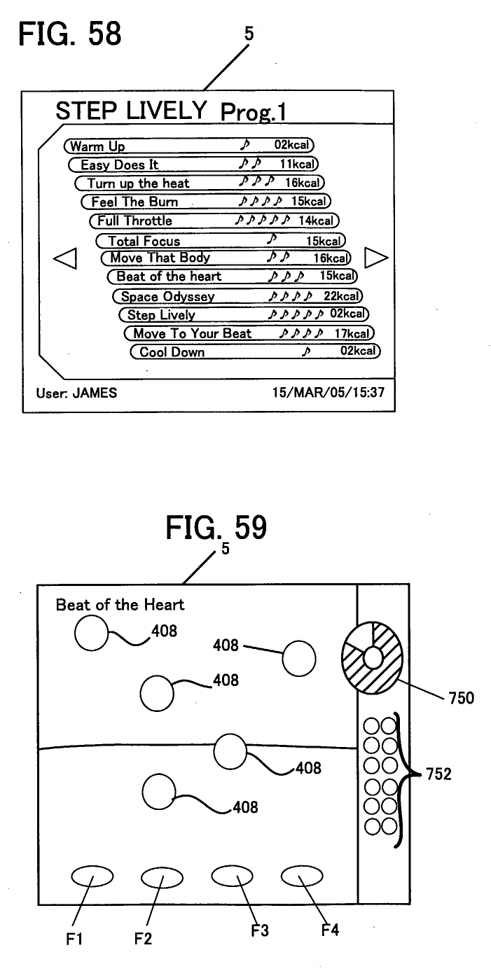

FIG. 57 is a view showing another example of the selection screen which is displayed on the television monitor 5 of FIG. 1. FIG. 58 is a view showing an example of the screen which is displayed after the screen of FIG. 57 is displayed. The high speed processor 91 can display the screens shown in FIG. 57 and FIG. 58 in place of the selection screen of FIG. 56. As shown in FIG. 57, this screen contains a “Level” field in which a difficulty level is set and a “Music” field in which the number of musics to be played back during one exercise is set. When the player enters a difficulty level and the number of musics in this screen, the screen of FIG. 58 is displayed to show a list of music titles which are determined in accordance with the difficulty level and the number of musics as set. Meanwhile, the motion of the character 406, the number and appearance timings of the moving objects are changed in accordance with the difficulty level and the number of musics as set. Also, in the same manner as FIG. 56, the calorie consumption of the player when he do an exercise to match the motion of the character 406 in synchronization with the music is displayed in association with the music title.

In addition, a pair of triangle objects which are the same as the triangle icons printed on the step areas ST2 and ST3 of the mat 2 are displayed in the screen of FIG. 58 such that the music title list is displayed therebetween. When the player steps on the step area ST2 or ST3 to turn on the foot switch SW2 or SW3, the music title list is switched to another music title list. There are a plurality of music title lists which are cyclically switched in a loop to display one after another in turn when the foot switch SW2 or SW3 is turned on. The direction of the loop of the foot switch SW2 and the direction of the loop of the foot switch SW3 are opposite to each other.

By the way, as has been discussed above, in the case of the present embodiment, the player can know the stepping position and the stepping timing not only by the moving objects 408 and 409 and the response objects F1 to F4 (the mat object 415) but also by the character 406 and the areas f1 to f4 (the mat object 411). Accordingly, the player can more easily know the motion as instructed, and thereby the exercise environment can be improved. In addition to this, since the character 406 indicates the motion of the whole body, the player can do not only exercises using stepping motions but also exercises using the whole body.

Also, in the case of the present embodiment, the response objects F1 to F4 (the mat object 415) and the areas f1 to f4 (the mat object 411) have the same forms as the corresponding step areas ST1 to ST4 (the mat 2). Accordingly, it is possible to enhance the realistic sensation that the player can experience during exercise, and make it easier for the player to know how to move as indicated.

Furthermore, in the case of the present embodiment, it is possible to animate the character 406 in synchronization with music only by changing the combination of unit animations (the unit motions) of the character 406 and the playback times of the respective unit animations in accordance with the music title. Accordingly, animated images need not separately be prepared for the respective music titles so that the storage capacity can be reduced.

Furthermore, in the case of the present embodiment, since the playback end time of a unit animation is designated before playing back the unit animation, the playback end time of the unit animation has been recognized at the time when starting the playback of the unit animation (refer to FIG. 47).

Accordingly, since the playback end time can be recognized when starting the playback, it is possible to calculate the playback time of each image frame of a unit animation when starting the playback. As a result, it is possible to start the last unit animation of the animation of the character 406 just after the playback start time of the last unit animation arrives.

Incidentally, in the case where a unit animation is played back by designating the playback start time, the playback time or the playback end time have to be designated if the last unit animation is to be played back just after the playback start time arrives. As thus described, in such a case, an additional parameter is needed for playing back the last unit animation.

In the case of the present embodiment, it is possible to start the last unit animation just after the playback start time arrives without need for an additional parameter.

Furthermore, in the case of the present embodiment, while successively playing back the unit animation indicated by the dance code registered in the buffer 703 of the dance control buffer “Bc” of FIG. 46 (during the playback operation) on the basis of the end point value and a base value of “0”, which are registered respectively in the buffer 702 and the buffer 704 of the dance control buffer “Bc”, a constant value of “255” (corresponding to the playback end time of a unit animation) and a dance code are successively stored every time a new entry is to be set in the dance management buffer “Bm”. The end point value and the base value of “0” registered respectively in the buffer 702 and the buffer 704 of the dance control buffer “Bc” are the same as the playback time information “Pf” and the initial value of the playback counter value “Pc” as has been discussed above. Then, when the result of counting up from the base value of “0” becomes equal to the end point value, i.e., when the playback of the current unit animation ends, the result of counting down from the constant value of “255” placed on top of the buffer 700 of the dance management buffer “Bm”, the dance code placed on top of the buffer 701 of the dance management buffer “Bm” and the base value of “0” are registered anew in the dance control buffer “Bc”, and the playback of the next unit animation is started on the basis of the registration information.

As has been discussed above, by buffering the constant value of “255” (which points to the playback end time of each unit animation) and the dance codes respectively used for playing back subsequent unit animations, the playback end time of the next unit animation can be recognized at the time when the current unit animation being played back ends, so that it is possible to play back the next unit animation from the playback end time of the current unit animation as the playback start time.

In the above embodiment (refer to FIG. 40), the animation of the character 406 is performed in time to music (in synchronization with music). As has been discussed above, in the case of the present embodiment, since animated images are played back by the use of a buffering mechanism, the animation of the character 406 is delayed by the time corresponding to the constant value of “255” (refer to FIG. 47). Accordingly, by delaying the playback of music by the time corresponding to the above constant value of “255” (refer to FIG. 47), it is possible to match the playback timing of music and the playback timing of animation, and synchronize the animation of the character 406 with music.

Meanwhile, in the period corresponding to the above constant value of “255” before starting the animation of the character 406, the animation of the character 406 which is not necessarily synchronized with music (the animation of the character 406 in the state of, as it were, waiting the playback of music) is played back (the uppermost entry of FIG. 47). In other words, in this case, the value of “255” in the buffer 702 shown in (a) of FIG. 46 is the above constant value, and the dance code “00h” stored in the buffer 703 represents the animation of the character 406 which is not necessarily synchronized with music.

### Embodiment 4

The hardware of the mat system of the embodiment 1 is used also as the hardware of the entertainment apparatus of the embodiment 4 of the present invention. The following is an explanation centered on the points different than the above exercise support apparatus.

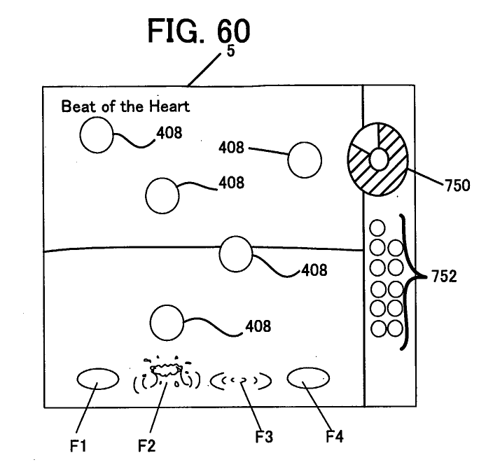

FIG. 59 is a view showing an example of a screen as displayed on the television monitor 5 of FIG. 1 by the entertainment apparatus of the embodiment 4. FIG. 60 is a view showing another example of a screen as displayed on the television monitor 5 of FIG. 1. As shown in FIG. 59, response objects F1 to F4 are displayed in the screen in correspondence with the step areas ST1 to ST4 of the mat 2. The moving objects 408 move respectively on four motion lanes corresponding to the four response objects F1 to F4 from the top edge to the bottom edge of the screen.

On the other hand, as illustrated in FIG. 60, in response to the stepping motion by the player on a step area, i.e., in response to the operation of turning on a foot switch, the response object is changed at the exact moment into the first form (in FIG. 60, the foot switch SW3 is turned on to change the response object F3 into the first form). Also, if the player succeeds in stepping on a step area in a timely manner, i.e., if the player succeeds in turning on a foot switch in a timely manner, the corresponding response object is changed into the second form (in FIG. 60, the foot switch SW2 is turned on to change the response object F2 into the second form). At the same time, the moving object is hit back in the opposite direction. In this case, the timely manner means that the foot switch corresponding to a response object is turned on at the time when a moving object reaches the response object.

Each time the player fails to hit back a moving object 408, one of circular lifes 752 disappears. When all the lifes 752 disappears, the game is over. In addition, the elapsed time display area 750 indicative of the elapsed time from the start is displayed.

It is possible to entertain the player with the combination of the game and music by displaying the moving objects in synchronization with music.

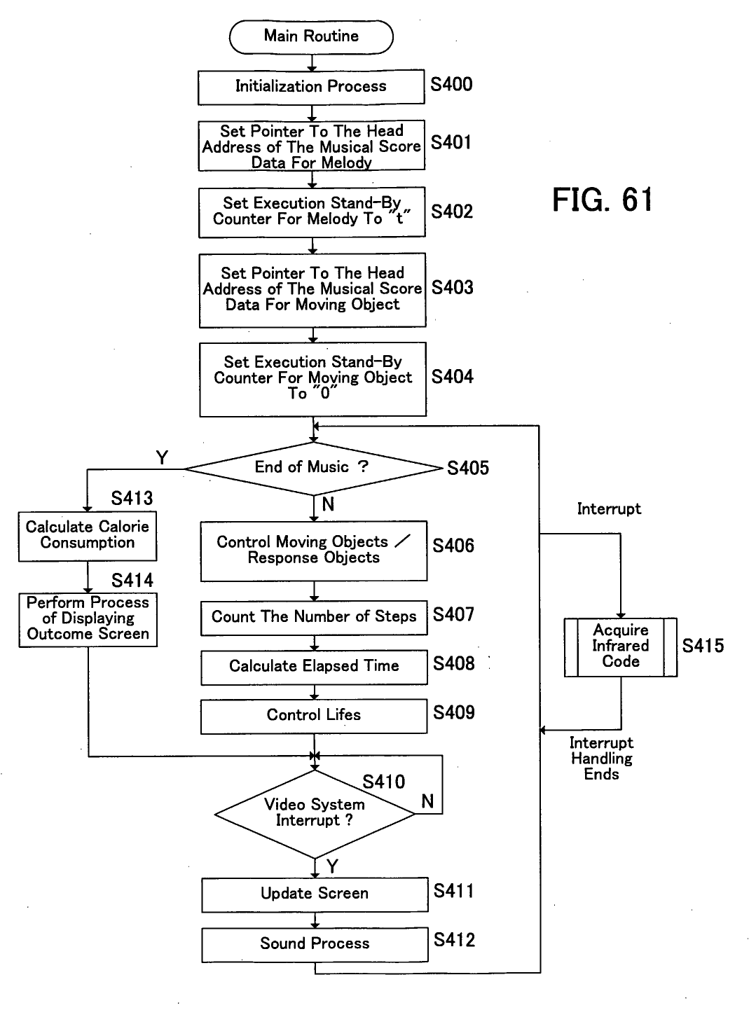

FIG. 61 is a flow chart showing an example of the overall process flow by the high speed processor 91 of FIG. 5 which is used in the entertainment apparatus in accordance with the embodiment 4 of the present invention. As shown in FIG. 61, in step S400, the high speed processor 91 performs the general initialization of the system. Specifically, the system and the respective variables are initialized.

In step S401, the high speed processor 91 sets a musical score data pointer to the head address of the musical score data for melody. In step S402, the high speed processor 91 sets an execution stand-by counter for melody to a time “t”.

In step S403, the high speed processor 91 sets a musical score data pointer to the head address of the musical score data for moving object. In step S404, the high speed processor 91 sets an execution stand-by counter for moving object to a time of “0”.

In step S405, the high speed processor 91 refers to a music end flag, and if the music end flag is turned on (i.e., if the music ends), the process proceeds to step S413 otherwise proceeds to step S406. In step S406, the high speed processor 91 performs the control of the moving objects 408 and the response objects F1 to F4. This process is performed in the same manner as the process in step S211 of FIG. 48. However, in this case, the process of changing the form of a response object is performed in step S406 in place of the process of changing the color of the response object in step S211.

In step S407, the high speed processor 91 detects the off-to-on state transitions of the foot switches SW1 to SW4 in order to calculate the step count “Ntl” of the player. This process is performed in the same manner as the process in step S212 of FIG. 48. In step S408, every time the video frame is updated, the high speed processor 91 increments the counter by one in order to calculate the elapsed time “Tc” from the start to the end of the music. This process is performed in the same manner as the process in step S213 of FIG. 48. In step S409, the high speed processor 91 performs control of the lifes 752 in accordance with the number of times of failing to hit back.

On the other hand, in step S413, the high speed processor 91 calculates the calorie consumption in accordance with the step count “Ntl” of the player which is calculated in step S407. This process is performed in the same manner as the process in step S218 of FIG. 48. In step S414, the high speed processor 91 performs the process of displaying the outcome screen (refer to FIG. 41). This process is performed in the same manner as the process in step S219 of FIG. 48.

By the way, if there is an interrupt by a video system synchronous signal in step S410, the process proceeds to step S411 otherwise the process repeats the same step S410. The interrupt by the video system synchronous signal is issued at 1/60 second intervals.

In response to the interrupt by the video system synchronous signal, in step S411, the high speed processor 91 updates the display image (video frame) of the television monitor 5 on the basis of the information (the storage location information and display location information of the image data) which is set in step S406 to S409 or S414. Also, in response to the interrupt by the video system synchronous signal, the sound process in step S412 is performed, and thereby music and sound effects are output. Thereafter, the processing proceeds to step S405.

When the signal transmitted from the IR receiver circuit 71 of the adapter 1 rises from a low level to a high level, i.e., when the value of the I/O port IO18 rises from a low level to a high level, an interrupt is issued in response to this, and the process of acquiring an infrared code (IR code) is performed in step S415. The details of the process in step S415 are the same as the process in step S21 of FIG. 21, and thereby no redundant description is repeated.

### Embodiment 5

The hardware of the mat system of the embodiment 1 is used also as the hardware of the athletic ability measurement apparatus of the embodiment 5 of the present invention. In the case of the present embodiment, the number of steps that the player takes within a predetermined time is measured. In what follows, this embodiment will be explained with reference to drawings.

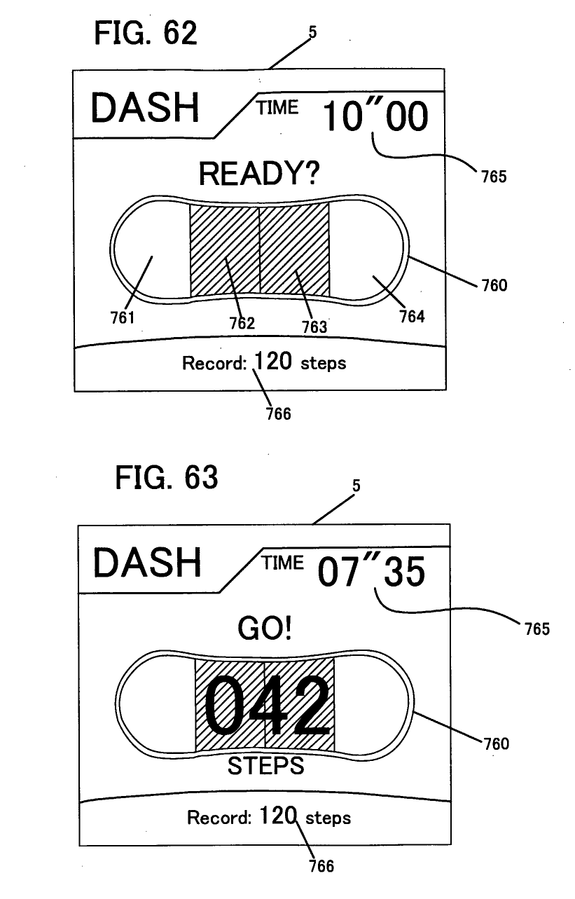

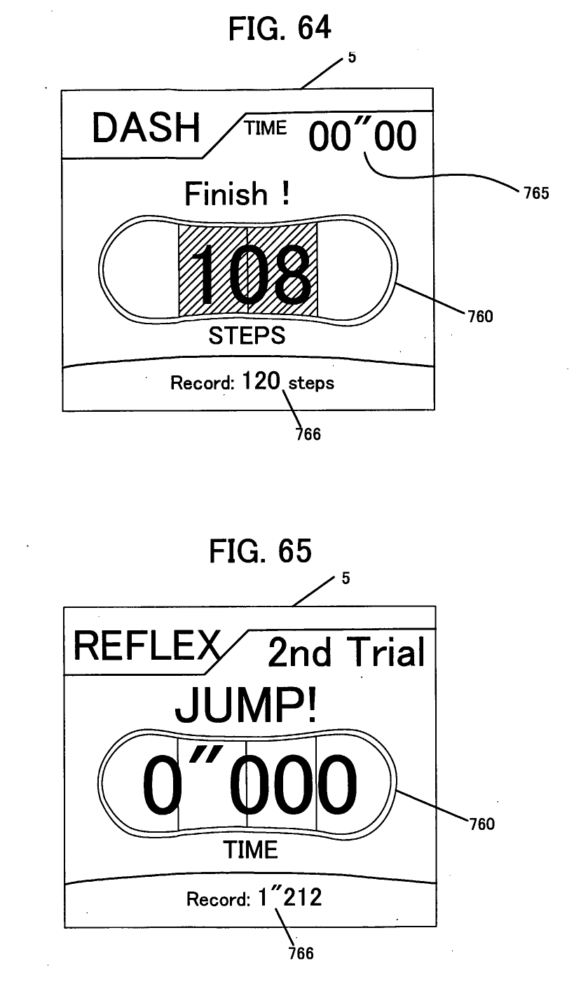

FIG. 62 is a view showing an example of a ready screen as displayed on the television monitor 5 of FIG. 1 in accordance with the athletic ability measurement apparatus of the embodiment 5 of the present invention. FIG. 63 is a view showing an example of a screen which is displayed during playing on the television monitor 5 of FIG. 1. FIG. 64 is a view showing an example of a “Finish” screen which is displayed on the television monitor 5 of FIG. 1.

As shown in FIG. 62, the ready screen generated by the high speed processor 91 includes a word of “Ready”, a down counter 765, a record 766 and a mat object 760 corresponding to the mat 2. The down counter 765 performs counting down from 10 seconds to 0 second. The mat object 760 comprises areas 761 to 764 corresponding to the step areas F1 to F4 respectively. In the figure, the color of the areas 762 and 763 is changed to be different from that of the other areas 761 and 764 in order to indicate which step areas the player is to step. The record 766 is the highest number of steps so far achieved by the player.

As shown in FIG. 63, when the word “Ready” of the ready screen of FIG. 62 is changed to the word “GO”, the high speed processor 91 starts counting down by the down counter 765. Then, the high speed processor 91 displays the current step count of the player over the mat object 760 on a real time base. In this case, every time a foot switch is changed from an off-state to an on-state, the step count is incremented by one.

Thereafter, as shown in FIG. 64, the high speed processor 91 stops the measurement when the down counter 765 reaches “0” (i.e., the word “Finish” is displayed). Then, the final result of the step count of the player is displayed over the mat object 760.

In other words, this athletic ability measurement apparatus serves to count how much the steps the player takes on the step areas ST2 and ST3 of the mat 2 within a predetermined time from the time when the word “Ready” is changed to the word “GO”.

As has been discussed above, in the case of the present embodiment, it is possible to easily measure athletic ability, since the count of steps within the predetermined time is used as the measure of athletic ability. Then, the player can know own athletic ability with reference to the count of steps within the predetermined time.

### Embodiment 6

The hardware of the mat system of the embodiment 1 is used also as the hardware of the reflexes ability measurement apparatus of the embodiment 6 of the present invention. In the case of the present embodiment, the reaction time of the player is measured. In what follows, this embodiment will be explained with reference to drawings.

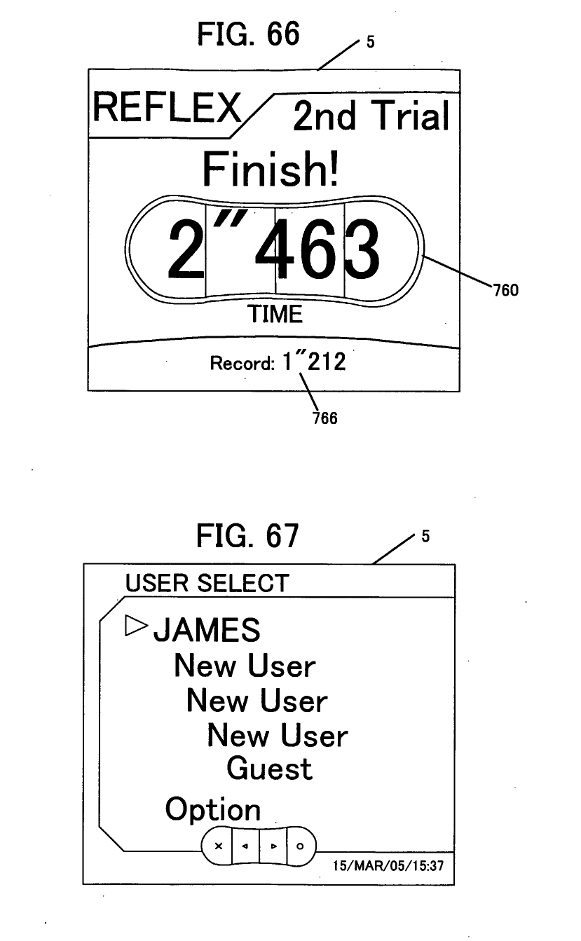

FIG. 65 is a view showing an example of a screen which is displayed during playing on the television monitor 5 of FIG. 1 in accordance with the reflexes ability measurement apparatus of the embodiment 6 of the present invention. FIG. 66 is a view showing an example of a “Finish” screen which is displayed on the television monitor 5 of FIG. 1. The ready screen of the present embodiment is the same as the ready screen of FIG. 62. However, the down counter 765 of FIG. 62 is not displayed, and the record 766 is displayed to show the shortest time so far achieved by the player.

As shown in FIG. 65, the high speed processor 91 counts up from the time when the word “Ready” is changed to the word “JUMP” to the time when both the feet of the player are taken off from the mat 2, i.e., all the foot switches SW1 to SW4 are turned off. Then, as shown in FIG. 66, the high speed processor 91 displays the result of measurement (the value of count) over the mat object 760.

In other words, this reflexes ability measurement apparatus serves to measure how quick the player can jump on the step areas ST2 and ST3 of the mat 2 after the word “Ready” is changed to the word “JUMP”.

Incidentally, in accordance with the present embodiment as has been discussed above, since the measure of reflexes ability is the time period from the time point when the start of action is indicated to the time point when the input from the player comes to cease (i.e., the time period from the time point when the start of action is indicated to the time point when both the feet of the player are taken off from the mat 2), it is possible to easily measure reflexes ability. Then, the player can know own reflexes ability with reference to the time counted after the start of action is indicated until the input from the player comes to cease.

### Embodiment 7

The hardware of the mat system of the embodiment 1 is used also as the hardware of the mat system of the embodiment 7 of the present invention.

FIG. 67 is a view showing an example of a user name entry screen as displayed on the television monitor 5 of FIG. 1 in accordance with the mat system of the embodiment 7 of the present invention. The player can enter own name in the user name entry screen by stepping the step areas ST1 to ST4 (the foot switches SW1 to SW4).

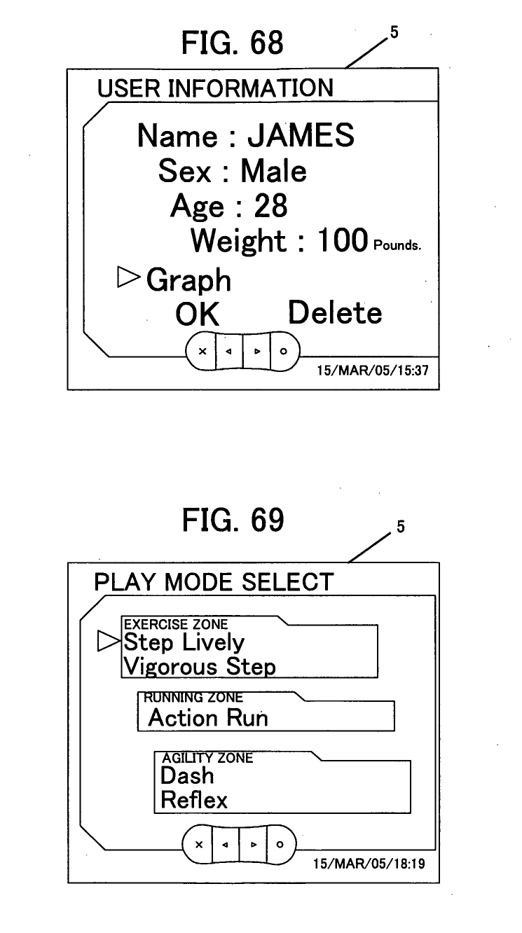

FIG. 68 is a view showing an example of a user information entry screen as displayed on the television monitor 5 of FIG. 1. The high speed processor 91 displays the user information entry screen after the user name entry screen is displayed. The player can enter own sex, age and weight in the user information entry screen by stepping the step areas ST1 to ST4 (the foot switches SW1 to SW4).

FIG. 69 is a view showing an example of a play mode selection screen as displayed on the television monitor 5 of FIG. 1. The high speed processor 91 displays the play mode selection screen after the user information entry screen is displayed. As shown in FIG. 69, the present embodiment provides five play modes.

The high speed processor 91 performs the processes of the embodiments 3, 4, 2, 5 and 6 as described above respectively in a play mode “Step Lively”, a play mode “Vigorous Step”, a play mode “Action Run”, a play mode “Dash” and a play mode “Reflex”.

In the following description, the play mode “Step Lively”, the play mode “Vigorous Step”, the play mode “Action Run”, the play mode “Dash” and the play mode “Reflex” are referred to respectively as the exercise mode, the entertainment mode, the simulated experience mode, the athletic ability measurement mode, and the reflexes ability measurement mode.

In the case of the present embodiment, the calorie consumptions calculated in the exercise mode, the entertainment mode, the simulated experience mode are accumulated, and the outcome is graphically displayed. This point will be explained with reference to drawings.

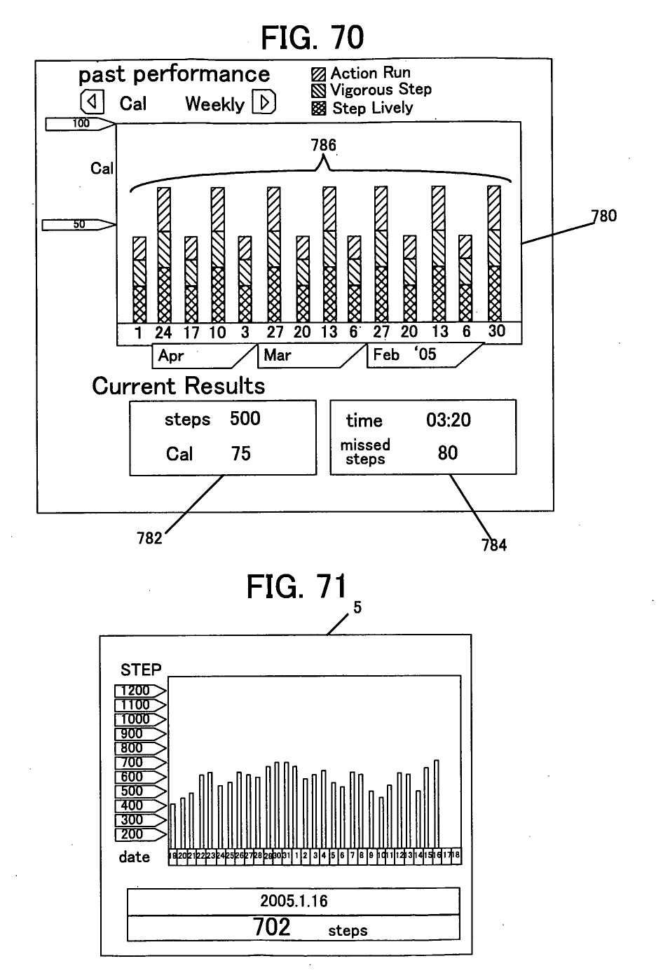

FIG. 70 is a view showing an example of the graphic screen displayed on the television monitor 5 of FIG. 1. As shown in FIG. 70, this graphic screen includes the graphic display area 780, an exercise amount display area 782 and a time display area 784. In the graphic display area 780, the calorie consumptions of the latest 14 weeks are displayed on a week-to-week basis by a bar graph. In the graphic display area 780, the ordinate is an energy axis, and the abscissa is a time axis as the week of May 1, the week of April 24, the week of April 17, and so on.

In this case, each of the bars 786 representing the calorie consumptions on a week-to-week basis comprises a part (shaded with multiple diagonal lines rising toward the right in the figure) representing the energy consumption in the exercise mode (“Action Run”), a part (shaded with multiple diagonal lines falling toward the right in the figure) representing the energy consumption in the entertainment mode (“Vigorous Step”), and a part (shaded with multiple crossing diagonal lines in the figure) representing the energy consumption in the exercise mode (“Step Lively”), which are separated by color.

In the exercise amount display area 782, the step count and the calorie consumption during the latest play mode as finished is displayed. Also, in the time display area 784, the elapsed time and the miss count during the latest play mode as finished are displayed. However, if the latest play mode as finished is the simulated experience mode, the miss count is not displayed.

Meanwhile, the unit of the time axis is not limited to weeks, but any appropriate unit, such as, days, months and so on can be used instead. For example, the player can switch the unit of the time axis by turning on the foot switch SW2 or SW3 to display the bar graph with a different unit of time. Also, while the bars 786 are separated by color to distinguish the respective play modes by using different colors, it is possible to use different pattern, different designs, or other different visual appearances for the purpose of distinguishing the respective play modes.

FIG. 71 is a view showing another example of the graphic screen displayed on the television monitor 5 of FIG. 1. The graphic screen of FIG. 71 includes a bar graph which indicates the total step counts of the player on a day-to-day basis and is displayed on the television monitor 5 by the high speed processor 91. Alternatively, it is possible to display the calorie consumptions on a day-to-day basis rather than the step counts. Each of the step counts and calorie consumptions on a day-to-day basis is a total value accumulated during the exercise mode, entertainment mode and the simulated experience mode in that day. Incidentally, the unit of the time axis is not limited to days, but any appropriate unit, such as, weeks, months and so on can be used instead.

In this case, the high speed processor 91 stores the step count and calorie consumption in the EEPROM 308 on a daily basis in association with the date. In this case, the high speed processor 91 acquires date information from the RTC 310. In the case of the present embodiment, the RTC 310 is incorporated within the cartridge 3, however, the RTC 310 can be placed within the circuit box 4 of the mat 2.

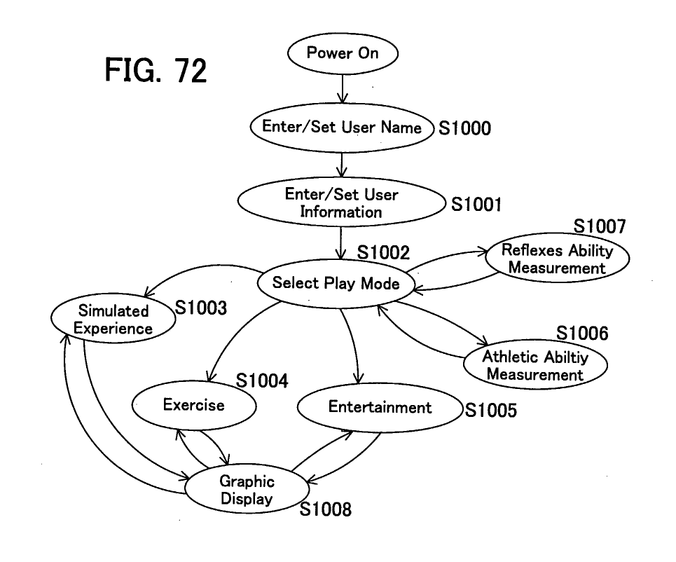

FIG. 72 is a schematic diagram showing the process transition among the routines performed by the mat system in accordance with the embodiment 7 of the present invention. As shown in FIG. 71, the high speed processor 91 displays the user name entry screen (refer to FIG. 67) on the television monitor 5 in step S1000, receives name information from the user, and stores the name information in the EEPROM 308. In step S1001, the high speed processor 91 displays the user information entry screen (refer to FIG. 68), receives user information from the user, and stores the user information in the EEPROM 308.

In step S1002, the high speed processor 91 displays the play mode selection screen (refer to FIG. 69), and receives a play mode from the user. Then, the high speed processor 91 performs either process of step S1003, step S1004, step S1005, step S1006 and step S1007 in accordance with the entry of the user. In step S1003, the process of FIG. 21 is performed. However, the outcome screen as displayed in step S20 does not indicate the calorie consumption. In step S1004, the process of FIG. 48 is performed. However, the process in step S219 is not performed. In step S1005, the process of FIG. 61 is performed. However, the process in step S414 is not performed. In step S1006, the process of the embodiment 5 is performed. In step S1007, the process of the embodiment 6 is performed.

When any one of the processes in step S1003, S1004 and S1005 is finished, the high speed processor 91 proceeds to step S1008 which is the graph screen (refer to FIG. 70) is displayed. Then, when the predetermined time elapses or in response to the entry of the player through the mat 2, the high speed processor 91 returns to the previous play mode. On the other hand, after either the process in step S1006 or the process in step S1007 is finished, when the predetermined time elapses or in response to the entry of the player through the mat 2, the high speed processor 91 display the play mode selection screen (refer to FIG. 69).

By the way, in the case of the present embodiment as has been discussed above, even when the user do different exercise programs (in the exercise mode, entertainment mode and the simulated experience mode), the changes in the amount of exercise are displayed separately for the respective exercise programs on the same time axis.

That is to say, as shown in FIG. 70, while the abscissa is the time axis and the ordinate is an axis indicative of the amount of exercise, the bars 786 are displayed to show the amounts of exercise distinctively for the three exercise programs on a predetermined time period basis (on a week-to-week basis in FIG. 70) by dividing each of the bars 786 into three bar elements which vertically stacked and have different forms respectively corresponding to the three exercise programs.

Because of this, the user can easily know not only the changes in the amount of exercise of the respective exercise programs, but also the change in the total amount of exercise. Furthermore, since the proportions of the amounts of exercise of the respective exercise programs to the total amount of exercise can be easily known, it is easy to make the schedule of doing the respective exercise programs.

Also, in the case of the present embodiment, since the energy consumption which is commonly known is used as a measure of the amount of exercise, the user can easily recognize the amount of exercise.

Meanwhile, the present invention is not limited to the above embodiments, and a variety of variations and modifications may be effected without departing from the spirit and scope thereof, as described in the following exemplary modifications.

(1) In the above embodiments, the mat 2 is provided with four foot switches SW1 to SW4. However, the number of the foot switches is not limited to this. Also, the foot switches SW1 to SW4 are arranged in a line, however, any other appropriate arrangement can be employed. For example, imaging two orthogonal lines bisecting each other, two foot switches can be arranged in one line, and the other two foot switches can be arranged in the other line.

(2) While the mat unit 7 is wireless connected with the adapter 1 in the above embodiments, they can be connected by cable. Also, while infrared light is used for wireless communication, radio waves can be used instead.

(3) While a cartridge type is employed in the above embodiments, it is possible to implement the respective functions of the cartridge 3 within the adapter 1 without the use of a cartridge. It is also possible to implement the respective functions of the cartridge 3 and the respective functions of the adapter 1 within the circuit box 4 of the mat unit 7.

(4) While the character 406 is prepared as a human image in the case of the above embodiment 2, the present invention is not limited thereto. For example, the character 406 can be prepared also as an arbitrary image such as an animal, a monster or a robot. Also, the screen can be divided into a plurality of sub-screens, in each of which a character is displayed, so that a plurality of players can do exercises.

(5) In the case of the above embodiment 3, it is possible to divide the story of images as displayed into three parts, i.e., a warm-up, an exercise (the process of FIG. 48), and a cool-down. In this case, the images are displayed in the order of the warm-up, the exercise, and the cool-down. The images of the warm-up and the cool-down are, for example, such that the character 406 repeats predetermined motions. In this case, it is freely determined whether or not the moving objects 408 are displayed. However, it is preferred to display the moving objects in the case of the warm-up and not to display the moving objects in the case of the cool-down. The exercise is implemented by the process of FIG. 48. Incidentally, the warm-up and the cool-down can be implemented by the similar process as described in FIG. 48.

(6) In the case of the above embodiment 3, the end times of playing the unit animations are designated when the character 406 is animated. Alternatively, it is also possible to designate the start times of playing the unit animations.

(7) In the case of the above embodiment 7, the ordinate of the graph of FIG. 70 is the energy consumption in calories which is used to represent the amount of exercise which the player has done. However, the unit of energy is not limited to calories, but any other unit of energy can be used. Also, while the amount of exercise which the player has done is directly indicated by the energy consumption, the amount of exercise can be indirectly indicated by an appropriate measure. For example, such a measure may be what number of apples are equivalent to the exercise, what number of steps are equivalent to the exercise and so forth. The graph of FIG. 71 can be prepared in accordance with the above alternatives.

As has been discussed above, in this description, “the amount of exercise” means a value which quantitatively represents how much the player exercises.

(8) While the graph used in the above embodiment 7 is a bar graph (refer to FIG. 70 and FIG. 71), however, any other graphical representation such as a line graph can be used.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

1. A simulated experience apparatus comprising:
a plurality of step members each of which includes a detector unit operable to detect a stepping motion of a player as an input;
a motion determination unit operable to determine which of a plurality of predetermined motion patterns the motion of the player belongs on the basis of the detection result by said detector unit; and
a motion control unit operable to control motion of a manipulation object displayed on a display device in accordance with the motion pattern as determined by said motion determination unit.

2. The simulated experience apparatus as claimed in claim 1 wherein the plurality of predetermined motion patterns include part or all of a motionless state, a walking motion, a running motion, a side stepping motion, a jumping motion and a squatting motion.

3. The simulated experience apparatus as claimed in claim 2 wherein said motion determination unit determines that the motion of the player is the squatting motion when said detector units of three or four of said plurality of step members simultaneously detect the inputs of the player.

4. The simulated experience apparatus as claimed in claim 1 further comprising an indication object control unit operable to make an indication object appear, which indicates what motion the player is to do, on a course in a virtual space displayed on the display device.

5. The simulated experience apparatus as claimed in claim 1 further comprising an energy consumption calculation unit operable to calculate the energy consumption of the player by adding an adjusted value calculated by adjusting an energy consumption value predetermined as an energy consumption corresponding to a predetermined motion in accordance with the number of times that the player performs the stepping motion to a base energy consumption calculated by multiplying a unit step energy consumption which is predetermined as an energy consumption of a unit stepping motion corresponding to the motion of stepping for predetermined times by the number of times of performing the unit stepping motion.

6. An energy consumption calculation method comprising:
acquiring a base energy consumption by multiplying a unit step energy consumption which is predetermined as an energy consumption of a unit stepping motion corresponding to the motion of stepping for predetermined times by the number of times of performing the unit stepping motion;
acquiring an adjusted value by adjusting an energy consumption value predetermined as an energy consumption corresponding to a predetermined motion in accordance with the number of times that the player performs the stepping motion; and
acquiring the energy consumption of the player by adding the adjusted value to the base energy consumption.

7. A squatting motion detection apparatus comprising:
a plurality of step members each of which includes a detector unit operable to detect a stepping motion of a player as an input; and
a determination unit operable to determine that the motion of the player is the squatting motion when said detector units of three or four of said plurality of step members detect the inputs of the player.

8. An exercise support apparatus which is used by connecting it to a display device, comprising:
a plurality of step members each of which includes a detector unit operable to detect a stepping motion of a player as an input; and
a video signal generation unit operable to generate a video signal for displaying a plurality of objects, and output the video signal to the display device, wherein the objects includes a plurality of response objects which are provided corresponding respectively to said plurality of step members and each of which is operable to respond to the detection of a stepping motion by said detector unit corresponding thereto, a moving object which moves on one of motion lanes provided corresponding respectively to the response objects and which is operable to instruct the player on what position and timing the player is to take a step on said plurality of step members, a character operable to instruct the player on what fullbody motion the player is to do, and a plurality of objects which correspond to said plurality of step members and are pointed to by the character in order to instruct the player on what position and timing the player is to take a step on said plurality of step members.

9. The exercise support apparatus as claimed in claim 8 wherein
the response objects are designed in similar forms as said stepping members respectively corresponding thereto, and wherein
the objects which are pointed to by the character are designed in similar forms as said stepping members respectively corresponding thereto.

10. An animation method of animating a character in accordance with a music by combining a plurality of types of unit animations, comprising:
Playing back the music; and
Playing back the combination of the unit animations as the animation of the character, wherein
the combination of the unit animations for animating the character is predetermined in accordance with the music, and wherein
the playback times of the unit animations are predetermined in accordance with the music.

11. An animation method of animating a character by combining a plurality of types of unit animations, wherein
the playback end time of the unit animation is designated on a time axis before playing back this unit animation.

12. An animation method of animating a character by combining a plurality of types of unit animations, comprising:
setting sequentially, every time when a unit animation is to be set up, designation information for designating the unit animation and a constant value;
starting a count operation from the constant value for each of the unit animations;
starting a count operation from a base value as registered, continuing the count operation until an end point value as registered;
playing back the unit animation in accordance with the designation information as registered until the result of counting from the base value becomes equal to the end point value;
registering the result of counting from the constant value as first set as the new end point value when the result of counting from the base value becomes equal to the end point value;
registering anew the designation information as first set when the result of counting from the base value becomes equal to the end point value; and
registering anew the base value when the result of counting from the base value becomes equal to the end point value.

13. An exercise amount management apparatus which is used by connecting it to a display device, comprising:
an exercise program providing unit operable to provide a user with a plurality of types of exercise programs through an image which is displayed on the display device;
an exercise amount calculating unit operable to calculate the amounts of exercise of the user separately for the respective exercise programs;
an accumulation unit operable to accumulate the amounts of exercise on a predetermined time period basis for each of the exercise programs;
a video signal generation unit operable to generate a video signal including an image which shows the change in the accumulated values by said accumulation unit on the same time axis for at least two predetermined exercise programs of the plurality of types of exercise programs.

14. The exercise amount management apparatus as claimed in claim 13 wherein the image showing the change in the accumulated values is displayed on the predetermined time period basis with the same time axis as a first axis and an axis representing the amount of exercise as a second axis which is perpendicular to the first axis, wherein the accumulated values of the at least two predetermined exercise programs are designated in different appearances respectively, and wherein the accumulated values designated in the different appearances are stacked in the direction of the second axis.

15. The exercise amount management apparatus as claimed in claim 14 wherein the amount of exercise is the energy that the user has consumed.

16. An athletic ability measurement apparatus which is used by connecting it to a display device, comprising:
a plurality of step members each of which includes a detector unit operable to detect a stepping motion of a player as an input;
a video signal generation unit operable to generate a video signal including an image by which the player is instructed to start a motion, and output the video signal to the display device; and
a counter unit operable to count the number of times that the player performs stepping motions within a predetermined period after the image by which the player is instructed to start the motion is displayed, wherein
the video signal generation unit generates a video signal including an image indicative of the count result of said counter unit, and outputs the video signal to the display device.

17. A reflexes ability measurement apparatus which is used by connecting it to a display device, comprising:
a plurality of step members each of which includes a detector unit operable to detect a stepping motion of a player as an input;
a video signal generation unit operable to generate a video signal including an image by which the player is instructed to start a motion, and output the video signal to the display device; and
a measurement unit operable to measure the time period passing after the image by which the player is instructed to start the motion is displayed until the input from the player to a predetermined detector unit of the detector units comes to cease, wherein
the video signal generation unit generates a video signal including an image indicative of the measurement result of said measurement unit, and outputs the video signal to the display device.

18. An audio-visual system comprising:
a stepping unit provided with a plurality of stepping members which are stepped on by a user;
an information processing unit operable to perform processes in accordance with a program,
each of the stepping members including:
a detector unit operable to detect a stepping motion of the user as an input;
said stepping unit further including:
a transmitter unit operable to wireless transmit the detection result by said detector unit to said information processing unit,
said information processing unit including:
a receiver unit operable to receive the detection result which is wireless transmitted from said transmitter unit of said stepping unit; and
a processor operable to generate a video signal and an audio signal on the basis of the detection result.
